(19) United States
(12) Patent Application Publication
(10) Pub. No.: US 2026/0313280 A1
(43) Pub. Date: Oct. 8, 2026

(54) EARPHONE

(71) Applicant: Shenzhen Dancing Future Technology Ltd., Shenzhen (CN)

(72) Inventors: Zhenlong XIE, Shenzhen (CN); Jianhui HUANG, Shenzhen (CN)

(21) Appl. No.: 19/478,745

(22) PCT Filed: Oct. 10, 2024
(86) PCT No.: PCT/CN2024/124000

§ 371 Date: Oct. 24, 2025

(30) Foreign Application Priority Data
Oct. 10, 2023 (CN) 202311312479.8
Oct. 10, 2023 (CN) 202322719705.6
Oct. 10, 2023 (CN) 202322720214.3
Oct. 10, 2023 (CN) 202322720517.5
Oct. 10, 2023 (CN) 202322738334.6
Oct. 12, 2023 (CN) 202322752381.6

(51) Int. Cl. H04R 1/08; H04R 1/10; H04R 1/40

(52) U.S. Cl. CPC H04R 1/086; H04R 1/1075; H04R 1/406; H04R 1/1016

(57) ABSTRACT

Embodiments of the present disclosure disclose an earphone. The earphone includes an earphone main body, a microphone group and a waterproof and breathable assembly, the earphone main body is provided with at least one sound pickup hole, a sound pickup cavity is formed in the earphone main body and is communicated with the sound pickup hole, the microphone group is arranged in the earphone main body and includes at least one microphone, and the waterproof and breathable assembly is arranged on one side of the microphone to prevent water in the sound pickup cavity from flowing to the microphone, the microphone and the sound pickup cavity being acoustically coupled through the waterproof and breathable assembly.

### TECHNICAL FIELD

The present disclosure relates to the technical field of earphones, and in particular, to an earphone waterproof button structure, an earphone structure with a waterproof microphone, and an earphone.

### BACKGROUND

At present, earphones are generally provided with components such as a battery, a circuit board, a speaker, and a microphone.

The waterproof performance of the earphone is of great significance for the earphone to be used in special environments (rainy days or sports conditions). Generally, a certain sealing measure needs to be provided at the connection position of different housing components to seal the housing, so as to prevent the electronic devices inside the earphone from being immersed in water, which will lead to shortened service life or even damage. However, the existing sealing measures for earphones are average, and a good waterproof effect cannot be achieved.

### SUMMARY

Embodiments of the present disclosure provide an earphone waterproof button structure, an earphone structure with a waterproof microphone, and an earphone, which can improve the waterproof performance of the earphone. In a first aspect, an embodiment of the present disclosure provides an earphone, including:
an earphone main body, where the earphone main body is provided with at least one sound pickup hole, and a sound pickup cavity is formed in the earphone main body and is communicated with the sound pickup hole;
a microphone group, arranged in the earphone main body and including at least one microphone; and
a waterproof and breathable assembly, arranged on one side of the microphone to prevent water in the sound pickup cavity from flowing to the microphone, where the microphone and the sound pickup cavity are acoustically coupled through the waterproof and breathable assembly.

In a second aspect, an embodiment of the present disclosure provides an earphone, including:
a housing, where a sound producing device is installed in the housing;
the housing includes a main shell and an inner cover which are hermetically covered with each other, the inner cover and the main shell enclose to form an accommodating cavity, a side of the inner cover close to the main shell is provided with a baffle plate that is protruding, the baffle plate is spaced apart from an outer wall of the inner cover, so as to form a sealing groove between the outer wall of the inner cover and the baffle plate, the main shell is provided with an inserting portion inserted into the sealing groove, the inserting portion is in sealing connection with the sealing groove, a gap is formed between a side of the baffle plate opposite to the sealing groove and the sound producing device, and the sound producing device is in sealing connection with the baffle plate.

In a third aspect, an embodiment of the present disclosure provides an earphone, including:
an earphone main body, including a body and an earphone head which are connected with each other; and
a neck hanging piece, including a neck hanging main body, a plug portion and a clamping table which are connected in sequence;
where the body is provided with a jack corresponding to the plug portion, the plug portion extends into the jack, the jack includes a first hole opening located on a surface of the body and a second hole opening located inside the body, a periphery of the first hole opening abuts against the neck hanging main body, and the clamping table is in snap-fit with a periphery of the second hole opening.

In a fourth aspect, an embodiment of the present disclosure provides an earphone structure with a waterproof microphone, including:
a housing, where a sound pickup hole is formed on the housing, a sound pickup cavity is formed in the housing, the sound pickup hole is communicated with the sound pickup cavity, the sound pickup cavity includes a first cavity and a second cavity which are communicated with each other, the first cavity is communicated with the sound pickup hole, the first cavity includes a communication hole communicated with the second cavity, and the communication hole and the sound pickup hole are arranged in a staggered manner in an axial direction of the sound pickup hole; and
a microphone and a waterproof and breathable assembly, where the microphone is located in the housing, the second cavity is acoustically coupled with the microphone through the waterproof and breathable assembly.

In a fifth aspect, an embodiment of the present disclosure provides an earphone structure with a waterproof microphone, including:
a housing, provided with at least one first sound pickup hole, where the housing includes a sound pickup wall which is arranged opposite to and spaced apart from the first sound pickup hole, a sound pickup cavity is formed between the sound pickup wall and the housing, and the sound pickup wall is provided with a second sound pickup hole communicated with the sound pickup cavity;
a microphone, arranged on a side of the sound pickup wall away from the first sound pickup hole; and
a waterproof and breathable assembly, arranged between the microphone and the sound pickup wall to prevent water from flowing to the microphone.

In a sixth aspect, an embodiment of the present disclosure provides an earphone waterproof button structure, including:
a housing, provided with an opening;
an elastic sealing layer, covering the opening and hermetically connected with an outer edge of the opening, where the elastic sealing layer includes a pressing portion protruding in a direction away from the opening; and
a button, integrally connected with a side of the pressing portion close to the housing.

### BRIEF DESCRIPTION OF DRAWINGS

FIG. 1 is a schematic structural view of an ear;

FIG. 2 is a schematic view of an earphone provided by an embodiment of the present disclosure when worn on an ear;

FIG. 3 is a schematic structural view of an earphone provided by an embodiment of the present disclosure;

FIG. 4 is a schematic structural view of the earphone in FIG. 3 from another perspective;

FIG. 5 is a partial cross-sectional view of the earphone in FIG. 3 from a first perspective;

FIG. 6 is an enlarged view of a portion A in FIG. 5;

FIG. 7 is an enlarged view of a portion B in FIG. 6;

FIG. 8 is a partial cross-sectional view of an earphone main body in FIG. 3;

FIG. 9 is an enlarged view of a portion C in FIG. 8;

FIG. 10 is a schematic structural view of an earphone main body in FIG. 3 with a partial structure removed;

FIG. 11 is a partial cross-sectional view of the earphone in FIG. 3 from a second perspective;

FIG. 12 is an enlarged view of a portion D in FIG. 11;

FIG. 13 is a partial cross-sectional view of an earphone in FIG. 3 from a third perspective;

FIG. 14 is an enlarged view of a portion E in FIG. 13;

FIG. 15 is a partial cross-sectional view of the earphone in FIG. 3 from a fourth perspective;

FIG. 16 is an enlarged view of a portion F in FIG. 15;

FIG. 17 is a partial cross-sectional view of an assembly of a main board cover and a light guide column of an earphone provided by an embodiment of the present disclosure;

FIG. 18 is a schematic structural view of an earphone in a cross section;

FIG. 19 is an enlarged view of a portion A in FIG. 18;

FIG. 20 is an enlarged view of a portion B in FIG. 19;

FIG. 21 is a schematic cross-sectional structural view of an earphone structure with a waterproof microphone provided by an embodiment of the present disclosure;

FIG. 22 is a partial enlarged view of portion A in FIG. 21;

FIG. 23 is a schematic view of a partial structure of the earphone structure with a waterproof microphone provided by an embodiment of the present disclosure;

FIG. 24 is a schematic structural view of an earphone when worn on an ear;

FIG. 25 is a schematic structural view of an earphone waterproof button structure provided by an embodiment of the present disclosure;

FIG. 26 is a schematic view of a partial structure of an earphone waterproof button structure provided by an embodiment of the present disclosure;

FIG. 27 is a first schematic cross-sectional structural view of an earphone waterproof button structure provided by an embodiment of the present disclosure;

FIG. 28 is a partial enlarged view of a portion A in FIG. 27;

FIG. 29 is a second schematic cross-sectional structural view of an earphone waterproof button structure provided by an embodiment of the present disclosure;

FIG. 30 is a partial enlarged view of a portion B in FIG. 29;

FIG. 31 is a schematic structural view of an earphone provided by an embodiment of the present disclosure;

FIG. 32 is a schematic structural view of a partial structure of an earphone provided by an embodiment of the present disclosure in a cross section;

FIG. 33 is an enlarged view of a portion A in FIG. 32;

FIG. 34 is a schematic view of a partial structure of an earphone provided by an embodiment of the present disclosure with an outer cover removed;

FIG. 35 is a schematic structural view of an earphone provided by an embodiment of the present disclosure in a cross-sectional perspective;

FIG. 36 is a partial enlarged view of a portion A in FIG. 35;

FIG. 37 is a partial enlarged view of a portion B in FIG. 36;

FIG. 38 is a schematic structural view of an earphone provided by another embodiment of the present disclosure;

FIG. 39 is a partial enlarged view of a portion C in FIG. 38; and

FIG. 40 is a schematic view of a partial structure of an earphone provided by an embodiment of the present disclosure.

### DETAILED DESCRIPTION

Embodiments of the present disclosure provides an earphone. The earphone may be a wired earphone or a wireless earphone, and may be used in scenarios such as daily calls, listening to music, and sports. A sports earphone is taken as an example below. The existing sports earphones generally have a waterproof rating of IPX4-IPX5, and do not have the conditions for long-term use in outdoor rainy days or underwater. In particular, the housing of the earphone is usually provided with a sound pickup hole communicated with an internal microphone, and water easily flows into the earphone from the sound pickup hole, and easily damages the microphone when flowing to the microphone, resulting in the failure of the microphone, which in turn affects the use of the earphone.

The following will first explain the definitions of the wearing state, the front side, the back side, the upper side and the lower side of the ear, the sagittal plane, the coronal plane, the horizontal plane, the sagittal axis, the coronal axis, the horizontal axis of the human body, and the X, Y, and Z directions involved in the text.

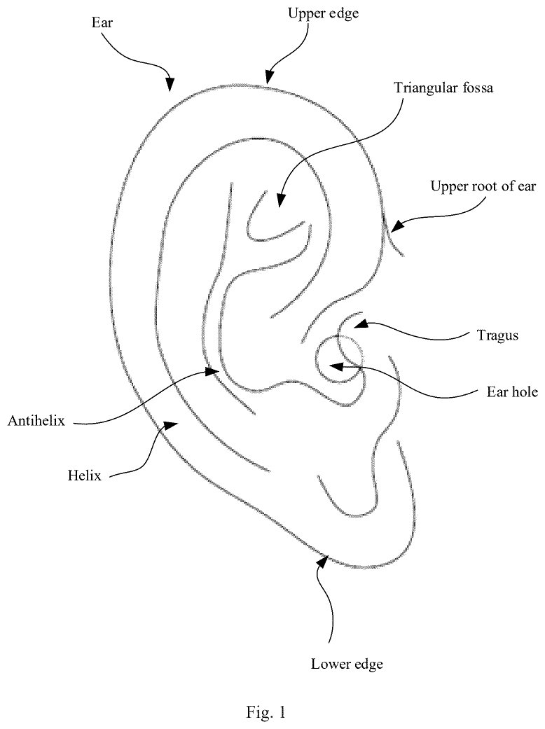

Please refer to FIG. 1, which is a schematic structural view of an ear. The front side and the back side of the ear are defined as follows. The “front side of the ear” described in the present disclosure is a concept relative to the “back side of the ear”, the former refers to a side of the ear away from the head, and the latter refers to a side of the ear toward the head; the “upper edge of the ear” refers to an outer edge of an upper side of a helix of the ear, and the “lower edge of the ear” refers to an outer edge of a lower side of the helix of the ear, which are all for the ear of the user.

The sagittal plane, the coronal plane, the horizontal plane, the sagittal axis, the coronal axis and the horizontal axis of the human body are defined as follows. As is well known, in the fields of medicine and anatomy, three basic sections of the human body may be defined, namely, the sagittal plane (Sagittal Plane), the coronal plane (Coronal Plane), and the horizontal plane (Horizontal Plane), and three basic axes of the human body may be defined, namely, the sagittal axis (Sagittal Axis), the coronal axis (Coronal Axis), and the vertical axis (Vertical Axis). The sagittal plane refers to a section perpendicular to the ground along the front-back direction of the body, which divides the human body into left and right parts; the coronal plane refers to a section perpendicular to the ground along the left-right direction of the body, which divides the human body into front and back parts; and the horizontal plane refers to a section parallel to the ground along the up-down direction of the body, which divides the human body into upper and lower parts. Correspondingly, the sagittal axis refers to an axis perpendicular to and passing through the coronal plane along the front-back direction of the body, the coronal axis refers to an axis perpendicular to and passing through the sagittal plane along the left-right direction of the body, and the vertical axis refers to an axis perpendicular to and passing through the horizontal plane along the up-down direction of the body.

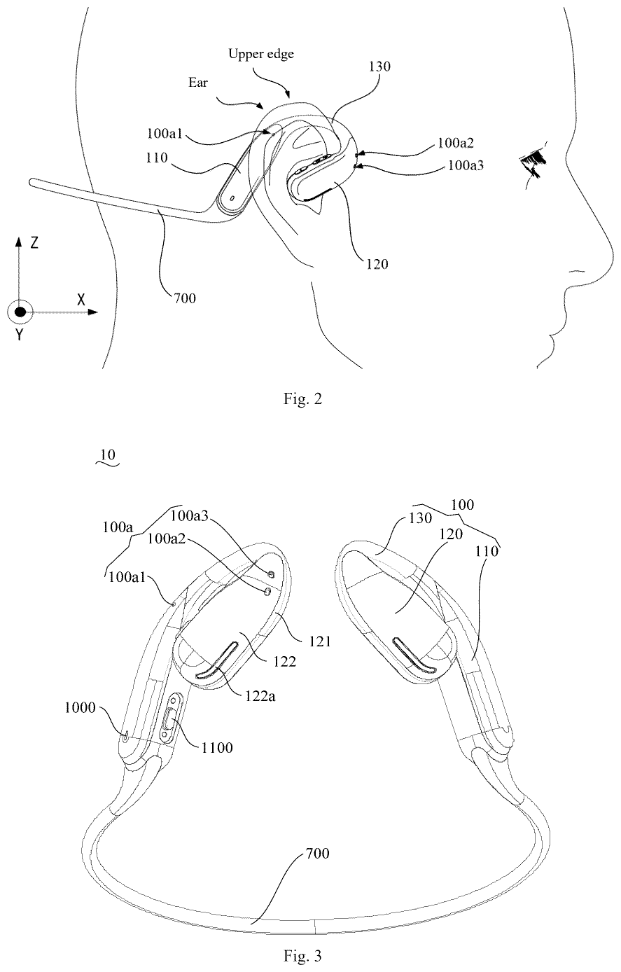

The X, Y, and Z directions are defined as follows. As shown in FIG. 2, for the convenience of description, the X, Y, and Z directions are defined respectively, the X direction is defined as being parallel to the sagittal axis and pointing to the front of the human body, the Y direction is defined as being parallel to the coronal axis and pointing to the right side of the human body (out of the paper surface along FIG. 2), and the Z direction is defined as being parallel to the vertical axis and pointing to the upper side of the human body.

The above definitions of directions are only for the convenience of description, and the X, Y, and Z directions may be defined arbitrarily on the premise that the principles of the present technical solution are met, including but not limited to definition methods such as axial symmetry and angular symmetry of the above orientations.

It may also be understood that the X direction may be used to represent a positive direction of the sagittal axis, the Y direction may be used to represent a positive direction of the coronal axis, and the Z direction may be used to represent a positive direction of the vertical axis.

The wearing state is defined as follows. The “wearing state” described in the present disclosure is a stable wearing state after the earphone is stably worn on the ear of the human body (as shown in FIG. 2), and the “natural state” is a state in which the earphone is not subject to any external force after being taken off from the ear. Certainly, due to individual differences among users, the actual wearing state of the earphone may be somewhat different from the aforementioned wearing state.

### Embodiment 1

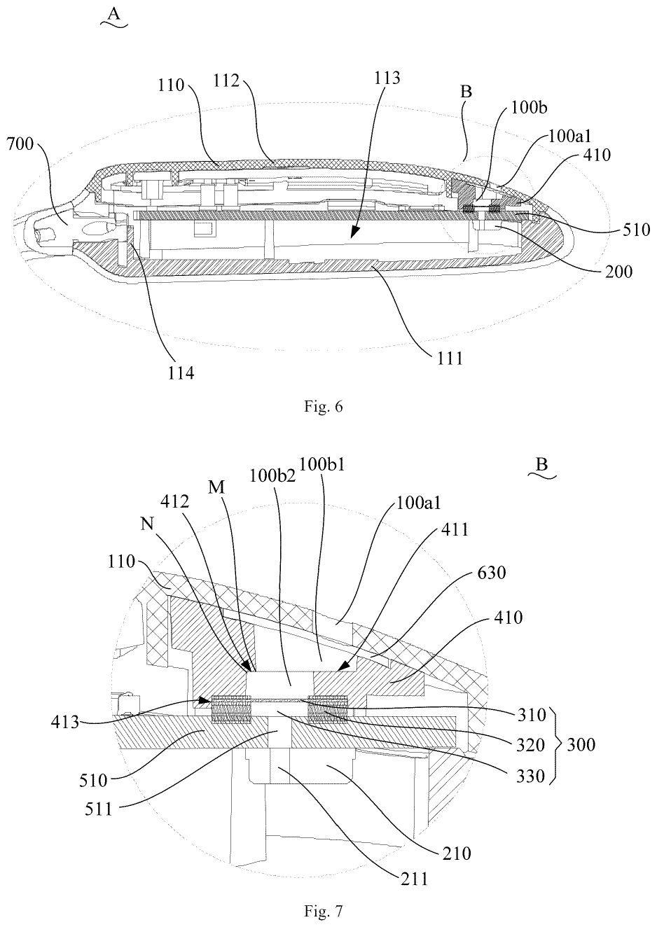

Please refer to FIGS. 3 to 10, in an embodiment of the present disclosure, the earphone 10 includes an earphone main body 100, a microphone group 200, and a breathable assembly 300, the earphone main body 100 is provided with at least one sound pickup hole 100a, a sound pickup cavity 100b is formed in the earphone main body 100, and the sound pickup cavity 100b is communicated with the sound pickup hole 100a; the microphone group 200 is arranged in the earphone main body 100, and the microphone group 200 includes at least one microphone; and the waterproof and breathable assembly 300 is arranged on one side of the microphone to prevent water in the sound pickup cavity 100b from flowing to the microphone, the microphone and the sound pickup cavity 100b being acoustically coupled through the waterproof and breathable assembly 300.

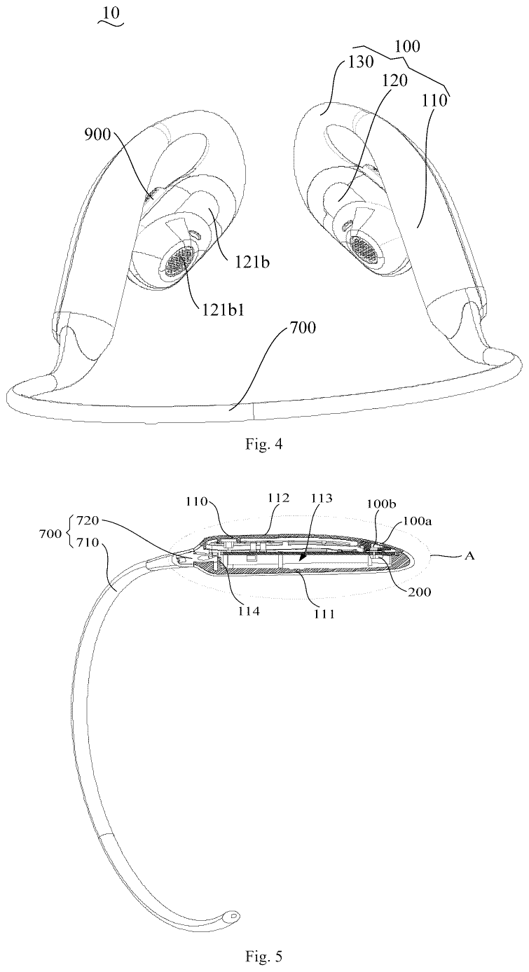

Exemplarily, please refer to FIG. 3 and FIG. 4, the at least one sound pickup hole 100a is formed on the earphone main body 100, and at least one microphone is arranged in the earphone main body 100 corresponding to the sound pickup hole 100a. The sound pickup hole 100a is used for picking up sound information and transmitting the sound information to the microphone through the sound pickup cavity 100b for sound processing. The shape of the sound pickup hole 100a may be in circular, square or other irregular shapes with beauty. In the present embodiment, in order to facilitate the production and machining of the sound pickup hole 100a, the shape of the sound pickup hole 100a is set to be circular. The sound pickup hole 100a may be located on a side of the earphone main body 100 close to the human body, or on a side of the earphone main body 100 away from the human body. In order to ensure the sound pickup effect of the earphone 10, the sound pickup hole 100a is preferably formed on a side of the earphone 10 that is not in contact with the human body when in use. Multiple sound pickup holes 100a may be provided, and multiple microphones may be provided. The number of the sound pickup holes 100a may correspond to the number of the microphones, or may be more or less than the number of the microphones, which is not specifically limited.

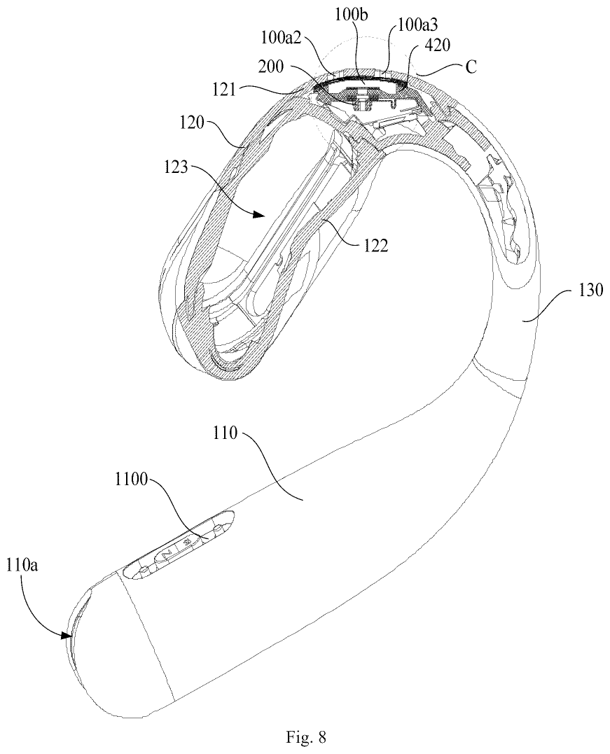

Please refer to FIG. 5 and FIG. 8, the sound pickup cavity 100b is formed in the earphone main body 100, and may be an internal accommodating cavity enclosed by the housing of the earphone 10. The sound pickup hole 100a and the microphone are acoustically coupled directly through the internal cavity of the earphone main body 100, or a separate component may be further arranged inside the earphone main body 100, the sound pickup cavity 100b is formed in the component, and the sound pickup hole 100a and the microphone are acoustically coupled through the sound pickup cavity 100b formed by the separate component, which is not specifically limited.

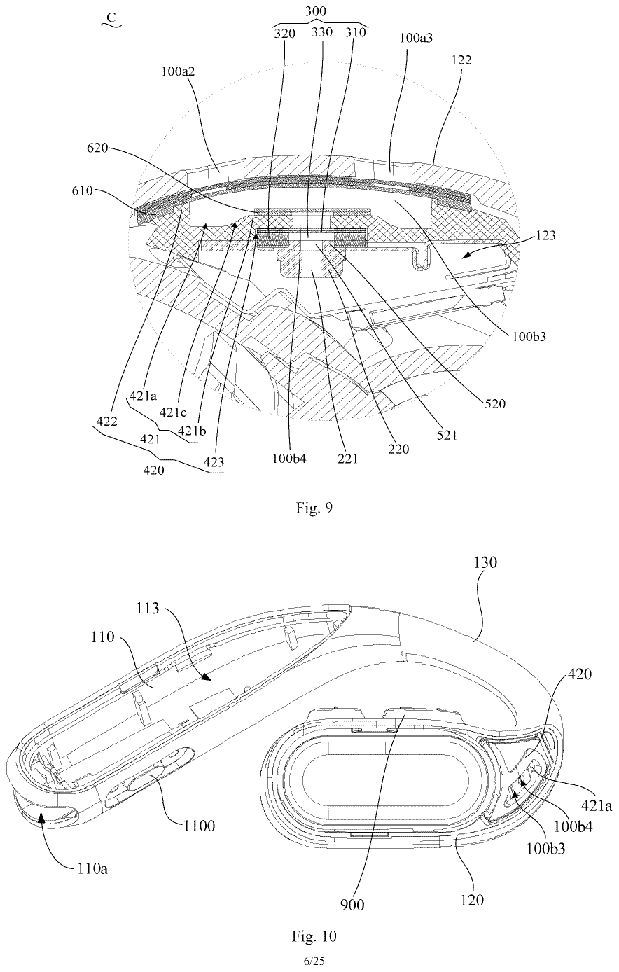

Please refer to FIG. 7 and FIG. 9, the waterproof and breathable assembly 300 is arranged on one side of the microphone. The waterproof and breathable assembly 300 is mainly used to prevent the water in the sound pickup cavity 100b from flowing to the microphone, and the microphone and the sound pickup cavity 100b are acoustically coupled through the waterproof and breathable assembly 300, that is, the waterproof and breathable assembly 300 can be used to block the water flow entering the sound pickup cavity 100b from flowing into the microphone, so as to avoid the failure of the microphone due to water ingress, thereby improving the waterproof performance of the earphone 10 and prolonging the service life of the earphone 10.

According to the technical solution of the present disclosure, the waterproof and breathable assembly 300 is arranged in the earphone main body 100 and on one side of the microphone, and the waterproof and breathable assembly 300 can prevent the water entering the sound pickup cavity 100b from flowing to the microphone, and therefore prevent the failure of the microphone due to water ingress. Through the arrangement of the waterproof and breathable assembly 300, the overall waterproof performance of the earphone 10 is improved, and the use performance of the earphone 10 is ensured.

Please refer to FIG. 7 and FIG. 9, in an embodiment, the sound pickup hole 100a and the microphone are arranged in a staggered manner in an axial direction of the sound pickup hole 100a.

Specifically, the sound pickup hole 100a and the microphone being arranged in a staggered manner may be understood as that there being a projection plane perpendicular to the axis of the sound pickup hole 100a, and an orthographic projection of the sound pickup hole 100a toward the projection plane not overlapping with an orthographic projection of the microphone toward the projection plane. It is considered that the water flowing to the microphone usually first flows into the sound pickup cavity 100b through the sound pickup hole 100a formed in the earphone main body 100, and then flows to the microphone, the staggered arrangement of the sound pickup hole 100a and the microphone in the axial direction of the sound pickup hole 100a has a certain blocking effect on the water flow flowing into the sound pickup cavity 100b, and prolongs the flow path of the water flow. Furthermore, other obstacles may be arranged on the path of the water flow to slow down or prevent the water flow, so as to improve the waterproof performance of the microphone, and at the same time, avoid the problem that the water flows directly into the microphone through the sound pickup hole 100a, resulting in the failure of the microphone. It should be noted that the projection plane here is a virtual plane perpendicular to the axis of the sound pickup hole 100a.

Please continue to refer to FIG. 7 and FIG. 9, in an embodiment, the waterproof and breathable assembly 300 includes a waterproof and breathable membrane 310 and a sealing connector 320, a waterproof and breathable cavity 330 is formed between the waterproof and breathable membrane 310 and the microphone, and the waterproof and breathable membrane 310 is acoustically coupled with the microphone through the waterproof and breathable cavity 330.

Specifically, the number of the layer of the waterproof and breathable membrane 310 may be one, or may be a plurality. The waterproof and breathable membrane 310 is mainly characterized by water resistance and breathability, that is, water flow cannot pass through the waterproof and breathable membrane 310, and any water flow entering the sound pickup cavity 100b will be blocked by the waterproof and breathable membrane 310 on the other side of the microphone, and will not flow to the microphone to cause the failure of the microphone, thereby improving the waterproof performance of the earphone 10, and ensuring the use performance and the service life of the earphone 10. Optionally, the material of the waterproof and breathable membrane 310 includes any one selected from a group consisting of polytetrafluoroethylene, expanded polytetrafluoroethylene, polyurethane resin, and thermoplastic polyurethane.

The waterproof and breathable membrane 310 is arranged in a sheet shape, and the sealing connector 320 is used to connect the waterproof and breathable membrane 310 with other components in the earphone main body 100, so as to form a closed waterproof and breathable cavity 330 between the waterproof and breathable membrane 310 and the microphone. The shape and size of the sealing connector 320 are adapted to the shape and size of the waterproof and breathable membrane 310, which is not specifically limited.

Further, the sealing connector 320 is a compressible elastic sealing component 320. In this way, the elastic sealing connector 320 may cooperate with other components to allow the entire waterproof and breathable assembly 300 to be pressed against the earphone main body 100, so as to further improve the waterproof effect of the waterproof and breathable assembly 300, and ensure the tightness of the waterproof and breathable cavity 330. It should be noted that the sealing connector 320 is also a connector with a waterproof effect, and its material is preferably waterproof foam, which can prevent water flow from flowing into the waterproof and breathable cavity 330 through the sealing connector 320. The waterproof foam may adopt pron4701 foam, and other types of waterproof foam are also acceptable.

Please refer to FIG. 3 and FIG. 4, in an embodiment, the at least one sound pickup hole 100a includes a first sound pickup hole 100a1 and a second sound pickup hole 100a2, the earphone main body 100 includes a main body portion 110 and a sound producing portion 120, the first sound pickup hole 100a1 is formed on the main body portion 110, the second sound pickup hole 100a2 is formed on the sound producing portion 120, the microphone group 200 includes a first microphone 210 and a second microphone 220, the first microphone 210 is acoustically coupled with the first sound pickup hole 100a1, and the second microphone 220 is acoustically coupled with the second sound pickup hole 100a2.

Exemplarily, two sound pickup holes 100a are provided, the earphone main body 100 includes a main body portion 110 and a sound producing portion 120, a charging pin assembly 1100, a light guide column 1000, a circuit board and the like are installed in the main body portion 110, and the sound producing portion 120 is provided with a speaker assembly for making a sound for the user to hear. The sound pickup holes 100a are formed on both the main body portion 110 and the sound producing portion 120, and the first microphone 210 and the second microphone 220 are arranged corresponding to the sound pickup holes 100a, so that the sound pickup effect of the earphone 10 can be further improved. The first microphone 210 corresponds to the first sound pickup hole 100a1 and is arranged in the main body portion 110, and the second microphone 220 corresponds to the second sound pickup hole 100a2 and is arranged in the sound producing portion 120. It should be mentioned that in the wearing state, the main body portion 110 is located at the back side of the ear. In this way, under the shielding of the ear, the wind can be avoided, so as to effectively reduce the air flow blown to the first sound pickup hole 100a1, thereby reducing wind noise.

Please refer to FIG. 9, further, the at least one sound pickup hole 100a further includes a third sound pickup hole 100a3 formed in the sound producing portion 120, the third sound pickup hole 100a3 is spaced apart from the second sound pickup hole 100a2, and a projection of the second microphone 220 on the sound producing portion 120 in an axial direction of the second microphone 220 is located between the second sound pickup hole 100a2 and the third sound pickup hole 100a3.

Exemplarily, when the earphone 10 is in use, the main body portion 110 is located at the back side of the contour of the human ear, and the sound producing portion 120 is located at the front side of the contour of the ear, the sound pickup effect of the sound producing portion 120 is better than that of the main body portion 110, therefore, the third sound pickup hole 100a3 is further formed in the sound producing portion 120 to ensure the sound pickup effect of the earphone 10. The third sound pickup hole 100a3 and the second sound pickup hole 100a2 are spaced apart, and may be spaced apart along the length direction of the sound producing portion 120, or may be spaced apart along the width direction of the sound producing portion 120, which is not specifically limited.

The second microphone 220 is arranged in the sound producing portion 120, and the second microphone 220 is acoustically coupled with the second sound pickup hole 100a2 and the third sound pickup hole 100a3 through the sound pickup cavity 100b. The projection of the second microphone 220 on the sound producing portion 120 in the axial direction of the second microphone 220 is located between the second sound pickup hole 100a2 and the third sound pickup hole 100a3, that is, when specifically determining the positions of the second microphone 220, the second sound pickup hole 100a2, and the third sound pickup hole 100a3, an inner wall surface of the sound producing portion 120 on a side where the second sound pickup hole 100a2 and the third sound pickup hole 100a3 are formed may be taken as a reference surface (the inner wall surface may be a plane surface or a curved surface, which is specifically determined according to the structure and shape of the sound producing portion 120), so as to determine the positions of the three structures.

The projection of the second microphone 220 in the axial direction of the second microphone 220 is located between the second sound pickup hole 100a2 and the third sound pickup hole 100a3, and the projection of the second microphone 220 on the reference surface may partially overlap with the second sound pickup hole 100a2 and the third sound pickup hole 100a3, or may not overlap with the second sound pickup hole 100a2 and the third sound pickup hole 100a3. In order to prevent the water flowing into the sound pickup cavity 100b through the second sound pickup hole 100a2 and the third sound pickup hole 100a3 from directly flowing to the second microphone 220 and causing the failure of the second microphone 220, preferably, the projection of the second microphone 220 on the reference surface does not overlap with the second sound pickup hole 100a2 and the third sound pickup hole 100a3, and has a certain distance from the second sound pickup hole 100a2 and the third sound pickup hole 100a3. In this way, the waterproof performance of the second microphone 220 is improved, and at the same time, the problem that the second microphone 220 fails due to the water flowing directly into the second microphone 220 through the second sound pickup hole 100a2 and the third sound pickup hole 100a3 is also avoided.

Similarly, when determining the positions of the first sound pickup hole 100a1 and the first microphone 210, the above method may also be applied for determination.

Further, the second sound pickup hole 100a2 and the third sound pickup hole 100a3 are arranged at a certain distance from each other, which may be understood as being symmetrically arranged, so that when wind enters from the second sound pickup hole 100a2 and the third sound pickup hole 100a3, the wind meets in the sound pickup cavity 100b, and because sound interference occurs between the second sound pickup hole 100a2 and the third sound pickup hole 100a3 at the sound pickup cavity 100b, the phenomenon of resonance silencing is generated, so as to filter out high-frequency sound in wind noise.

Specifically, the second sound pickup hole 100a2 and the third sound pickup hole 100a3 are communicated with each other through the sound pickup cavity 100b. When the wind enters from the second sound pickup hole 100a2, it may flow into the third sound pickup hole 100a3 through the sound pickup cavity 100b, and the wind entering from the third sound pickup hole 100a3 may also flow into the second sound pickup hole 100a2 through the sound pickup cavity 100b, so that the communicated second sound pickup hole 100a2 and the third sound pickup hole 100a3 can weaken wind energy, thereby further reducing the energy of the wind entering the sound pickup cavity 100b.

Please refer to FIGS. 5 to 7, in an embodiment, the main body portion 110 includes a first housing 111 and a main board cover 112, the first housing 111 and the main board cover 112 enclose to form a main body accommodating cavity 113, and the first sound pickup hole 100a1 is formed in the main board cover 112.

Exemplarily, the main body portion 110 is formed with an installation space, and the main board cover 112 is arranged in a plate shape, which is specifically an arc-shaped plate with a certain radian. Certainly, in other embodiments, the main board cover 112 may also be arranged as a straight plate. The first housing 111 has an opening, and the arc-shaped main board cover 112 covers the opening to form a sealed main body accommodating cavity 113 for the installation of other components of the earphone 10. The first housing 111 and the main board cover 112 may be connected by clamping, gluing or clamping and gluing, or may be connected by other means, which is not specifically limited. In order to ensure the stability and waterproofness of the connection between the main board cover 112 and the first housing 111, the first housing 111 and the main board cover 112 may be connected by clamping, and then glue is applied to the connecting gap between the first housing 111 and the main board cover 112 to prevent water from flowing into the main body accommodating cavity 113 through the connecting gap between the main board cover 112 and the first housing 111, and from causing damage to internal components, thereby further improving the waterproof performance of the earphone 10.

The first sound pickup hole 100a1 is formed in the main board cover 112, and when the earphone 10 is in use, the main board cover 112 is a side away from the user's skin, so as to ensure the sound pickup effect of the earphone 10, and at the same time, prevent the sweat of the human body from directly flowing into the main body accommodating cavity 113 through the first sound pickup hole 100a1, and from causing the failure of the first microphone 210. It should be noted here that the main body accommodating cavity 113 is enclosed by the first housing 111 and the main board cover 112. If the sound pickup cavity 100b is not formed by a separate component, the main body accommodating cavity 113 in this case is equivalent to the sound pickup cavity 100b that communicates the first sound pickup hole 100a1 with the first microphone 210. If the sound pickup cavity 100b is formed by a separate component, the main body accommodating cavity 113 is an installation cavity for placing the separate component.

Please refer to FIG. 7, in an embodiment, the sound pickup cavity 100b includes a first sound pickup cavity 100b1 and a second sound pickup cavity 100b2 that are communicated with each other, the first sound pickup cavity 100b1 is communicated with the first sound pickup hole 100a1, the second sound pickup cavity 100b2 is acoustically coupled with the first microphone 210 through the waterproof and breathable assembly 300, and the first sound pickup cavity 100b1 is at least partially located at an outer side of the second sound pickup cavity 100b2 in an axial direction of the first sound pickup hole 100a1.

Exemplarily, the sound pickup cavity 100b includes a first sound pickup cavity 100b1 and a second sound pickup cavity 100b2 that are communicated with each other, the first sound pickup cavity 100b1 and the second sound pickup cavity 100b2 are both located in the main body portion 110, and the first sound pickup hole 100a1 is communicated with the first sound pickup cavity 100b1, and is acoustically coupled with the first microphone 210 through the second sound pickup cavity 100b2 and the waterproof and breathable assembly 300. The first sound pickup cavity 100b1 is at least partially located on the outer side of the second sound pickup cavity 100b2 in the axial direction of the first sound pickup hole 100a1, that is, the first sound pickup cavity 100b1 and the second sound pickup cavity 100b2 are staggered in the axial direction of the first sound pickup hole 100a1. With such a configuration, after flowing into the sound pickup cavity 100b through the first sound pickup hole 100a1, the water flow will flow through the first sound pickup cavity 100b1 and the second sound pickup cavity 100b2 in sequence before flowing to the first microphone 210. The staggered arrangement of the first sound pickup cavity 100b1 and the second sound pickup cavity 100b2 prolongs the flow path of the water flow on the one hand, and on the other hand, plays a role in blocking and delaying the flow of the water flow flowing into the sound pickup cavity 100b, thereby reducing the impact force of the water flow, and preventing the waterproof and breathable membrane 310 of the waterproof and breathable assembly 300 from being damaged by the impact of the water flow.

Please continue to refer to FIG. 7, in an embodiment, the earphone 10 includes a first sound pickup frame 410, the first sound pickup cavity 100b1 and the second sound pickup cavity 100b2 are formed in the first sound pickup frame 410, a first step surface 411 is formed between a cavity wall of the first sound pickup cavity 100b1 and a cavity wall of the second sound pickup cavity 100b2, and a projection of the first step surface 411 on the main board cover 112 in the axial direction of the first sound pickup hole 100a1 covers the first sound pickup hole 100a1.

Exemplarily, the first sound pickup frame 410 is installed in the main body accommodating cavity 113, the first sound pickup cavity 100b1 and the second sound pickup cavity 100b2 are formed by the first sound pickup frame 410, and the first microphone 210 is acoustically coupled with the second sound pickup cavity 100b2 through the waterproof and breathable assembly 300, and the two are relatively sealed. In this way, the water flowing into the sound pickup cavity 100b through the first sound pickup hole 100a1 will only flow in the first sound pickup cavity 100b1 and the second sound pickup cavity 100b2, and will not flow to other places in the main body accommodating cavity 113, will not cause other components in the main body accommodating cavity 113 to fail due to water inflow, thereby ensuring the use performance and the service life of the earphone 10. The first step surface 411 is formed between the cavity wall of the first sound pickup cavity 100b1 and the cavity wall of the second sound pickup cavity 100b2, and the first step surface 411 is arranged opposite to and spaced apart from the first sound pickup hole 100a1, so that the water flowing into the first sound pickup cavity 100b1 through the first sound pickup hole 100a1 will first flow to the first step surface 411, and the first step surface 411 plays a role in buffering the flow of the water flow, thereby preventing the waterproof and breathable membrane 310 from being damaged by excessive impact force of the water flow, and ensuring the waterproof performance of the first microphone 210.

The projection of the first step surface 411 on the main board cover 112 in the axial direction of the first sound pickup hole 100a1 covers the first sound pickup hole 100a1, that is, the area of the first step surface 411 is larger than the area of the first sound pickup hole 100a1, so as to ensure that no matter where the water flow flows into the first sound pickup cavity 100b1 from the first sound pickup hole 100a1, it will first flow to the first step surface 411.

Please continue to refer to FIG. 7, in an embodiment, a second step surface 412 is further formed between the cavity wall of the first sound pickup cavity 100b1 and the cavity wall of the second sound pickup cavity 100b2, a first inflection point M is provided at a connection position between the cavity wall of the first sound pickup cavity 100b1 and the second step surface 412, a second inflection point N is provided at a connection position between the cavity wall of the second sound pickup cavity 100b2 and the second step surface 412, the first microphone 210 includes a first microphone channel 211, and a shortest distance from the first inflection point M to an axis of the first microphone channel 211 is smaller than a shortest distance from the second inflection point N to the first microphone channel 211.

Exemplarily, the first microphone channel 211 refers to a channel through which external sound information enters the first microphone 210 for information processing, and the channel is arranged on the first microphone 210. The waterproofing of the first microphone 210 is mainly to prevent water flow from entering the first microphone 210 through the first microphone channel 211 and damaging the microphone. The second step surface 412 is further formed between the cavity wall of the first sound pickup cavity 100b1 and the cavity wall of the second sound pickup cavity 100b2, and the first step surface 411 and the second step surface 412 are respectively located on two opposite sides of a side wall of the sound pickup cavity 100b, where the connection position between the cavity wall of the first sound pickup cavity 100b1 and the second step surface 412 is a line segment, and the first inflection point M is any point on the line segment. Similarly, the connection position between the cavity wall of the second sound pickup cavity 100b2 and the second step surface 412 is also a line segment, and the second inflection point N is any point on the line segment.

Since the second sound pickup cavity 100b2 is arranged close to the first microphone 210, in order to prevent the water flow flowing into the second sound pickup cavity 100b2 from flowing into the first microphone 210 and causing the failure of the first microphone 210, the shortest distance from the first inflection point M to the axis of the first microphone channel 211 is chosen to be set smaller than the shortest distance from the second inflection point N to the first microphone channel 211. In this way, the cavity wall of the second sound pickup cavity 100b2 has a certain distance from the first microphone channel 211, and the water flow is not easy to flow from the cavity wall of the second sound pickup cavity 100b2 to the first microphone 210, thereby ensuring the service life of the first microphone 210, and the second step surface 412 also plays a certain role in buffering and blocking the water.

Please continue to refer to FIG. 7, in an embodiment, a first installation groove 413 is formed on a side of the first sound pickup frame 410 away from the first sound pickup hole 100a1, and a groove bottom of the first installation groove 413 is communicated with the second sound pickup cavity 100b2; the waterproof and breathable assembly 300 is arranged in the first installation groove 413, the earphone 10 further includes a first installation component 510, and the first installation component 510 hermetically presses the waterproof and breathable assembly 300 into the first installation groove 413.

Exemplarily, the first sound pickup frame 410 is further provided with the first installation groove 413, and the waterproof and breathable assembly 300 is hermetically pressed and connected in the first installation groove 413 through the first installation component 510. Two sides of the sealing connector 320 may be respectively bonded to the groove bottom of the first installation groove 413 and a surface of the first installation component 510 to increase the stability of its installation, and a closed waterproof and breathable cavity 330 is formed between the waterproof and breathable membrane 310 and the first microphone 210 to prevent water flow from entering the waterproof and breathable cavity 330 and damaging the first microphone 210. The first installation component 510 may be configured as a rigid circuit board or a flexible circuit board, which is not specifically limited.

Further, the first microphone 210 is arranged on a side of the first installation component 510 away from the first sound pickup hole 100a1 and connected with the first installation component 510, the waterproof and breathable assembly 300 is arranged on the other side of the first installation component 510, the first installation component 510 has a first sound passing channel 511, and the first sound passing channel 511 is arranged corresponding to the first microphone channel 211; the first microphone 210 is acoustically coupled with the waterproof and breathable assembly 300 through the first sound passing channel 511.

Exemplarily, the first microphone 210 is arranged on the first installation component 510, and the first installation component 510 is provided with the first sound passing channel 511, the first sound passing channel 511 is communicated with the waterproof and breathable cavity 330 (the first sound passing channel 511 may also be regarded as a part of the waterproof and breathable cavity 330), and the first sound passing channel 511 is arranged corresponding to the first microphone channel 211. In this way, external sound information directly enters the first microphone 210 through the first sound passing channel 511 for processing, and there is no gap between the first sound passing channel 511 and the first microphone channel 211, thereby avoiding the risk of water entering the first microphone 210 through the gap. The first installation component 510 may be a component that is arranged in the main body portion 110 and is specially used for the installation of the first microphone 210, or may be a circuit board arranged in the main body portion 110, which may be configured as a flexible circuit board or a rigid circuit board, which is not specifically limited.

Please refer to FIG. 7, in an embodiment, in the axial direction of the first sound pickup hole 100a1, a thickness of the elastic sealing component 320 is larger than a distance between the groove bottom of the first installation groove 413 and the first installation component 510.

Exemplarily, in order to ensure the sealing performance of the connection between the waterproof and breathable assembly 300 and the first sound pickup frame 410 and the first installation component 510, a compressible elastic connector may be used to ensure the sealing performance of the connection between the waterproof and breathable assembly 300 and the first sound pickup frame 410 and the first installation component 510 through pre-compression, so that the waterproof and breathable membrane 310 is in sealing fit with the first installation groove 413 and the first installation component 510 to prevent water from entering, thereby improving the waterproof performance of the first microphone 210. Therefore, the thickness of the elastic sealing component 320 here is set to be larger than the distance between the groove bottom of the first installation groove 413 and the first installation component 510. In order to ensure the sealing effect of the elastic sealing component 320, the compression ratio of the elastic sealing component 320 is set to be 40%-70%. For example, the initial thickness of the elastic sealing component 320 is 0.34 mm, the compressed thickness is 0.2 mm, and the compression ratio is 46%. Alternatively, the initial thickness of the elastic sealing component 320 is 0.3 mm, the compressed thickness is 0.1 mm, and the compression ratio is 66%.

In an embodiment, the first housing 111 and the main board cover 112 are bonded. Exemplarily, the first housing 111 and the main board cover 112 are connected together by gluing, which further improves the waterproof performance of the earphone 10, and prevents the situation that external water flow enters through the gap at the connection position between the first housing 111 and the main board cover 112, causing damage to components in the main body portion 110 and the failure of the earphone 10.

Please refer to FIGS. 8 to 10, in an embodiment, the sound producing portion 120 includes a second housing 121 and an outer cover 122, the outer cover 122 and the second housing 121 enclose to form a sound producing accommodating cavity 123, the second microphone 220 is arranged in the sound producing accommodating cavity 123, and the second sound pickup hole 100a2 and the third sound pickup hole 100a3 are formed in the outer cover 122.

Exemplarily, the sound producing portion 120 is formed with an installation space, and the outer cover 122 is arranged in a plate shape, which is specifically an arc-shaped plate with a certain radian. Certainly, in other embodiments, the outer cover 122 may also be arranged as a straight plate. The second housing 121 has an opening, and the arc-shaped outer cover 122 covers the opening to form a sealed sound producing accommodating cavity 123 for the installation of other components of the earphone 10. The second housing 121 and the outer cover 122 may be connected by clamping, gluing or clamping and gluing, or may be connected by other means, which is not specifically limited. In order to ensure the stability and waterproofness of the connection between the outer cover 122 and the second housing 121, the second housing 121 and the outer cover 122 may be connected by clamping, and then glue is applied to the connecting gap between the second housing 121 and the outer cover 122 to prevent water from flowing into the main body accommodating cavity 113 through the connecting gap between the outer cover 122 and the second housing 121, causing damage to internal components, thereby further improving the waterproof performance of the earphone 10.

The second sound pickup hole 100a2 and the third sound pickup hole 100a3 are formed in the outer cover 122, and when the earphone 10 is in use, the outer cover 122 is a side away from the user's skin, so as to ensure the sound pickup effect of the earphone 10, and at the same time, prevent the sweat of the human body from directly flowing into the sound producing accommodating cavity 123 through the second sound pickup hole 100a2 and the third sound pickup hole 100a3, causing the failure of the second microphone 220. It should be noted here that the sound producing accommodating cavity 123 is enclosed by the second housing 121 and the outer cover 122. If the sound pickup cavity 100b is not formed by a separate component, the sound producing accommodating cavity 123 in this case is equivalent to the sound pickup cavity 100b that communicates with the second sound pickup hole 100a2, the third sound pickup hole 100a3 and the second microphone 220. If the sound pickup cavity 100b is formed by a separate component, the sound producing accommodating cavity 123 is an installation cavity for placing the separate component.

Please refer to FIG. 9, in an embodiment, the sound pickup cavity 100b includes a main sound cavity 100b3 and a secondary sound cavity 100b4 that are communicated with each other, the main sound cavity 100b3 is communicated with the second sound pickup hole 100a2 and the third sound pickup hole 100a3, and the secondary sound cavity 100b4 is acoustically coupled with the second microphone 220 through the waterproof and breathable membrane 310.

Exemplarily, the sound pickup cavity 100b includes a main sound cavity 100b3 and a secondary sound cavity 100b4 that are communicated with each other, the main sound cavity 100b3 and the secondary sound cavity 100b4 are both located in the sound producing portion 120, and the second sound pickup hole 100a2 and the third sound pickup hole 100a3 are communicated with the main sound cavity 100b3, and are acoustically coupled with the second microphone 220 through the secondary sound cavity 100b4 and the waterproof and breathable assembly 300. The waterproof and breathable membrane 310 can prevent the water in the secondary sound cavity 100b4 from flowing to the second microphone 220, thereby further improving the waterproof performance of the second microphone 220 and preventing it from failing due to water ingress.

Please refer to FIGS. 8 to 10, in an embodiment, the earphone 10 includes a second sound pickup frame 420, the main sound cavity 100b3 and the secondary sound cavity 100b4 are formed in the second sound pickup frame 420, the secondary sound cavity 100b4 is acoustically coupled with the waterproof and breathable cavity 330 through the waterproof and breathable membrane 310, the earphone 10 has a projection plane perpendicular to an axis of the second sound pickup hole 100a2, and an orthographic projection of the secondary sound cavity 100b4 toward the projection plane is located between an orthographic projection of the second sound pickup hole 100a2 toward the projection plane and an orthographic projection of the third sound pickup hole 100a3 toward the projection plane.

Exemplarily, the second sound pickup frame 420 is installed in the sound producing accommodating cavity 123, the main sound cavity 100b3 and the secondary sound cavity 100b4 are formed by the second sound pickup frame 420, and the second microphone 220 is acoustically coupled with the secondary sound cavity 100b4 through the waterproof and breathable assembly 300, and the two are relatively sealed. In this way, the water flowing into the sound pickup cavity 100b through the second sound pickup hole 100a2 and the third sound pickup hole 100a3 will only flow in the main sound cavity 100b3 and the secondary sound cavity 100b4, and will not flow to other places in the sound producing accommodating cavity 123, will not cause other components in the sound producing accommodating cavity 123 to fail due to water ingress, thereby ensuring the use performance and the service life of the earphone 10.

In this case, the earphone 10 has a projection plane perpendicular to the axis of the second sound pickup hole 100a2, and the orthographic projection of the secondary sound cavity 100b4 toward the projection plane is located between the orthographic projection of the second sound pickup hole 100a2 toward the projection plane and the orthographic projection of the third sound pickup hole 100a3 toward the projection plane. That is, there is a projection plane perpendicular to the axis of the second sound pickup hole 100a2 or the third sound pickup hole 100a3, and the orthographic projection of the second microphone 220 on the projection plane in the direction toward the sound producing portion 120 is located between two orthographic projections of the second sound pickup hole 100a2 and the third sound pickup hole 100a3 on the projection plane in the direction toward the sound producing portion 120. The projection of the second microphone 220 on the projection plane may partially overlap with the orthographic projections of the second sound pickup hole 100a2 and the third sound pickup hole 100a3, or may not overlap with the orthographic projections of the second sound pickup hole 100a2 and the third sound pickup hole 100a3. In order to prevent the water flowing into the sound pickup cavity 100b through the second sound pickup hole 100a2 and the third sound pickup hole 100a3 from directly flowing to the second microphone 220 and causing the failure of the second microphone 220, preferably, the projection of the second microphone 220 on the projection plane does not overlap with the projections of the second sound pickup hole 100a2 and the third sound pickup hole 100a3 on the projection plane, and has a certain distance from the projections of the second sound pickup hole 100a2 and the third sound pickup hole 100a3 on the projection plane. In this way, the waterproof performance of the second microphone 220 is improved, and at the same time, the problem that the second microphone 220 fails due to the water flowing directly into the second microphone 220 through the second sound pickup hole 100a2 and the third sound pickup hole 100a3 is also avoided.

It should be noted that, the orthographic projection of the secondary sound cavity 100b4 toward the projection plane refers to that a light source is arranged on a midline or an axis of the secondary sound cavity 100b4, and the light source irradiates in the direction toward the projection plane. Since the secondary sound cavity 100b4 is formed in the second sound pickup frame 420, and the second sound pickup frame 420 is a solid structure, when the light source irradiates in the direction toward the projection plane, a shadow part of the second sound pickup frame 420 will be formed on the projection plane, and since the secondary sound cavity 100b4 is a cavity, the light will directly pass through the secondary sound cavity 100b4, so no shadow will be formed on the projection plane, that is, in this case, a shadow part of the second sound pickup frame 420 and a non-shadow part enclosed by the shadow part will be formed on the projection plane, and in this case, the non-shadow part is the orthographic projection of the secondary sound cavity 100b4 toward the projection plane. Similarly, the determination principle of the orthographic projections of the second sound pickup hole 100a2 and the third sound pickup hole 100a3 is the same as above. It should be noted here that when determining the orthographic projection of the second sound pickup hole 100a2 toward the projection plane, the light source is located on the midline or the axis of the second sound pickup hole 100a2, and when determining the orthographic projection of the third sound pickup hole 100a3 toward the projection plane, the light source is located on the midline or the axis of the third sound pickup hole 100a3, or the light source may be set as a relatively large light source that may emit light rays to simultaneously cover the second sound pickup frame 420, the second sound pickup hole 100a2, and the third sound pickup hole 100a3.

It should be further noted that, the projection plane here is a virtual plane perpendicular to the axis of the second sound pickup hole 100a2. When specifically determining the positions of the second microphone 220, the second sound pickup hole 100a2, and the third sound pickup hole 100a3, a plane may be arranged outside the second microphone 220, the second sound pickup hole 100a2, and the third sound pickup hole 100a3 as the projection plane, or an inner wall surface of the sound producing portion 120 on a side where the second sound pickup hole 100a2 and the third sound pickup hole 100a3 are formed may be taken as a reference surface (the inner wall surface may be a plane surface or a curved surface, which is specifically determined according to the structure and shape of the sound producing portion 120), so as to determine the positions of the three structures. Similarly, when determining the positions of the first sound pickup hole 100a1 and the first microphone 210, the above method may also be applied for determination.

Please refer to FIG. 9, in an embodiment, the second sound pickup frame 420 includes a sound frame bottom portion 421 and a sound frame side portion 422, the sound frame bottom portion 421 is connected with the sound frame side portion 422, and the sound frame bottom portion 421 is provided with a waterproof groove 421a opposite to the second sound pickup hole 100a2 and the third sound pickup hole 100a3.

Exemplarily, the sound frame bottom portion 421 and the sound frame side portion 422 are in an integral structure, and the sound frame bottom portion 421 is arranged opposite to and spaced apart from the outer cover 122. The waterproof groove 421a may allow the water entering the main sound cavity 100b3 through the second sound pickup hole 100a2 and the third sound pickup hole 100a3 to accumulate therein, so as to prevent the water from flowing into the secondary sound cavity 100b4 and flowing to the second microphone 220 to cause the failure of the second microphone 220 when the user is moving or exercising. The design of the waterproof groove 421a reduces the probability of the water flowing to the second microphone 220, further improves the waterproofness of the second microphone 220, and ensures the use performance and the service life of the earphone 10.

Further, the sound frame bottom portion 421 and the sound frame side portion 422 enclose to form the main sound cavity 100b3, the sound frame bottom portion 421 is formed with a boss 421b protruding toward the outer cover 122, and the waterproof groove 421a is formed between the boss 421b and an inner wall of the sound frame side portion 422.

It is worth mentioning that, a connection position between the boss 421b and the waterproof groove 421a is inclined to smoothly transit to form a flow guide surface 421c. Exemplarily, the flow guide surface 421c extends obliquely from a surface of the boss 421b to a bottom of the waterproof groove 421a, and the arrangement of the flow guide surface 421c may guide the water to flow into the waterproof groove 421a when the water falls on the surface of the boss 421b, so as to prevent the water on the surface of the boss 421b from flowing into the secondary sound cavity 100b4 along the surface of the boss 421b when the user is moving or exercising, thereby reducing the probability of the water flow flowing to the second microphone 220, further improving the waterproofness of the second microphone 220, and ensuring the use performance and the service life of the earphone 10. In this case, the obliquely extending flow guide surface 421c may play a certain role in changing the direction of the wind fluid, that is, part of the wind fluid changes the direction, and in this way, the wind fluid that changes the direction may form a certain resistance, which slows down the flow velocity of the wind fluid flowing to the second microphone 220, so that the energy of the wind flowing to the second microphone 220 is relatively small, thereby reducing the wind noise.

Please continue to refer to FIG. 9, in an embodiment, the secondary sound cavity 100b4 is formed in the sound frame bottom portion 421, the secondary sound cavity 100b4 includes a secondary sound cavity inlet and a secondary sound cavity outlet (not shown in the figure), the secondary sound cavity inlet is formed in the surface of the boss 421b, and the secondary sound cavity outlet is formed in an outer wall surface of the sound frame bottom portion 421 and is arranged corresponding to the waterproof and breathable membrane 310.

Specifically, the secondary sound cavity inlet is formed in the surface of the boss 421b, and has a certain height difference from the bottom of the waterproof groove 421a, which further reduces the probability of the water flow flowing into the secondary sound cavity 100b4, and improves the waterproof effect of the second microphone 220. The secondary sound cavity outlet is formed in the outer wall surface of the sound frame bottom portion 421 and is arranged corresponding to the waterproof and breathable membrane 310, so that the water flow flowing into the secondary sound cavity 100b4 can be blocked by the waterproof and breathable membrane 310 on one side, so as to prevent it from flowing into the microphone and causing damage to the microphone.

Please continue to refer to FIG. 9, in an embodiment, a second installation groove 423 is formed on a side of the second sound pickup frame 420 away from the outer cover 122, a groove bottom of the second installation groove 423 is communicated with the secondary sound cavity 100b4, the waterproof and breathable assembly 300 is arranged in the second installation groove 423, the earphone 10 further includes a second installation component 520, and the second installation component 520 hermetically presses the waterproof and breathable assembly 300 into the second installation groove 423.

Exemplarily, the second installation groove 423 is further formed in the second sound pickup frame 420, and the waterproof and breathable assembly 300 is hermetically pressed and connected in the second installation groove 423 through the second installation component 520. Two sides of the sealing connector 320 may be respectively bonded to the groove bottom of the second installation groove 423 and a surface of the second installation component 520 to increase the stability of its installation, and a closed waterproof and breathable cavity 330 is formed between the waterproof and breathable membrane 310 and the second microphone 220 to prevent water flow from entering the waterproof and breathable cavity 330 and damaging the second microphone 220. The second installation component 520 may be a component that is arranged in the sound producing portion 120 and is specially used for the installation of the second microphone 220, or may be a circuit board arranged in the sound producing portion 120, which may be configured as a flexible circuit board or a rigid circuit board.

Further, since other components, such as a speaker, that occupy relatively large volume are also arranged in the sound producing accommodating cavity 123, in order to make reasonable use of the space in the sound producing accommodating cavity 123 and ensure the waterproofness of the earphone 10 while achieving a compact structure, the second installation component 520 may be chosen to be configured as a flexible circuit board. Firstly, the flexible circuit board is flexible and may be freely bent and folded, and will not be damaged after being bent for tens of thousands of times, and may be arbitrarily arranged according to the space layout, and may be arbitrarily stretched and moved in a three-dimensional space, so as to realize the integration of component assembly and wiring, with high flexibility, which is convenient for the circuit board to bend and fold according to the installation environment. Secondly, the flexible circuit board is thin, light and flat, which makes the structural layout of the earphone 10 more compact and reasonable, reduces the volume and weight of the earphone 10, and makes it convenient to carry. Thirdly, the flexible circuit board is highly safe, because the wires of the flexible circuit board are integrally connected and have highly consistent parameters, which may reduce the error problems when the wires are assembled, and reduce the occurrence of failures of the earphone 10. Fourthly, the flexible circuit board has high assembly reliability, and the planar wiring of the flexible circuit board may reduce switch interconnection, facilitate circuit design, reduce assembly work, improve the reliability of the whole system of the earphone 10, and facilitate fault detection. Fifthly, the flexible circuit board has good heat dissipation, weldability and easy assembly, and has various base materials, which may be selected according to different requirements.

Please continue to refer to FIG. 9, in an embodiment, the second microphone 220 is arranged on a side of the second installation component 520 away from the second sound pickup hole 100a2 and the third sound pickup hole 100a3 and connected with the second installation component 520, the waterproof and breathable assembly 300 is arranged on the other side of the second installation component 520, the second installation component 520 has a second sound passing channel 521, the second microphone 220 has a second microphone channel 221, and the second microphone 220 is acoustically coupled with the waterproof and breathable assembly 300 through the second sound passing channel 521.

Exemplarily, the second microphone 220 is arranged on the second installation component 520, and the second installation component 520 is provided with the second sound passing channel 521, the second sound passing channel 521 is communicated with the waterproof and breathable cavity 330 (the second sound passing channel 521 may also be regarded as a part of the waterproof and breathable cavity 330), and the second sound passing channel 521 is arranged corresponding to the second microphone channel 221. In this way, external sound information directly enters the second microphone 220 through the second sound passing channel 521 for processing, and there is no gap between the second sound passing channel 521 and the second microphone channel 221, thereby avoiding the risk of water entering the second microphone 220 through the gap.

Please continue to refer to FIG. 9, in an embodiment, in the axial direction of the second sound pickup hole 100a2, a thickness of the elastic sealing component 320 is larger than a distance between the groove bottom of the second installation groove 423 and the second installation component 520.

Specifically, in order to ensure the sealing performance of the connection between the waterproof and breathable assembly 300 and the second sound pickup frame 420 and the second installation component 520, a compressible elastic connector may be used to ensure the sealing performance of the connection between the waterproof and breathable assembly 300 and the second sound pickup frame 420 and the second installation component 520 through pre-compression, so that the waterproof and breathable membrane 310 is in sealing fit with the second installation groove 423 and the second installation component 520 to prevent water from entering, thereby improving the waterproof performance of the second microphone 220. Therefore, the thickness of the elastic sealing component 320 here is set to be larger than the distance between the groove bottom of the second installation groove 423 and the second installation component 520. In order to ensure the sealing effect of the elastic sealing component 320, the compression ratio of the elastic sealing component 320 is set to be 40%-70%. For example, the initial thickness of the elastic sealing component 320 is 0.34 mm, the compressed thickness is 0.2 mm, and the compression ratio is 46%. Alternatively, the initial thickness of the elastic sealing component 320 is 0.3 mm, the compressed thickness is 0.1 mm, and the compression ratio is 66%.

Please continue to refer to FIG. 9, in an embodiment, the earphone 10 further includes a first mesh cloth assembly 610, the first mesh cloth assembly 610 is arranged between the second sound pickup frame 420 and the outer cover 122, and the first mesh cloth assembly 610 covers the second sound pickup hole 100a2 and the third sound pickup hole 100a3.

Exemplarily, the first mesh cloth assembly 610 that covers the second sound pickup hole 100a2 and the third sound pickup hole 100a3 is arranged on a side of the outer cover 122 facing the second sound pickup frame 420, so that impurities such as water and dust may be prevented from entering the sound pickup cavity 100b through the second sound pickup hole 100a2 and the third sound pickup hole 100a3, which plays a role in blocking and slowing down the entry of water, thereby improving the waterproof performance of the earphone 10. In this case, the first mesh cloth assembly 610 is arranged at the second sound pickup hole 100a2 and the third sound pickup hole 100a3, and the first mesh cloth assembly 610 can further weaken or eliminate wind energy, so that the wind energy finally reaching the second microphone 220 is very small, thereby achieving the effect of eliminating wind noise.

Further, the second sound pickup frame 420 hermetically presses and connects the first mesh cloth assembly 610 to the outer cover 122. Exemplarily, the first mesh cloth assembly 610 may be hermetically pressed and connected on the outer cover 122 through the second sound pickup frame 420, and the first mesh cloth assembly 610 may be bonded to the outer cover 122 and the second sound pickup frame 420 respectively through double-sided adhesive tape or other adhesive, so as to prevent water flow from flowing into the sound producing accommodating cavity 123 through the gap. Further, a compressible elastic sealing component 320 may also be arranged between the outer cover 122 and the second sound pickup frame 420, and the sealing performance of the connection between the outer cover 122, the second sound pickup frame 420 and the first mesh cloth assembly 610 is ensured through pre-compression, so as to prevent the sound producing accommodating cavity 123 from getting water, and further improve the waterproofness of the earphone 10.

Please continue to refer to FIG. 9, in an embodiment, the earphone 10 further includes a second mesh cloth assembly 620, and the second mesh cloth assembly 620 is arranged at the secondary sound cavity inlet.

Specifically, the second mesh cloth assembly 620 may also be arranged at the secondary sound cavity inlet, and the second mesh cloth assembly 620 can slow down and block the water flow, thereby reducing the probability of water entering the secondary sound cavity 100b4, improving the waterproofness of the second microphone 220, and ensuring the service life of the earphone 10. At the same time, the arrangement of the second mesh cloth assembly 620 also prevents dust from entering the secondary sound cavity 100b4, thus playing a role in dust prevention. The second mesh cloth assembly 620 may be bonded to the secondary sound cavity inlet through double-sided adhesive tape, and the bonding method is simple and convenient.

Further, a third mesh cloth assembly 630 may also be arranged at the first sound pickup hole 100a1 to prevent impurities such as water and dust from entering the sound pickup cavity 100b through the first sound pickup hole 100a1, which plays a role in blocking and slowing down the entry of water, thereby improving the waterproof performance of the earphone 10. At the same time, the third mesh cloth assembly 630 is arranged at the first sound pickup hole 100a1, and the third mesh cloth assembly 630 can further weaken or eliminate wind energy, so that the wind energy finally reaching the first microphone 210 is very small, thereby achieving the effect of eliminating wind noise.

It should be noted that the material of the first mesh cloth assembly 610, the second mesh cloth assembly 620, and the third mesh cloth assembly 630 may be a metal material or a non-metal material (such as a damping material), and the number of layers may be set to be single-layer or multi-layer, which is not specifically limited.

In an embodiment, at least one selected from a group consisting of the first mesh cloth assembly 610, the second mesh cloth assembly 620, and the third mesh cloth assembly 630 includes a mesh cloth body and a waterproof coating compounded on the mesh cloth body. For example, the mesh cloth body is woven from a fiber material to form a porous mesh structure.

Optionally, the fiber material includes at least one selected from a group consisting of polyester fiber (i.e., terylene), polyamide fiber (i.e., nylon or polyamide), polyvinyl alcohol fiber (i.e., vinylon), polyacrylonitrile fiber (i.e., acrylic), polypropylene fiber (i.e., polypropylene), and polyvinyl chloride fiber (i.e., polyvinyl chloride). The surface of the fiber body is coated with a waterproof coating. The waterproof coating may be made of commonly used materials in the art.

Preferably, the waterproof coating is a nano-coating. The nano-coating is cured from a waterproof paint added with nano-materials. This coating has a better waterproof effect.

Further, the mesh number of the first mesh cloth assembly 610, the second mesh cloth assembly 620, and the third mesh cloth assembly 630 is set to be more than 300 meshes. This mesh number range can effectively prevent water flow from passing through the waterproof mesh cloth, thereby effectively preventing water.

Please refer to FIG. 3 and FIG. 4, in an embodiment, the second housing 121 includes a middle housing 121a and an inner cover 121b, the inner cover 121b is arranged opposite to the outer cover 122, the inner cover 121b and the outer cover 122 are bonded to the middle housing 121a, the inner cover 121b is opposite to the human body in the wearing state, and the inner cover 121b is provided with a first sound outlet hole 121b1.

Exemplarily, the second housing 121 includes a middle housing 121a and an inner cover 121b that are connected with each other, which are separately arranged to facilitate the installation of other components in the earphone main body 100. Certainly, in other embodiments, the middle housing 121a and the inner cover 121b may be integrally formed. The inner cover 121b and the outer cover 122 are arranged opposite to each other, and both of them are bonded to the middle housing 121a, which further improves the waterproof performance of the earphone 10, and prevents the situation that external water flow enters through the gap at the connection position between the inner cover 121b and the outer cover 122 and the middle housing 121a, causing damage to components in the sound producing portion 120 and the failure of the earphone 10. The inner cover 121b is provided with the first sound outlet hole 121b1, and the first sound outlet hole 121b1 is used for outputting sound for the user to listen to. Further, a second sound outlet hole 122a may also be formed in the outer cover 122 to further improve the sound output effect of the earphone 10.

Please refer to FIGS. 2 to 4, in an embodiment, the earphone main body 100 further includes an ear hook portion 130, one end of the main body portion 110 is connected to one end of the ear hook portion 130 in a smooth transition, the other end of the ear hook portion 130 is bent in a direction toward the main body portion 110 and is connected to the sound producing portion 120 in a smooth transition, the ear hook portion 130 is used to hook on the human ear, and a curved profile formed by the connection of the ear hook portion 130 and the main body portion 110 is adapted to fit with a back profile of the human ear.

Specifically, when the earphone 10 of the present disclosure is used as a sports earphone 10, and the user uses the sports earphone 10 provided by the present disclosure to listen to music or exercise during sports, the ear hook portion 130 is arranged in an arc shape so as to fit with the contour of the user's ear, and the flexible circuit board may be deformed synchronously with the ear hook portion 130, so that the user can perform targeted adjustment and deformation according to the comfort requirements of wearing the earphone 10, thereby enabling the earphone 10 to meet the user's personal comfort requirements for the earphone 10.

The curved profile formed by the connection of the ear hook portion 130 and the main body portion 110 is adapted to fit with the back profile of the ear, which further enables the earphone 10 to always maintain a fit wearing form with the back of the ear after being worn on the user's ear, so that the earphone 10 will not fall off the ear due to the range of sports actions during the sports process of the user, thereby ensuring the wearing stability of the earphone 10.

Further, the contour shape formed by the connection of the ear hook portion 130 and the main body portion 110 for hooking the user's ear may be a fixed shape and cannot be adjusted by deformation. In this case, an elastic memory metal with memory function, such as titanium metal wire, may be arranged inside the ear hook portion 130 to support the ear hook portion 130, and the hooking shape formed by the ear hook portion 130 and the elastic memory metal is designed according to ergonomics to fit the contour of the human ear, so that the user feels more comfortable when wearing the sports earphone 10 for exercise. Certainly, the contour shape formed by the connection of the ear hook portion 130 and the main body portion 110 for hooking the user's ear may also be adjusted by deformation by the user according to the demand, so that the curved contour formed by the connection of the ear hook portion 130 and the main body portion 110 may be adapted to different users.

In an embodiment, the ear hook portion 130 has elasticity, and the main body portion 110 and the sound producing portion 120 are both made of hard materials. In order to expand the spacing between the sound producing portion 120 and the main body portion 110 during the wearing process to facilitate the wearing process of the user, the ear hook portion 130 is arranged to be elastic, but after the wearing is completed, the sound producing portion 120 and the main body portion 110 return to the natural state, and no clamping force is generated due to the elastic deformation to the ear, thereby maintaining the wearing comfort.

The main body portion 110 and the sound producing portion 120 are made of hard materials, specifically, it means that the main body skeletons of the main body portion 110 and the sound producing portion 120 are made of materials with great rigidity, so that the overall structure is not easily deformed. The exterior of the main body portion 110, the exterior of the sound producing portion 120, and the ear hook portion 130 may be coated or not coated with flexible materials (such as polycarbonate, polyamide, acrylonitrile-butadiene-styrene copolymer, silica gel, etc.) as needed, or may be partially or fully coated with flexible materials as needed, so as to improve wearing comfort as needed.

The above hard materials refer to materials with great rigidity that are not easily deformed under normal circumstances, and preferably, materials with an elastic modulus greater than 2.0 GPa may be selected, including but not limited to polycarbonate (PC), polyamide (PA), acrylonitrile butadiene styrene copolymer (ABS), polystyrene (PS), high impact polystyrene (HIPS), polypropylene (PP), polyethylene terephthalate (PET), polyvinyl chloride (PVC), polyurethane (PU), polyethylene (PE), phenol formaldehyde (PF), poly(ester sulfones) (PES), polyvinylidene chloride (PVDC), polymethylmethacrylate (PMMA), polyether-ether-ketone (PEEK), etc., or a mixture formed by at least two of them, or a mixture formed by them and reinforcing agents such as glass fiber and carbon fiber.

As a preferred embodiment, the hard material selected has a modulus greater than 2.32 GPa and a Poisson's ratio of about 0.390212, such as PC material.

Please refer to FIGS. 2 to 4, 8, 10, and 15, in an embodiment, the earphone 10 further includes a neck hanging piece 700, the neck hanging piece 700 is arranged in a long strip shape, a plug portion 720 is arranged at an end of the neck hanging piece 700, and a jack 110a plug-fit with the plug portion 720 is arranged at an end of the main body portion 110 away from the ear hook portion 130.

Exemplarily, the neck hanging piece 700 is connected to the main body portion 110, the neck hanging piece 700 is arranged in a long strip shape, and the neck hanging piece 700 is used to hang the earphone 10 around the user's neck, which is convenient for the user to use during sports. The plug portion 720 is arranged at the end of the neck hanging piece 700, that is, both ends of the long strip-shaped neck hanging piece 700 are provided with the plug portion 720, and the plug portion 720 is plug-fit with the jack 110a on the main body portion 110. The neck hanging piece 700 may be made of plastic or silicone. Compared with plastic materials, silicone materials are more skin-friendly, comfortable and easy to deform, which makes the user experience more comfortable. In view of this, in this embodiment, the neck hanging piece 700 is made of silicone.

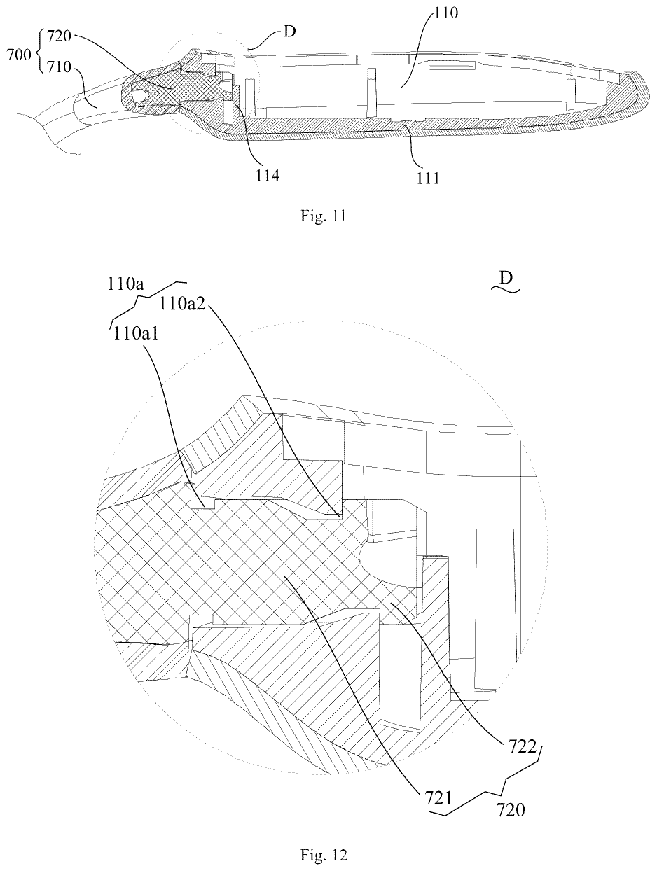

Please refer to FIG. 11 and FIG. 12, in an embodiment, the plug portion 720 includes a plug section 721 and a clamping section 722 that are connected in sequence, the jack 110a has a first hole opening 110a1 located on a surface of the main body portion 110 and a second hole opening 110a2 located in the main body portion 110, the plug portion 720 extends into the main body portion 110 through the first hole opening 110a1, and the clamping section 722 is adapted to a peripheral clamping opening of the second hole opening 110a2.

Exemplarily, the neck hanging piece 700 includes a neck hanging main body 710 and plug portions 720 connected to both ends of the neck hanging main body 710, and the neck hanging main body 710 and the plug portions 720 are integrally formed. Considering that the neck hanging piece 700 and the main body portion 110 should be fixedly matched for use, in this embodiment, a jack 110a is formed in the main body portion 110 corresponding to the plug portion 720 for the plug portion 720 to extend into the jack 110a, and the clamping section 722 is located at an end of the plug portion 720 extending into the jack 110a, the clamping section 722 just abuts against an outer peripheral edge of the second hole opening 110a2, so that the clamping section 722 is snap-fit with the periphery of the second hole opening 110a2. Certainly, the neck hanging piece 700 and the main body portion 110 may also be snap-fit with a groove body on the plug portion 720 by providing a clamping block in the jack 110a, or other fixed fit manners of the neck hanging piece 700 and the earphone main body 100, which is not specifically limited.

It should be noted that the periphery of the first hole opening 110a1 may abut against an end surface of the neck hanging main body 710, so that it is difficult for water to flow into the main body portion 110 through the jack 110a, therefore, the waterproof sealing performance at the assembly of the neck hanging piece 700 and the main body portion 110 can be improved by adopting this installation method.

By inserting the plug section 721 into the jack 110a, and snap-fitting the clamping section 722 with the outer peripheral edge of the second hole opening 110a2, the periphery of the first hole opening 110a1 abuts against the neck hanging main body 710, and then the neck hanging piece 700 and the main body portion 110 are assembled and fixed, moreover, this installation method can improve the sealing performance at the assembly of the neck hanging piece 700 and the main body portion 110, so that water is not easy to flow into the main body portion 110 through the jack 110a, thereby greatly prolonging the service life of the earphone 10.

Please continue to refer to FIG. 11 and FIG. 12, in an embodiment, a baffle plate 114 is arranged in the main body portion 110 to abut against an end portion of the clamping section 722. Specifically, the baffle plate 114 is arranged to define a relative position of the clamping section 722, so as to prevent the plug portion 720 from excessively extending into the jack 110a, and the baffle plate 114 is also used to block water flowing in through a gap between the jack 110a and the plug section 721, so as to prevent water from further entering the main body portion 110 and contaminating or damaging other electronic components inside the main body portion 110, thereby prolonging the service life of the earphone 10. The number of the baffle plate 114 may be one or multiple consecutive baffle plates may be provided. In this embodiment, one baffle plate 114 can better prevent water from entering the main body portion 110. The shape of a side of the baffle plate 114 that abuts against the clamping section 722 may be square, semicircular or other shapes, which is not limited here.

Further, the baffle plate 114 protrudes and extends from a side of an inner wall of the main body portion 110 toward the opposite side of the inner wall of the main body portion 110, and a space is formed between the baffle plate 114 and the opposite side of the inner wall of the main body portion 110.

It should be noted that the baffle plate 114 and the inner wall of the main body portion 110 may be integrally formed in a mold or formed by connection, and the specific connection relationship may be ultrasonic welding or gluing, which is not limited here. A space is formed between the baffle plate 114 and the opposite side of the inner wall of the main body portion 110, instead of being connected to the opposite side of the inner wall of the main body portion 110, which is used to balance the air pressure inside the main body portion 110, and prevent the air pressure inside the main body portion 110 from decreasing when the plug section 721 is inserted into the jack 110a, and from causing difficulty in inserting the plug section 721.

Preferably, the baffle plate 114 and the clamping section 722 are bonded and sealed. It should be noted that before the plug portion 720 is inserted into the jack 110a, glue may be dispensed on the surface of the clamping section 722, and then the clamping section 722 and the baffle plate 114 are sealed by gluing, so that the relative position between the clamping section 722 and the plug section 721 can be further fixed, and the waterproof effect of the baffle plate 114 can also be better.

Still further, the clamping section 722 and the periphery of the second hole opening 110a2 are bonded and sealed. According to the description of the previous embodiment, after glue is dispensed on the surface of the clamping section 722, the clamping section 722 is bonded and sealed with the periphery of the second hole opening 110a2 through the jack 110a, so that water may be further prevented from entering the main body portion 110 through the second hole opening 110a2 from the gap between the plug section 721 and the jack 110a, the waterproof effect at the connection position between the main body portion 110 and the neck hanging piece 700 can be improved, and the service life of the earphone 10 can be prolonged.

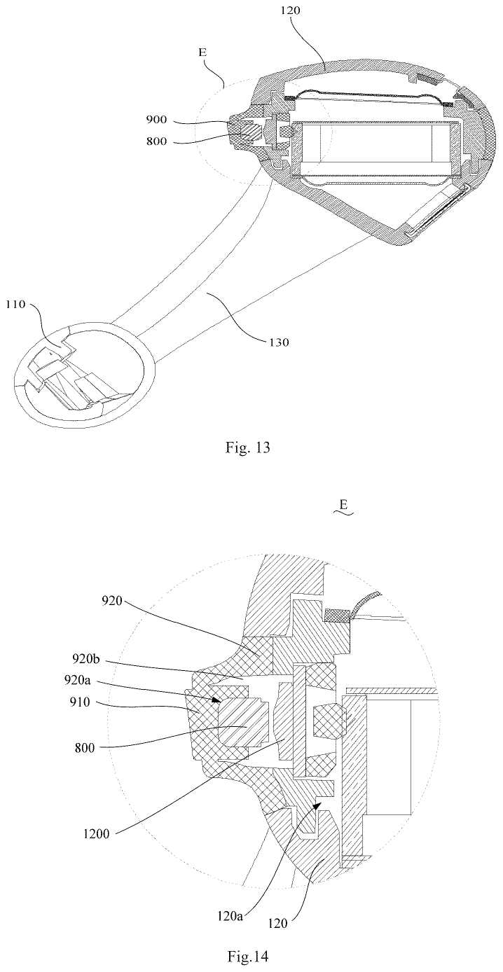

Please refer to FIGS. 13 to 16, in an embodiment, the sound producing portion 120 is provided with a button hole 120a, the earphone 10 further includes a button 800 and an elastic sealing layer 900, the elastic sealing layer 900 covers the button hole 120a and is hermetically connected with an outer edge of the button hole 120a, and the elastic sealing layer 900 has a pressing portion 910 protruding in a direction away from the button hole 120a; the button 800 is integrally connected with a side of the pressing portion 910 close to the button hole 120a.

Exemplarily, the button hole 120a is formed in the middle housing 121a of the sound producing portion 120, which is convenient for the user to operate. The elastic sealing layer 900 covers the button hole 120a, and the elastic sealing layer 900 is hermetically connected with the outer edge of the button hole 120a, so that the button hole 120a is in a sealed state, thereby improving the waterproof performance of the position of the button hole 120a of the sound producing portion 120, and preventing water from entering the interior of the sound producing portion 120 through the button hole 120a and the gap between the button 800 and the middle housing 121 a of the sound producing portion 120, and then preventing water from entering the interior of the sound producing portion 120 and damaging electrical components therein. Moreover, the elastic sealing layer 900 has the pressing portion 910 protruding in the direction away from the button hole 120a, which is convenient for the user to find the position of the button 800 when the user needs to perform blind pressing, thereby realizing blind pressing. It can be seen that the arrangement of the elastic sealing layer 900 can improve the waterproof performance of the earphone 10 at the button 800.

It should be noted that the button 800 of the present disclosure may be a volume button, a switch button, a track switching button, or a button of multiple functions, and the specific function of the button 800 is not limited here. Preferably, in this embodiment, the button 800 of the present disclosure is configured as a volume switch button, that is, pressing the volume-up button once is a volume-up control instruction, and pressing the volume-up button twice in a row is a switch control instruction, or pressing the volume-up button once for a short time is a volume-up control instruction, and pressing the volume-up button once for a long time is a switch control instruction.

In an embodiment, the button 800 and the elastic sealing layer 900 are integrally injection molded; because the molding process of integral injection molding has a fast production speed and high efficiency, the production efficiency of the structure of the button 800 of the earphone 10 can be improved. Certainly, the present solution is not limited to this, in other embodiments, the button 800 may also be connected to the elastic sealing layer 900 as a whole by bonding.

It should be noted that the above-mentioned integral injection molding is specifically secondary injection molding, after the button 800 is molded, it is placed in a secondary molding mold and the material of the elastic sealing layer 900 is injected again, so that the elastic sealing layer 900 and the button 800 are connected as a whole.

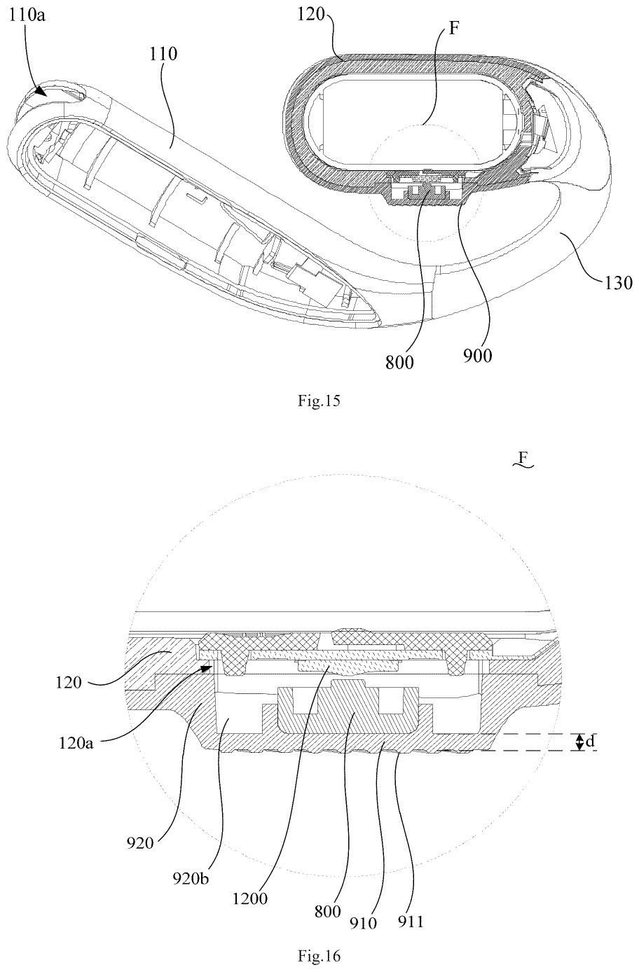

Please refer to FIG. 14 and FIG. 16, further, a mounting portion 920 is provided on a side of the elastic sealing layer 900 close to the sound producing portion 120, and the button 800 is provided on the mounting portion 920; the mounting portion 920 can facilitate the installation of the button 800, and can prevent the actual mounting position of the button 800 from deviating from a preset mounting position when the button 800 is mounted, and prevent the misalignment between the button 800 and a switch arranged at the button hole 120a, and prevent the problem that the button 800 fails to trigger the switch in time or even fails to trigger the switch.

Please continue to refer to FIG. 14 and FIG. 16, in an embodiment, the mounting portion 920 has a button groove 920a for embedding the button 800. It may be understood that the button 800 is embedded in the button groove 920a, and the groove wall of the button groove 920a may cover the button 800, thereby increasing the stability of the installation of the button 800. Certainly, the present disclosure is not limited to this, in other embodiments, the button groove 920a may not be provided, and the button 800 is directly injection molded on the surface of the elastic sealing layer 900 without the button groove 920a.

Further, the button 800 partially protrudes from the button groove 920a; this can facilitate the user to grasp the button 800, thereby facilitating the disassembly of the button 800 from the button groove 920a, and the button 800 partially protrudes from the button groove 920a, which also prevents the groove wall of the button groove 920a from interfering with the switch when the button 800 is triggered. Certainly, the present disclosure is not limited to this, in other embodiments, the button 800 may not protrude from the button groove 920a.

Please continue to refer to FIG. 14 and FIG. 16, in an embodiment, a buffer groove 920b recessed in a direction away from the button hole 120a is formed on an outer periphery of the mounting portion 920; the arrangement of the buffer groove 920b can increase the softness of the pressing portion 910, thereby increasing the feel of the user when pressing, and improving the comfort of the user when pressing. Certainly, the present disclosure is not limited to this, in other embodiments, the buffer groove 920b may not be provided on the outer periphery of the mounting portion 920.

Further, the buffer groove 920b is arranged around the mounting portion 920. It may be understood that the buffer groove 920b is arranged around the mounting portion 920, that is, the buffer groove 920b is arranged around the button 800, in this way, no matter which part of the pressing portion 910 is pressed by the user, the buffer groove 920b can be deformed, thereby increasing the feel of the user when pressing. Certainly, the present disclosure is not limited to this, in other embodiments, a buffer groove 920b may be respectively arranged on two opposite sides of the mounting portion 920, instead of the buffer groove 920b arranged around the mounting plate.

Preferably, a thickness of a position of the elastic sealing layer 900 corresponding to the buffer groove 920b is d (please refer to FIG. 16), and a value range of d is 0.4 mm-0.8 mm. It may be understood that the thickness of the elastic sealing layer 900 not only affects the elasticity, but also affects the service life of the elastic sealing layer 900. Limiting the thickness of the position of the elastic sealing layer 900 corresponding to the buffer groove 920b to a range of 0.4 mm-0.8 mm can increase the service life while ensuring the feel of pressing. When the thickness of the position of the elastic sealing layer 900 corresponding to the buffer groove 920b is less than 0.4 mm, the elastic sealing layer 900 has a short service life. If the thickness of the position of the elastic sealing layer 900 corresponding to the buffer groove 920b is greater than 0.8 mm, the hardness of the elastic sealing layer 900 increases, thereby reducing the comfort of pressing.

Further, in an embodiment, the thickness of the position of the elastic sealing layer 900 corresponding to the buffer groove 920b is 0.4 mm. In a second embodiment, the thickness of the position of the elastic sealing layer 900 corresponding to the buffer groove 920b may also be 0.6 mm. In a third embodiment, the thickness of the position of the elastic sealing layer 900 corresponding to the buffer groove 920b may also be 0.7 mm. The thickness of the position of the elastic sealing layer 900 corresponding to the buffer groove 920b is not specifically limited here.

In an embodiment, an angle between the bottom wall of the buffer groove 920b and the side wall of the buffer groove 920b is a right angle, which can make the elastic sealing layer 900 better rebound. Further, the button 800 is made of a hard material, including but not limited to hard plastic.

In an embodiment, the elastic sealing layer 900 is made of at least one selected from a group consisting of silica gel, polycarbonate, polyamide and acrylonitrile-butadiene-styrene copolymer.

Exemplarily, the elastic sealing layer 900 is made of silica gel. Since silica gel has strong sealing performance, and has the advantages of waterproofness, environmental protection, durability and low price, configuring the elastic sealing layer 900 with silica gel can not only ensure the waterproofness of the elastic sealing layer 900, but also reduce the cost of the elastic sealing layer 900. Moreover, silica gel also has good heat resistance and cold resistance, and has a long service life when exposed to the external environment of the earphone 10; more importantly, it has tear resistance, and the elastic sealing layer 900 is not easy to tear even if it is pressed for a long time and undergoes elastic deformation; therefore, configuring the elastic sealing layer 900 with silica gel can also make the elastic sealing layer 900 have a long service life.

Please refer to FIG. 16, in an embodiment, a surface of the pressing portion 910 is provided with an anti-slip layer 911; it may be understood that providing the anti-slip portion on the surface of the pressing portion 910 can increase friction, thereby preventing the hand of the user from slipping sideways, and facilitating the user to press the button 800.

Exemplarily, the anti-slip layer 911 includes multiple convex strips spaced apart from each other, such an anti-slip layer 911 is simple to form, and is convenient to increase the forming efficiency of the anti-slip layer 911 while ensuring the anti-slip effect. Certainly, the present disclosure is not limited to this, in other embodiments, the anti-slip layer 911 may also be configured with multiple anti-slip convex points.

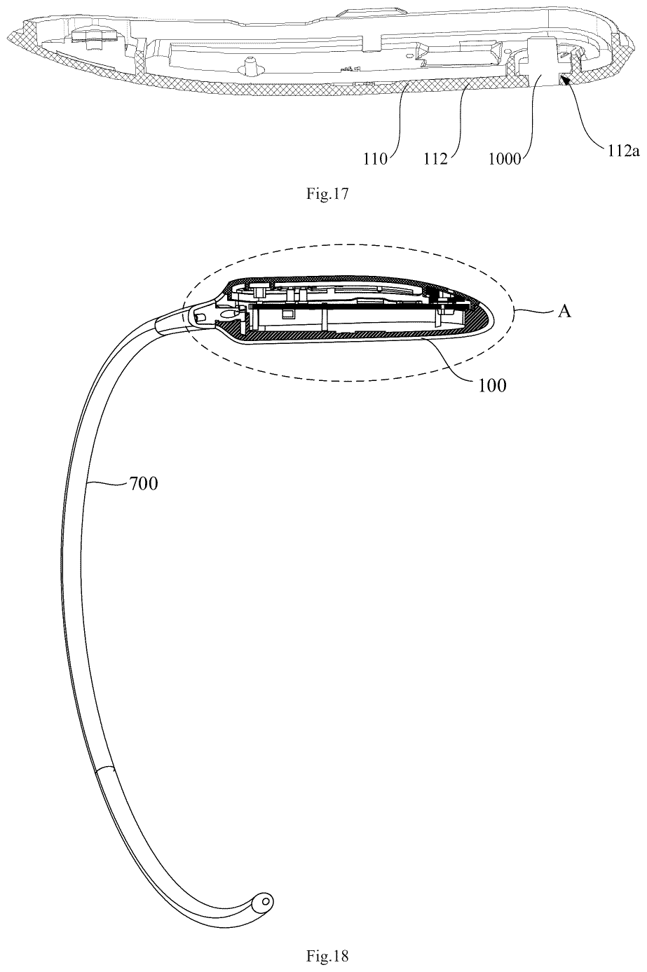

Please refer to FIG. 3 and FIG. 17, in an embodiment, the earphone 10 further includes a light guide column 1000, the main board cover 112 is provided with a light guide hole 112a, and the light guide column 1000 passes through the light guide hole 112a. Exemplarily, the connection position between the light guide column 1000 and the main board cover 112, that is, the gap between the light guide column 1000 and the light guide hole 112a may be sealed with adhesive, so as to ensure the sealing performance at the light guide hole 112a, prevent water from flowing into the main body portion 110 through the gap between the light guide column 1000 and the light guide hole 112a, and further improve the waterproof performance and service life of the earphone 10.

Please refer to FIGS. 3, 8 and 10, in an embodiment, the earphone 10 further includes a charging pin assembly 1100, and the charging pin assembly 1100 is arranged on the main body portion 110 to connect to an external device to charge the earphone 10. The charging pin assembly 1100 includes a charging pin and a pin bracket (not shown in the figure), the charging pin and the pin bracket are riveted and assembled together, and the bracket at the tail end of the charging pin is designed with a glue dispensing groove (one for each pin tail, not shown in the figure), and sealing glue is dispensed at the glue dispensing groove to fix the charging pin, which can ensure the waterproofness of the assembly gap between the charging pin and the pin bracket; secondly, a glue dispensing groove (not shown in the figure) is also designed at the connection position between the pin bracket and the first housing 111 of the main body portion 110, and the glue dispensing groove is also fixed with waterproof sealing glue to ensure the waterproofness of the assembly gap between the pin bracket and the first housing 111. The width of the glue dispensing groove is at least 0.5 mm and the depth is greater than 0.3 mm, and the maximum depth of the glue dispensing groove of the earphone 10 does not exceed 0.5 mm.

Through the waterproof arrangement at the first microphone 210 and the second microphone 220, and the waterproof arrangement at the connection position between the neck hanging piece 700 and the earphone main body 100, the button 800, the light guide column 1000 and the charging pin assembly 1100, the earphone 10 of the present disclosure can achieve the waterproof effect of IPX7 level for the whole machine, and has the condition of being used outdoors in rainy days or underwater for a long time, so as to provide the user with various use scenarios and improve the user experience.

### Embodiment 2

In the earphone provided by the embodiment of the present disclosure, as shown in FIGS. 18 to 20, the earphone main body includes a housing 100, and the sound pickup hole 110 and the sound pickup cavity 120 are formed in the housing 100. It should be noted that it may be clearly seen from FIG. 7 and FIG. 20 that the sound pickup cavity and the waterproof and breathable cavity are the same structure, therefore, the sound pickup cavity may also be called a waterproof and breathable cavity, and the following embodiments are all described by taking the “sound pickup cavity” as an example. Similarly, the waterproof and breathable assembly and the waterproof and breathable structure are also one structure, therefore, the following embodiments are all described by taking the “waterproof and breathable assembly” as an example.

The sound pickup cavity 120 includes a first cavity 121 and a second cavity 122 that are communicated with each other, the first cavity 121 is communicated with the sound pickup hole 110, the first cavity 121 has a communication hole 123 communicated with the second cavity 122, and the communication hole 123 and the sound pickup hole 110 are arranged in a staggered manner in an axial direction of the sound pickup hole 110; and the microphone 200 is located in the housing 100, and the second cavity 122 is acoustically coupled with the microphone 200 through the waterproof and breathable assembly 300. In the present embodiment, the waterproof and breathable assembly prevents water from flowing to a sound receiving portion of the microphone 200, and such a configuration can further improve the waterproof effect between the sound pickup hole 110 and the microphone 200.

In a possible implementation, as shown in FIGS. 18 to 20, the housing 100, the microphone 200, and the waterproof and breathable assembly 300 may further constitute an earphone structure with a waterproof microphone. A sound pickup hole 110 is formed in the housing 100, a sound pickup cavity 120 is formed in the housing 100, the sound pickup hole 110 is communicated with the sound pickup cavity 120, the sound pickup cavity 120 includes a first cavity 121 and a second cavity 122 that are communicated with each other, the first cavity 121 is communicated with the sound pickup hole 110, the first cavity 121 has a communication hole 123 communicated with the second cavity 122, and the communication hole 123 and the sound pickup hole 110 are arranged in a staggered manner in an axial direction of the sound pickup hole 110; and the microphone 200 is located in the housing 100, and the second cavity 122 is acoustically coupled with the microphone 200 through the waterproof and breathable assembly 300.

Exemplarily, the sound pickup hole 110 is formed in a surface of the housing 100, and the sound pickup hole 110 is communicated with the sound pickup cavity 120 in the housing 100, where the sound pickup cavity 120 may be formed in an inner wall of the housing 100, or a bracket 400 may be arranged in the housing 100, and the sound pickup cavity 120 is formed in the bracket 400, which is not limited here.

Further, the sound pickup cavity 120 at least includes the first cavity 121 and the second cavity 122. A vertical section of the housing 100 is made, as shown in FIG. 20, the vertical section of the first cavity 121 and the vertical section of the second cavity 122 may be square, trapezoidal, elliptical or in any other shape. In the present embodiment, an outer wall of the housing 100 where the sound pickup hole 110 is formed is arranged in an arc shape, and the first cavity 121 is enclosed by the outer wall of the housing 100 where the sound pickup hole 110 is formed and other wall surfaces. In this way, in the present embodiment, the vertical section of the first cavity 121 is arranged in a substantially trapezoidal shape, and the vertical section of the second cavity 122 is arranged in a square shape.

The first cavity 121 is communicated with the second cavity 122 through the communication hole 123, where one or more communication holes 123 may be provided, and a hole opening of the communication hole 123 may be arranged in a circular shape, a square shape or a special shape, which is not limited here. It should be noted that the communication hole 123 is arranged in a staggered manner with the sound pickup hole 110 in the axial direction of the sound pickup hole 110, that is, the orthographic projections of the communication hole 123 and the sound pickup hole 110 on a first reference plane perpendicular to the axial direction of the sound pickup hole 110 only partially overlap or do not overlap. With such a configuration, water falling into the sound pickup hole 110 will not directly drip into the communication hole 123, thereby effectively improving the waterproof effect of the earphone structure. The hole opening of the communication hole 123 may be partially staggered with the hole opening of the sound pickup hole 110, or the hole opening of the communication hole 123 may be completely staggered with hole opening of the sound pickup hole 110. In the present embodiment, in order to further improve the waterproof effect, the hole opening of the communication hole 123 and the hole opening of the sound pickup hole 110 are arranged in a completely staggered manner.

In addition, in order to prevent water from directly flowing to the sound receiving portion of the microphone 200 through the second cavity 122, the waterproof and breathable assembly 300 is arranged between the second cavity 122 and the microphone 200, and the waterproof and breathable assembly 300 can effectively isolate water and prevent water from entering the sound receiving portion of the microphone 200.

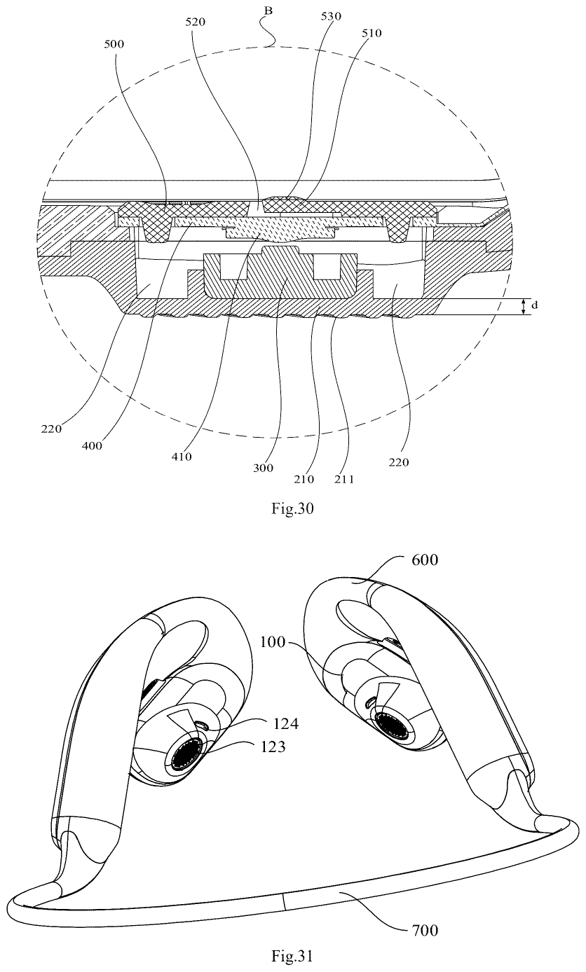

In the technical solution of the embodiment of the present disclosure, the sound pickup cavity 120 is arranged in the housing 100, the sound pickup cavity 120 includes the first cavity 121 and the second cavity 122 that are communicated with each other, the communication hole 123 of the first cavity 121 and the second cavity 122 is arranged in a staggered manner with the sound pickup hole 110 to prevent water entering the sound pickup hole 110 from directly flowing into the communication hole 123, and the waterproof and breathable assembly 300 is arranged between the second cavity 122 and the microphone 200 to prevent water from flowing to the sound receiving portion of the microphone 200, so that the waterproof effect between the sound pickup hole 110 and the microphone 200 can be further improved. In an embodiment, please refer to FIG. 30, the first cavity 121 is at least partially located at an outer side of the second cavity 122 in the axial direction of the sound pickup hole 110.

Specifically, the first cavity 121 is at least partially located on the outer side of the second cavity 122 in the axial direction of the sound pickup hole 110, that is, the first cavity 121 and the second cavity 122 are staggered in the axial direction of the sound pickup hole 110. With such a configuration, after flowing into the housing 100 through the sound pickup hole 110, the water flow will flow through the first cavity 121 and the second cavity 122 in sequence before flowing to the microphone 200. The staggered arrangement of the first cavity 121 and the second cavity 122 prolongs the flow path of the water flow on the one hand, and on the other hand, plays a role in blocking and delaying the flow of the water flowing into the sound pickup cavity 120, thereby reducing the impact force of the water flow, and preventing the waterproof and breathable assembly 300 from being damaged by the impact of the water flow.

Further, please refer to FIG. 20, a step surface 420 is formed between the cavity wall of the first cavity 121 and the cavity wall of the second cavity 122, and the orthographic projection of the step surface 420 on the plane where the sound pickup hole 110 is located covers the sound pickup hole 110.

It should be noted that the first cavity 121 and the second cavity 122 both have cavity walls, and the cavity wall of the first cavity 121 and/or the cavity wall of the second cavity 122 may be formed by the inner wall of the housing 100, or may be formed by the bracket 400 in the housing 100. The microphone 200 is acoustically coupled with the second cavity 122 through the waterproof and breathable assembly 300, and the two are relatively sealed. In this way, the water flowing into the housing 100 through the sound pickup hole 110 will only flow in the first cavity 121 and the second cavity 122, and will not flow to other places in the housing 100, preventing other components in the housing 100 from failing due to water inflow, thereby ensuring the use performance and the service life of the earphone. The step surface 420 is formed between the cavity wall of the first cavity 121 and the cavity wall of the second cavity 122, and the step surface 420 is arranged opposite to and spaced apart from the sound pickup hole 110, so that the water flowing into the first cavity 121 through the sound pickup hole 110 will first flow to the step surface 420, and the step surface 420 plays a role in buffering the flow of the water, thereby preventing the waterproof and breathable assembly 300 from being damaged by excessive impact force of the water flow, and ensuring the waterproof performance of the microphone 200. The orthographic projection of the step surface 420 on the plane where the sound pickup hole 110 is located covers the sound pickup hole 110, that is, the area of the step surface 420 is greater than or equal to the area of the sound pickup hole 110, so as to ensure that no matter where the water flows into the first cavity 121 from the sound pickup hole 110, it will first flow to the step surface 420.

An inner wall surface of the housing 100 where the sound pickup hole 110 is located may be a curved surface or a flat surface, which is specifically determined according to the structure and shape in the housing 100, and is not limited here.

Optionally, please refer to FIG. 3, a third cavity 321 is further arranged in the housing 100, and the second cavity 122 is acoustically coupled with the microphone 200 through the third cavity 321.

Exemplarily, in the present embodiment, the third cavity 321 is further arranged in the housing 100, where the third cavity 321 may be formed in the inner wall of the housing 100, may be formed in the bracket 400 arranged in the housing 100, or may be formed in the waterproof and breathable assembly 300, which is not limited here. Considering that the second cavity 122 is acoustically coupled with the microphone 200, the third cavity 321 is arranged between the second cavity 122 and the microphone 200, and the third cavity 321 can be used to provide enough space for the arrangement of the waterproof and breathable assembly 300.

In an embodiment, please refer to FIG. 20, a sound pickup channel 510 is further arranged between the third cavity 321 and the microphone 200.

It should be noted that the sound pickup channel 510 is further arranged between the third cavity 321 and the microphone 200, where the sound pickup channel 510 may be formed in the inner wall of the housing 100, may be formed in the bracket 400 arranged in the housing 100, or may be formed in the circuit board, which is not limited here.

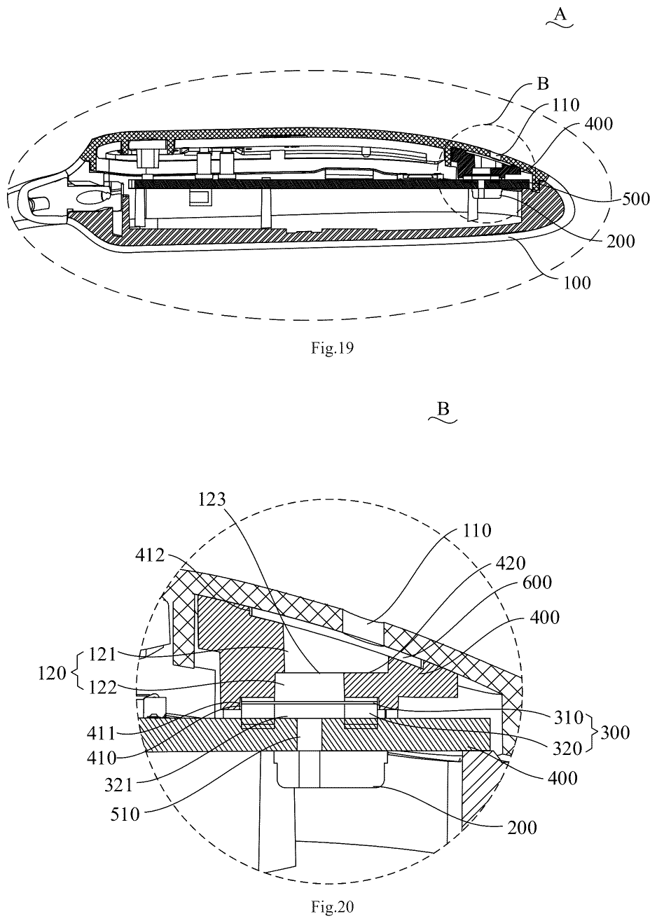

In an embodiment, please refer to FIG. 19 and FIG. 20, the waterproof and breathable assembly 300 is provided with a vent hole, and the vent hole is communicated with the second cavity 122.

Exemplarily, the waterproof and breathable assembly 300 is provided with the vent hole, and the vent hole is very small, which only allows gas to flow, but does not allow water droplets to pass through, and the vent hole is communicated with the second cavity 122, so that air and sound can enter from the sound pickup hole 110 and be transmitted to the microphone 200 through the waterproof and breathable assembly 300. Generally, the aperture of the vent hole is set between 0.1 and 10 μm. For the waterproof and breathable assembly 300, the water inlet pressure and the air permeability are two very important values. Generally, these two values are in a competitive relationship, and a high air permeability means a low water inlet pressure. The waterproof and breathable assembly 300 is mainly divided into a hydrophobic membrane and an oleophobic membrane, and the oleophobic membrane is used in the present embodiment. Since expanded polytetrafluoroethylene has certain natural hydrophobicity and oleophobicity, it sometimes gets wet and permeated when encountering liquids with low surface energy, such as alcohol, cleaning agents, lubricants, etc. The oleophobic membrane has a lower surface energy and can resist the infiltration of these liquids.

In an embodiment, please refer to FIG. 3, the waterproof and breathable assembly 300 includes a waterproof and breathable membrane 310 and a compressible elastic sealing component 320, and the elastic sealing component 320 is used to press against and fix the waterproof and breathable membrane 310.

It should be noted that the waterproof and breathable assembly 300 at least includes the waterproof and breathable membrane 310 and the compressible elastic sealing component 320, where the waterproof and breathable membrane 310 plays a main waterproof and breathable function, the vent hole is also formed in the waterproof and breathable membrane 310, and the compressible elastic sealing component 320 is used to press against and fix the waterproof and breathable membrane 310. The elastic sealing component 320 is compressed and arranged in the housing 100, where one end of the elastic sealing component 320 abuts against the waterproof and breathable membrane 310, and the elastic sealing component 320 has an elastic force in a direction opposite to the compression direction due to being compressed. Therefore, the elastic sealing component 320 can better fix the waterproof and breathable membrane 310 through this elastic force.

Optionally, the material of the waterproof and breathable membrane 310 is any one selected from a group consisting of polytetrafluoroethylene, expanded polytetrafluoroethylene, polyurethane resin, and thermoplastic polyurethane. The elastic sealing component 320 is made of waterproof foam in the present embodiment, and the elastic sealing component 320 may also be made of waterproof and breathable fabric. The surface of the waterproof foam is provided with a waterproof layer, which can further improve the sealing effect of the elastic sealing component 320.

Exemplarily, the waterproof foam is made of pron4701 foam, and other types of waterproof foam are also acceptable.

In an embodiment, please refer to FIG. 19 and FIG. 20, the housing 100 further includes a bracket 400, the bracket 400 is connected to the housing 100, and the first cavity 121 and the second cavity 122 are formed in the bracket 400.

Specifically, considering that it is difficult to directly form the first cavity 121 and the second cavity 122 on the inner wall of the housing 100, the bracket 400 is arranged in the housing 100, and the first cavity 121 and the second cavity 122 are formed between the bracket 400 and the outer wall of the housing 100. The bracket 400 is connected to the housing 100, and in order to further improve the sealing performance in the first cavity 121, the bracket 400 and the outer wall of the housing 100 are bonded and sealed, so that the water entering the first cavity 121 will not flow out of the first cavity 121 to the outside of the bracket 400.

Further, please refer to FIG. 20, a first accommodating groove 410 is formed on a side of the bracket 400 close to the microphone 200, and the waterproof and breathable membrane 310 is located in the first accommodating groove 410.

According to the above-described embodiments, the elastic sealing component 320 is arranged between the second cavity 122 and the microphone 200. It should be noted that the first accommodating groove 410 is formed on a side of the bracket 400 close to the microphone 200, and the waterproof and breathable membrane 310 is arranged in the first accommodating groove 410, where the waterproof and breathable membrane 310 may or may not be connected to the bracket 400, which is not limited here.

Preferably, please refer to FIG. 20, the first accommodating groove 410 has a groove side wall 411, the elastic sealing component 320 is at least partially located in the first accommodating groove 410, and the elastic sealing component 320 is attached to the groove side wall 411.

Further, in the above embodiment, the waterproof and breathable membrane 310 is located in the first accommodating groove 410, and the waterproof and breathable membrane 310 blocks the second cavity 122, so that the water passing through the second cavity 122 cannot flow into the microphone 200. In order to further prevent the water in the second cavity 122 from flowing out, the elastic sealing component 320 is also at least partially arranged in the first accommodating groove 410, and the elastic sealing component 320 is attached to the groove side wall 411, so that the elastic sealing component 320 can block the water flow flowing out from the outer periphery of the waterproof and breathable membrane 310, further improve the waterproof measure at the microphone 200, and prolong the service life of the earphone.

It should be noted that the third cavity 321 is formed in a middle portion of the elastic sealing component 320, so that the sound can be transmitted through the elastic sealing component 320 to the sound receiving portion of the microphone 200.

In an embodiment, please refer to FIG. 19 and FIG. 20, the earphone further includes an earphone main board 500, the earphone main board 500 is located in the housing 100, the sound pickup channel 510 is formed in the earphone main board 500, and the earphone main board 500 presses against a side of the elastic sealing component 320 away from the sound pickup hole 110.

Exemplarily, the earphone main board 500 is further arranged in the housing 100, and in the present embodiment, the microphone 200 is arranged on a side of the earphone main board 500 away from the sound pickup hole 110, therefore, the sound pickup channel 510 communicated with the microphone 200 is arranged on the earphone main board 500. In addition, the earphone main board 500 is also used to press against the side of the elastic sealing component 320 away from the sound pickup hole 110, so that the earphone main board 500 can better press against the elastic sealing component 320. In the present embodiment, the elastic sealing component 320 may be bonded to the earphone main board 500, and certainly, the elastic sealing component 320 may not be bonded to the earphone main board 500.

In an embodiment, please refer to FIG. 20, the waterproof and breathable membrane 310 and the bracket 400 are bonded together through double-sided adhesive tape.

Further, the waterproof and breathable membrane 310 is connected to the bracket 400 by gluing, and the gluing connection is performed by bonding with double-sided adhesive tape, and certainly, other gluing methods such as glue water may also be used to connect the waterproof and breathable membrane 310 to the bracket 400. By gluing the waterproof and breathable membrane 310 to the bracket 400, the waterproof and sealing effect of the waterproof and breathable membrane 310 can be further improved, and the water flow is prevented from flowing into the microphone 200 from the periphery of the waterproof and breathable membrane 310.

In an embodiment, please refer to FIG. 19 and FIG. 20, a mesh cloth 600 is arranged in the housing 100, the mesh cloth 600 is located between the housing 100 and the bracket 400, and the mesh cloth 600 covers a side of the sound pickup hole 110 close to the first cavity 121.

It should be noted that the mesh cloth 600 is further arranged in the housing 100, the mesh cloth 600 is located between the housing 100 and the bracket 400, and the mesh cloth 600 covers the side of the sound pickup hole 110 close to the first cavity 121, the mesh cloth 600 can be used to prevent large dust particles and the like from entering the housing 100 through the sound pickup hole 110, where the mesh cloth 600 may be made of microfiber or metal, and using these materials, the dustproof mesh cloth 600 can have better dustproof and breathable functions, and the mesh cloth 600 made of metal will have better durability and protection functions.

In an embodiment, please refer to FIG. 20, a second accommodating groove 412 is formed on a side of the bracket 400 close to the sound pickup hole 110, and the mesh cloth 600 is located in the second accommodating groove 412.

Exemplarily, most of the mesh cloth 600 is arranged in a flat shape. Considering that the mesh cloth 600 has a certain thickness and the mesh cloth 600 may be made of a metal material (incompressible), the second accommodating groove 412 is formed in the bracket 400, and the mesh cloth 600 is arranged in the second accommodating groove 412.

An embodiment of the present disclosure further provides an earphone, please refer to FIG. 18, the earphone includes a neck hanging piece 700 and an earphone structure with a waterproof microphone, and for the specific structure of the earphone structure with a waterproof microphone, reference may be made to the above embodiments. Since the earphone adopts all the technical solutions of the above embodiments, the earphone at least has all the beneficial effects brought by the technical solutions of the above embodiments, which will not be repeated here.

The neck hanging piece 700 is connected to the housing 100, specifically, two ends of the neck hanging piece 700 are respectively connected to the housings 100 of two earphone structures, and the neck hanging piece 700 is used to hang the earphone with a waterproof microphone 200 around the neck of the human body, so that the user can hang the earphone around the neck while wearing the earphone on the ear during sports. In contrast, a non-neck-hung Bluetooth earphone generally has an earphone box, and it is very inconvenient to put the earphone box in a trouser pocket during sports, and the neck hanging piece 700 is arranged to make it more convenient to wear during sports.

### Embodiment 3

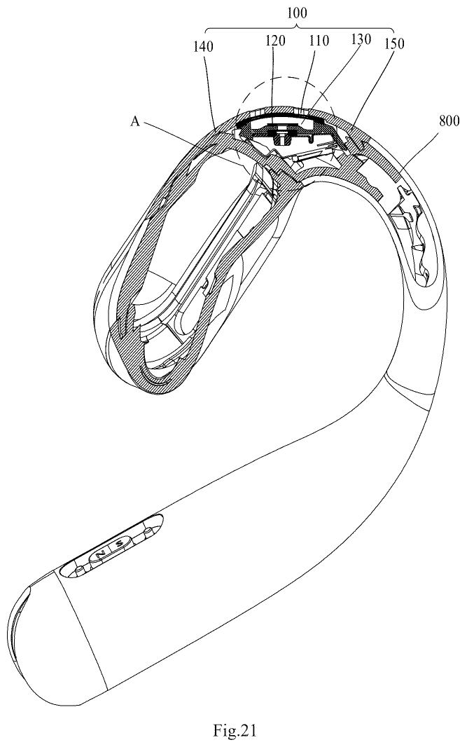

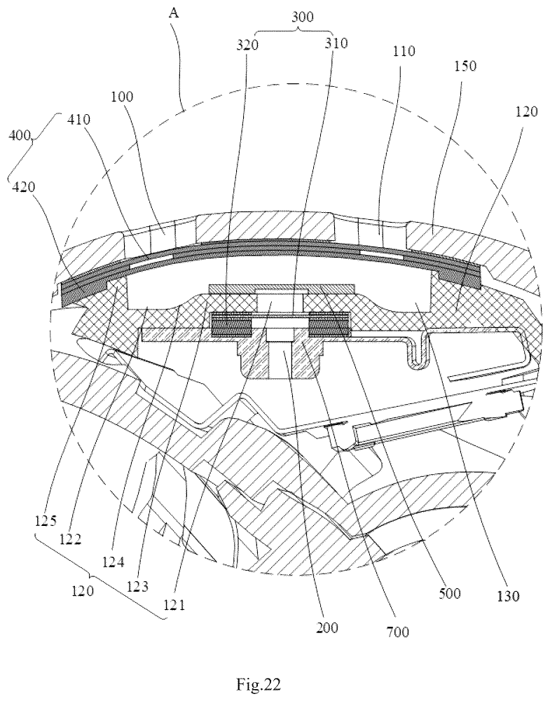

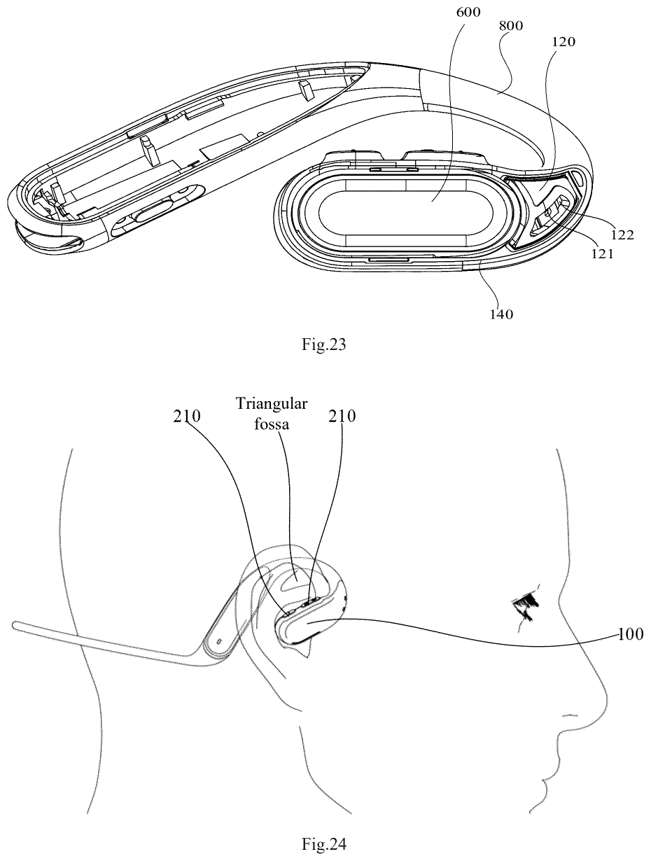

In the earphone provided by the embodiment of the present disclosure, as shown in FIGS. 21 to 23, the earphone main body includes a housing 100, and at least one sound pickup hole 110 is formed in the housing 100. It should be noted that it may be clearly seen from FIG. 7 and FIG. 22 that the sound pickup cavity and the waterproof and breathable cavity are the same structure, therefore, the sound pickup cavity may also be called a waterproof and breathable cavity, and the following embodiments are all described by taking the “sound pickup cavity” as an example. Similarly, the waterproof and breathable assembly and the waterproof and breathable structure are also one structure, therefore, the following embodiments are all described by taking the “waterproof and breathable assembly” as an example.

Referring to FIGS. 21 to 23, in an embodiment of the present disclosure, a sound pickup wall 120, which is arranged opposite to and spaced apart from the first sound pickup hole 110, is provided in the housing 100, a sound pickup cavity 130 is formed between the sound pickup wall 120 and the housing 100, the sound pickup wall 120 is provided with a second sound pickup hole 121, and the second sound pickup hole 121 is communicated with the sound pickup cavity 130; the microphone 200 is arranged on a side of the sound pickup wall 120 away from the first sound pickup hole 110; and the waterproof and breathable assembly 300 is arranged between the microphone 200 and the sound pickup wall 120 to prevent water from flowing to the microphone 200. It should be noted that in the present embodiment, the housing 100, the microphone 200, and the waterproof and breathable assembly 300 further constitute an earphone structure with a waterproof microphone, where the housing 100 is at least provided with the first sound pickup hole 110.

Exemplarily, in the present embodiment, the first sound pickup hole 110 is formed in the housing 100, the second sound pickup hole 121 is formed in the sound pickup wall 120 in the housing 100, the microphone 200 is arranged on the side of the sound pickup wall 120 away from the first sound pickup hole 110, and the waterproof and breathable assembly 300 is arranged between the microphone 200 and the sound pickup wall 120, that is, the waterproof and breathable assembly 300 is used to block the flow path of water from the end of the second sound pickup hole 121, so as to prevent water from entering the back side of the sound pickup wall 120 along the second sound pickup hole 121, and from entering the microphone 200, thereby improving the waterproof performance of the earphone and prolonging the service life of the earphone.

Optionally, any first sound pickup hole 110 and the second sound pickup hole 121 are arranged in a staggered manner in a radial direction of the first sound pickup hole 110; it may be understood that the staggered arrangement means that the orthographic projection of the second sound pickup hole 121 on a first reference plane perpendicular to the axial direction of the first sound pickup hole 110 does not overlap with the orthographic projection of the first sound pickup hole 110 on the first reference plane, and there is no overlapping part, so that it can be avoided that water directly falls into the second sound pickup hole 121 after passing through the first sound pickup hole 110, thereby improving the waterproof performance of the microphone 200.

Further, in the present embodiment, two first sound pickup holes 110 are provided, and the second sound pickup hole 121 is arranged in a staggered manner with both the first sound pickup holes 110, without any overlapping part; and the second sound pickup hole 121 is located between the two first sound pickup holes 110. Certainly, the embodiment of the present disclosure is not limited thereto, and in other embodiments, three first sound pickup holes 110 may be provided, and the specific number of the first sound pickup holes 110 is not specifically limited here.

Optionally, a waterproof groove 122 is formed at a position of the sound pickup wall 120 opposite to the first sound pickup hole 110, and the waterproof groove 122 is recessed in a direction away from the first sound pickup hole 110, the waterproof groove 122 may allow the water permeating through the first sound pickup hole 110 to accumulate therein, so as to prevent the water from flowing into the second sound pickup hole 121 along the surface of the sound pickup wall 120 when the user is moving or exercising; it may be seen that the arrangement of the waterproof groove can reduce the probability of the water entering the second sound pickup hole 121, thereby reducing the probability of the water flowing into the microphone 200.

Further, a boss 123 protruding from a bottom of the waterproof groove 122 is formed on the sound pickup wall 120, and the second sound pickup hole 121 is formed in the boss 123; it may be understood that the second sound pickup hole 121 is formed in the boss 123, so that the accumulated water in the waterproof groove 122 can be prevented from flowing into the second sound pickup hole 121, thereby reducing the probability of the water entering the second sound pickup hole 121, and further reducing the probability of the water flowing into the microphone 200.

Further, the waterproof groove 122 is arranged corresponding to the first sound pickup hole 110, that is, the orthographic projection of the waterproof groove 122 on a first reference plane perpendicular to the axial direction of the first sound pickup hole 110 at least partially overlaps with the orthographic projection of the first sound pickup hole 110 on the first reference plane; in this way, the probability of the water permeating through the first sound pickup hole 110 directly falling into the waterproof groove 122 can be increased, thereby reducing the probability of the water permeating through the first sound pickup hole 110 falling on the surface of the boss 123 or even directly falling into the second sound pickup hole 121.

Optionally, the waterproof groove 122 has a flow guide surface 124, and the flow guide surface 124 extends obliquely from the surface of the boss 123 to the bottom of the waterproof groove 122; the arrangement of the flow guide surface 124 can guide the water to flow into the waterproof groove 122 when the water falls on the surface of the boss 123, and reduce the probability that the water on the surface of the boss 123 flows into the second sound pickup hole 121 along the surface of the boss 123 when the user is moving or exercising. It may be seen that the embodiment of the present disclosure can reduce the probability of the water entering the second sound pickup hole 121, thereby reducing the probability of the water flowing into the microphone 200.

Optionally, the waterproof and breathable assembly 300 includes at least one waterproof and breathable layer that is stacked, and the arrangement of the at least one waterproof and breathable layer stacked can increase the sealing performance of the sound pickup cavity 130, so as to prevent water from entering the microphone 200, improve the waterproof performance of the earphone, and prolong the service life of the earphone.

Optionally, the waterproof and breathable layer includes a waterproof and breathable membrane 310, and the waterproof and breathable membrane 310 is arranged on a side of the sound pickup wall 120 away from the first sound pickup hole 110 and covers the second sound pickup hole 121; because the waterproof and breathable membrane 310 not only has excellent waterproof and breathable performance, but also resists aging and oxidation, the waterproof and breathable membrane 310 can prolong the service life of the waterproof and breathable layer.

Optionally, the material of the waterproof and breathable membrane 310 is any one selected from a group consisting of polytetrafluoroethylene, expanded polytetrafluoroethylene, polyurethane resin, and thermoplastic polyurethane.

In the present embodiment, the material of the waterproof and breathable membrane 310 is expanded polytetrafluoroethylene, which is a membrane produced from polytetrafluoroethylene by a special process. The waterproof and breathable membrane 310 is mainly characterized by waterproof and breathable, dustproof and breathable, and prevention of bacteria and breathable, and is called a “breathable material” in foreign countries.

Further, the waterproof and breathable membrane 310 is mainly composed of a microfiltration membrane, and has a pore size between 0.1 and 10 μm. For the waterproof and breathable membrane 310, the water inlet pressure and the air permeability are two very important values. Generally, these two values are in a competitive relationship, and a high air permeability means a low water inlet pressure. The waterproof and breathable membrane 310 is mainly divided into a hydrophobic membrane and an oleophobic membrane, and the oleophobic membrane is used in the present embodiment. Since expanded polytetrafluoroethylene has certain natural hydrophobicity and oleophobicity, it sometimes gets wet and permeated when encountering liquids with low surface energy, such as alcohol, cleaning agents, lubricants, etc. The oleophobic membrane has a lower surface energy and can resist the infiltration of these liquids.

Optionally, the waterproof and breathable assembly 300 further includes a compressible first waterproof elastic piece 320, and the first waterproof elastic piece 320 is arranged on a side of the waterproof and breathable layer away from the sound pickup wall 120; it may be understood that the first waterproof elastic piece 320 can further improve the waterproof performance of the waterproof and breathable assembly 300, and prevent water from entering the body from the side directions.

Further, a circuit board 700 is arranged on a side of the sound pickup wall 120 away from the first sound pickup hole 110, the microphone 200 is arranged on the circuit board 700, and the circuit board 700 abuts against a side of the waterproof and breathable assembly 300 away from the sound pickup wall 120, that is, the circuit board 700 abuts against the first waterproof elastic piece 320, so that the first waterproof elastic piece 320 is compressed, thereby increasing the sealing performance between the waterproof and breathable layer and the sound pickup wall 120, between the waterproof and breathable layer and the first waterproof elastic piece 320, and between the first waterproof elastic piece 320 and the circuit board 700, and improving the waterproofness of the waterproof and breathable assembly 300.

Further, the circuit board 700 is configured as a flexible circuit board. Firstly, the flexible circuit board is flexible and may be freely bent and folded, and will not be damaged after being bent for tens of thousands of times, and may be arbitrarily arranged according to the space layout, and may be arbitrarily stretched and moved in a three-dimensional space, so as to realize the integration of component assembly and wiring, with high flexibility, which is convenient for the circuit board 700 to bend and fold according to the installation environment. Secondly, the flexible circuit board is thin, light and flat, which makes the structural layout of the earphone more compact and reasonable, reduces the volume and weight of the earphone, and makes it convenient to carry. Thirdly, the flexible circuit board is highly safe, because the wires of the flexible circuit board are integrally connected and have highly consistent parameters, which can reduce the error problems when the wires are assembled, and reduce the occurrence of failures of the earphone. Fourthly, the flexible circuit board has high assembly reliability, and the planar wiring of the flexible circuit board can reduce switch interconnection, facilitate circuit design, reduce assembly work, improve the reliability of the whole system of the earphone, and facilitate fault detection. Fifthly, the flexible circuit board has good heat dissipation, weldability and easy assembly, and has various base materials, which may be selected according to different requirements. Certainly, the embodiment of the present disclosure is not limited thereto, and in other embodiments, the circuit board 700 may also be configured as a rigid circuit board.

Further, the waterproof and breathable layer is bonded to the sound pickup wall 120; and/or, the waterproof and breathable layer is bonded to the first waterproof elastic piece 320; and/or, the first waterproof elastic piece 320 is bonded to the circuit board 700; because the bonded connection has a good sealing performance, and the sealing performance between the waterproof and breathable assembly 300 and the sound pickup wall 120 and the circuit board 700 can be increased, thereby improving the waterproofness of the waterproof and breathable assembly 300. Moreover, the bonding process is simple and the manufacturing cost is low, so that the installation cost of the waterproof and breathable assembly 300 can be reduced. Certainly, the embodiment of the present disclosure is not limited thereto, and in other embodiments, the waterproof and breathable layer may also abut against the sound pickup wall 120; and/or, the waterproof and breathable layer may also abut against the first waterproof elastic piece 320; and/or, the first waterproof elastic piece 320 may also abut against the circuit board 700.

Preferably, the waterproof and breathable layer is bonded to the sound pickup wall 120 by back adhesive; and/or, the waterproof and breathable layer is bonded to the first waterproof elastic piece 320 by back adhesive; and/or, the first waterproof elastic piece 320 is bonded to the circuit board 700 by back adhesive. Certainly, the embodiment of the present disclosure is not limited thereto, and in other embodiments, the waterproof and breathable layer may also be bonded to the sound pickup wall 120 by double-sided adhesive tape; and/or, the waterproof and breathable layer may also be bonded to the first waterproof elastic piece 320 by double-sided adhesive tape; and/or, the first waterproof elastic piece 320 may also be bonded to the circuit board 700 by double-sided adhesive tape.

Optionally, the first waterproof elastic piece 320 is made of waterproof foam, which not only has waterproof performance, but also has excellent compressible deformability and long-lasting elasticity. While ensuring the waterproof performance, the compressible deformability of the waterproof foam may be used to increase the sealing performance of the connection position of the first waterproof elastic piece 320, thereby increasing the sealing performance of the waterproof and breathable assembly 300. Certainly, the embodiment of the present disclosure is not limited thereto, and in other embodiments, the first waterproof elastic piece 320 may also be made of waterproof and breathable fabric.

Exemplarily, the waterproof foam is made of pron4701 foam, and other types of waterproof foam are also acceptable, and the material of the waterproof foam is not specifically limited here.

Optionally, the earphone structure with a waterproof microphone further includes a mesh cloth structure 400, the mesh cloth structure 400 is arranged on a side of the housing 100 facing the sound pickup wall 120 and covers the first sound pickup hole 110, and the first sound pickup hole 110 is communicated with the sound pickup cavity 130 through the mesh cloth structure 400; it may be understood that the mesh cloth structure 400 covering the first sound pickup hole 110 is arranged on the side of the housing 100 facing the sound pickup wall 120, so that the impurities such as water and dust can be reduced from entering the waterproof and breathable cavity 130 through the first sound pickup hole 110, that is, the sound pickup cavity 130 before the microphone 200 is formed into a waterproof, breathable and sound-guiding channel by using the waterproof and breathable assembly 300 and the mesh cloth structure 400, thereby reducing the probability of water entering the microphone 200.

Optionally, the mesh cloth structure 400 includes a first mesh cloth 410 and a compressible second waterproof elastic piece 420 that are stacked with each other, and the second waterproof elastic piece 420 abuts against a side of the first mesh cloth 410 away from the first sound pickup hole 110; it may be understood that the first mesh cloth 410 can block impurities such as dust, the second waterproof elastic piece 420 can play a role of lateral waterproofing, and prevent water from entering the body from the side directions, and the mesh cloth structure 400 can increase the waterproofness of the sound pickup cavity 130, thereby reducing the probability of water entering the sound pickup cavity 130. Certainly, the present disclosure is not limited thereto, and in a second embodiment, the mesh cloth structure 400 may also be made of waterproof and breathable fabric. Certainly, the present disclosure is not limited thereto, and in the second embodiment, the mesh cloth structure 400 may also include a first mesh cloth 410 and a waterproof and breathable membrane that are stacked with each other.

Optionally, the second waterproof elastic piece 420 is also made of waterproof foam, which not only has waterproof performance, but also has excellent compressible deformability and long-lasting elasticity. While ensuring the waterproof performance, the compressible deformability of the waterproof foam may be used to increase the sealing performance of the connection position of the second waterproof elastic piece 420, thereby increasing the sealing performance of the waterproof and breathable assembly 300. Certainly, the present disclosure is not limited thereto, and in other embodiments, the second waterproof elastic piece 420 may also be made of waterproof and breathable fabric. Exemplarily, the waterproof foam is made of pron4701 foam, and other types of waterproof foam are also acceptable, and the material of the waterproof foam is not specifically limited here.

Optionally, a sound pickup frame is arranged in the housing 100, the sound pickup wall 120 is a side wall of the sound pickup frame opposite to the first sound pickup hole 110, and the sound pickup frame has a front wall abutting against the mesh cloth structure 400. It may be understood that the sound pickup frame is used to abut against the mesh cloth structure 400, that is, the sound pickup frame abuts against the second waterproof elastic piece 420, thereby increasing the sealing performance of the mesh cloth structure 400, and further increasing the waterproofness of the sound pickup cavity 130.

Optionally, the front wall has a pressing convex portion 125, and the pressing convex portion 125 abuts against the mesh cloth structure 400; the pressing convex portion 125 can increase the stability of abutting of the first waterproof and breathable assembly 300, thereby increasing the sealing performance of the mesh cloth structure 400. Certainly, the present disclosure is not limited thereto, and in some other embodiments, the pressing convex portion 125 may not be provided, and the wall surface of the front wall directly abuts against the mesh cloth structure 400.

Exemplarily, the pressing convex portion 125 abuts against a back side of a connection position of the second waterproof elastic piece 420 and the first mesh cloth 410, so that the sealing performance of the connection position can be increased, thereby preventing water from flowing into the sound pickup cavity 130 from the connection position of the first mesh cloth 410 and the housing 100 and the connection position of the first mesh cloth 410 and the second waterproof elastic piece 420, and further improving the waterproofness of the sound pickup cavity 130.

Further, the first mesh cloth 410 is bonded to the side of the housing 100 facing the sound pickup wall 120; and/or, the first mesh cloth 410 is bonded to the second waterproof elastic piece 420; and/or, the second waterproof elastic piece 420 abuts against and is bonded to the sound pickup wall 120. Because the bonded connection has a good sealing performance, the sealing performance between the waterproof mesh cloth and the housing 100 can be increased, thereby increasing the waterproofness of the sound pickup cavity 130. Moreover, the bonding process is simple and the manufacturing cost is low, so that the installation cost of the mesh cloth structure 400 can be reduced. Certainly, the present disclosure is not limited thereto, and in other embodiments, the first mesh cloth 410 may also abut against the side of the housing 100 facing the sound pickup wall 120; and/or, the first mesh cloth 410 may also abut against the second waterproof elastic piece 420; and/or, the second waterproof elastic piece 420 may also only abut against the sound pickup wall 120.

Preferably, the first mesh cloth 410 is bonded to the side of the housing 100 facing the sound pickup wall 120 by double-sided adhesive tape; and/or, the first mesh cloth 410 is bonded to the second waterproof elastic piece 420 by double-sided adhesive tape; and/or, the second waterproof elastic piece 420 is bonded to the sound pickup wall 120 by double-sided adhesive tape. Certainly, the present disclosure is not limited thereto, and in other embodiments, the first mesh cloth 410 is bonded to the side of the housing 100 facing the sound pickup wall 120 by back adhesive; and/or, the first mesh cloth 410 is bonded to the second waterproof elastic piece 420 by back adhesive; and/or, the second waterproof elastic piece 420 is bonded to the sound pickup wall 120 by back adhesive.

Optionally, the earphone structure with a waterproof microphone further includes a second mesh cloth 500, the second mesh cloth 500 is arranged on a side of the sound pickup wall 120 facing the first sound pickup hole 110 and covers the second sound pickup hole 121; the second mesh cloth 500 can further filter impurities such as dust in the sound pickup cavity 130, and reduce the impurities such as dust from entering the second sound pickup hole 121.

Optionally, the housing 100 includes a main housing 140 and an upper cover 150 covering an opening of the main housing 140, the sound pickup wall 120 is arranged in the opening of the main housing 140, and the sound pickup wall 120 is connected to the main housing 140 in a sealing manner; it may be understood that the sound pickup wall 120 is connected to the main housing 140 in a sealing manner, that is, the sealing performance of a side of the sound pickup wall 120 away from the first sound pickup hole 110 can be increased, and since the microphone 200 is arranged on the side of the sound pickup wall 120 away from the first sound pickup hole 110, water can be prevented from entering the side of the sound pickup wall 120 away from the first sound pickup hole 110, thereby preventing water from entering the microphone 200, improving the waterproof performance of the earphone, and prolonging the service life of the earphone. Certainly, the present disclosure is not limited thereto, and in some other embodiments, the sound pickup wall 120 may also be arranged on the upper cover 150 and connected to the upper cover 150 in a sealing manner, and the upper cover 150 is connected to the main housing 140 in a sealing manner.

Optionally, a sealing adhesive is arranged between a periphery of the sound pickup wall 120 and the main housing 140, in this way, the sealing adhesive not only can be used to bond the sound pickup wall 120 to the main housing 140, but also can be used to seal the connection position of the sound pickup wall 120 and the main housing 140. Certainly, the present disclosure is not limited thereto, and in some other embodiments, a sealing gasket may also be arranged between the periphery of the sound pickup wall 120 and the main housing 140.

Optionally, the upper cover 150 is sealed and bonded to the main housing 140, and it may be understood that the upper cover 150 is sealed and bonded to the main housing 140, so that the waterproof performance of the sound pickup cavity 130 can be improved, thereby increasing the waterproof performance of the earphone and prolonging the service life of the earphone. Certainly, the present disclosure is not limited thereto, and in some other embodiments, the upper cover 150 may also be sealed and clamped to the main housing 140.

Optionally, the earphone further includes a passive diaphragm 600, the passive diaphragm 600 and the sound pickup wall 120 are arranged side by side at the opening of the main housing 140, and a sealing adhesive is arranged between the passive diaphragm 600 and the main housing 140, it may be understood that the sound producing device (the passive diaphragm 600 is a part of the sound producing device) is arranged at a position of the sound pickup wall 120 away from the first sound pickup hole 110, the passive diaphragm 600 is arranged side by side with the sound pickup wall 120, that is, the sound producing device is also located on a side of the passive diaphragm 600 away from the first sound pickup hole 110, and the sealing adhesive is arranged between the passive diaphragm 600 and the main housing 140, so that the sealing performance of the side of the passive diaphragm 600 away from the first sound pickup hole 110 can be increased, thereby preventing water from entering the sound producing device, improving the waterproof performance of the earphone, further improving the acoustic performance of the earphone, and prolonging the service life of the earphone. Certainly, the present disclosure is not limited thereto, and in some other embodiments, a sealing gasket may also be arranged between the passive diaphragm 600 and the main housing 140, so as to increase the sealing performance of the connection between the passive diaphragm 600 and the main housing 140.

Optionally, in a wearing state, the first sound pickup hole 110 faces a head top direction of a human body, so that when wearing the earphone, water may flow down along the housing 100, thereby reducing the probability of water entering the sound pickup cavity 130.

The wearing state is defined as follows. The “wearing state” described in the present disclosure is a stable wearing state after the earphone is stably worn on the ear of the human body; certainly, due to individual differences among users, the actual wearing state of the earphone may be somewhat different from the aforementioned wearing state.

The present disclosure further provides an earphone, which includes an ear hook portion 800 and an earphone structure with a waterproof microphone. For the specific structure of the earphone structure with a waterproof microphone, reference may be made to the above embodiments. Since the present earphone adopts all the technical solutions of the above embodiments, it at least has all the beneficial effects brought by the technical solutions of the above embodiments, which will not be repeated here. The ear hook portion 800 includes a sound producing portion located on a front side of the ear, and the earphone structure with a waterproof microphone is arranged on the sound producing portion. The ear hook portion 800 can increase the stability of the earphone worn on the ear.

Exemplarily, the sound producing portion includes a speaker.

Optionally, the earphone further includes a neck hanging piece, two ends of the neck hanging piece are respectively provided with one ear hook portion 800, and the earphone structure with a waterproof microphone is arranged on at least one ear hook portion 800; the neck hanging piece is convenient for the user to hang the earphone on the neck of the human body when the earphone is not in use, thereby increasing the convenience of use; moreover, the neck hanging piece can also enable the earphone to still hang on the neck of the human body when the earphone falls off from the ear, so that the earphone can be prevented from falling.

### Embodiment 4

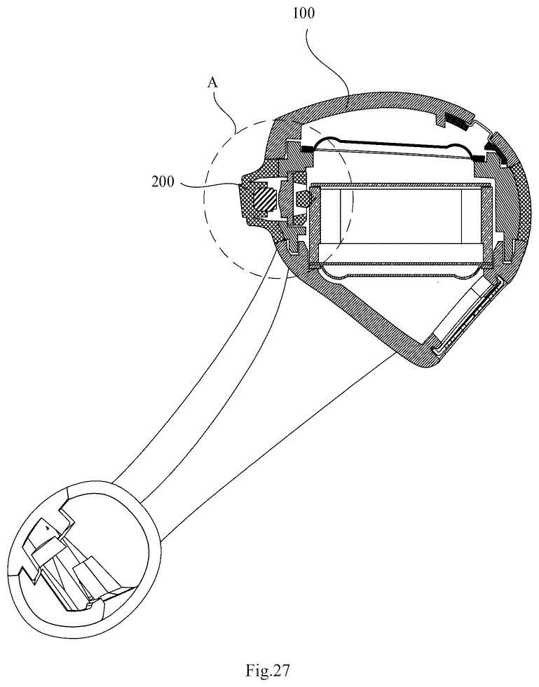

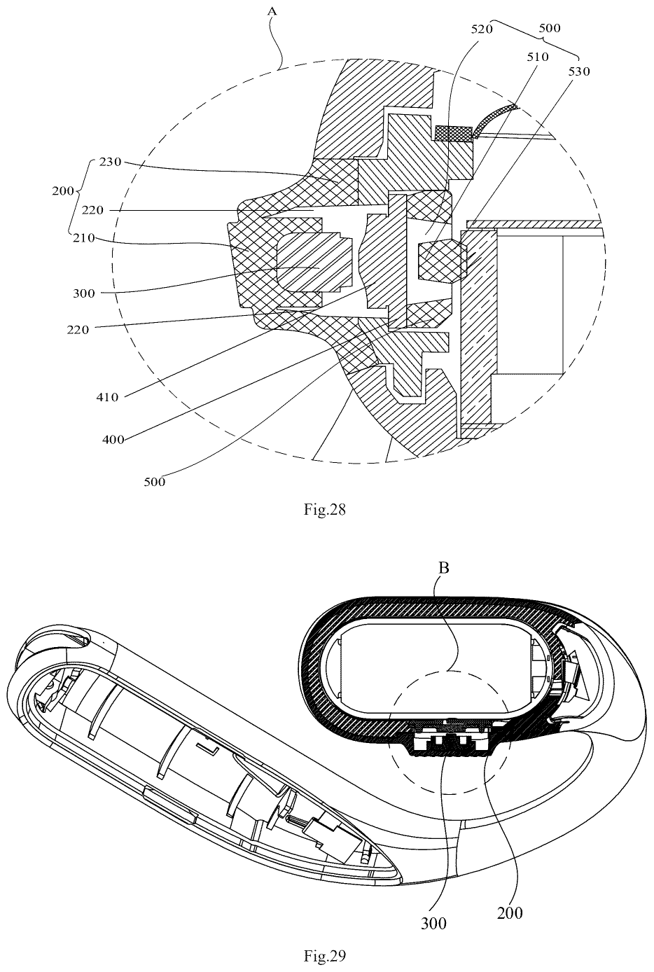

Referring to FIG. 27 to FIG. 28, in an embodiment of the present disclosure, the earphone includes an earphone waterproof button structure, which includes a housing 100, an elastic sealing layer 200 and a button 300, the housing 100 is provided with an opening 110; the elastic sealing layer 200 covers the opening 110 and is hermetically connected with an outer edge of the opening 110, and the elastic sealing layer 200 has a pressing portion 210 protruding in a direction away from the opening 110; the button 300 is integrally connected with a side of the pressing portion 210 close to the housing 100.

Exemplarily, the elastic sealing layer 200 covers the opening 110, and the elastic sealing layer 200 is hermetically connected with the outer edge of the opening 110, so that the opening 110 is in a sealed state, thereby improving the waterproof performance of the position of the opening 110 of the housing 100, further preventing moisture from entering the interior of the housing 100 through the opening 110 and the gap between the button 300 and the housing 100, and preventing moisture from entering the interior of the housing 100 and damaging electrical components therein. Moreover, the elastic sealing layer 200 has the pressing portion 210 protruding in the direction away from the opening 110, which is convenient for the user to find the position of the button 300 when the user needs to perform blind pressing, thereby realizing blind pressing; it may be seen that the technical solution provided by the present disclosure can improve the waterproof performance of the button structure.

It should be noted that the button structure of the embodiment of the present disclosure may be a volume button, a switch button, a track switching button, or the like, and the specific type of the button structure is not limited here.

Preferably, in this embodiment, the button structure of the embodiment of the present disclosure is configured as a volume switch button, that is, pressing the volume-up button once is a volume-up control instruction, and pressing the volume-up button twice in a row is a switch control instruction.

Optionally, the button 300 and the elastic sealing layer 200 are integrally injection molded; because the molding process of integral injection molding has a fast production speed and high efficiency, the production efficiency of the earphone waterproof button structure can be improved. Certainly, the present disclosure is not limited thereto, and in other embodiments, the button 300 may also be connected to the elastic sealing layer 200 as a whole by bonding.

It should be noted that the above-mentioned integral injection molding is specifically secondary injection molding, after the button 300 is molded, the button 300 is placed in a secondary molding mold and the material of the elastic sealing layer 200 is injected, so that the elastic sealing layer 200 and the button 300 are connected as a whole.

Further, a side of the elastic sealing layer 200 close to the housing 100 is provided with a mounting portion, and the button 300 is arranged on the mounting portion; the mounting portion can facilitate the installation of the button 300, and can prevent the actual mounting position of the button 300 from deviating from a preset mounting position when the button 300 is mounted, prevent the misalignment between the button 300 and the switch 410 arranged at the opening 110, and prevent the problem that the button 300 fails to trigger the switch 410 in time or even fails to trigger the switch 410.

Optionally, the mounting portion has a mounting groove for embedding the button 300. It may be understood that the button 300 is embedded in the mounting groove, and the groove wall of the mounting groove may cover the button 300, thereby increasing the stability of the installation of the button 300. Certainly, the embodiment of the present disclosure is not limited thereto, and in some other embodiments, the mounting groove may not be provided, and the button 300 is directly injection molded on the surface of the elastic sealing layer 200 without the mounting groove.

Optionally, the button 300 partially protrudes from the mounting groove; this can facilitate the user to grasp the button 300, thereby facilitating the disassembly of the button 300 from the mounting groove, and the button 300 partially protrudes from the mounting groove, which also prevents the groove wall of the mounting groove from interfering with the switch 410 when the button 300 is triggered. Certainly, the embodiment of the present disclosure is not limited thereto, and in other embodiments, the button 300 may not protrude from the mounting groove.

Optionally, a buffer groove 220 recessed in a direction away from the opening 110 is formed on an outer periphery of the mounting portion; the buffer groove 220 can increase the softness of the pressing portion 210, thereby increasing the feel of the user when pressing, and improving the comfort of the user when pressing. Certainly, the embodiment of the present disclosure is not limited thereto, and in other embodiments, the buffer groove 220 may not be provided on the outer periphery of the mounting portion.

Further, the buffer groove 220 is arranged around the mounting portion. It may be understood that the buffer groove 220 is arranged around the mounting portion, that is, the buffer groove 220 is arranged around the button 300, in this way, no matter which part of the pressing portion 210 is pressed by the user, the buffer groove 220 can be deformed, thereby increasing the feel of the user when pressing. Certainly, the embodiment of the present disclosure is not limited thereto, and in other embodiments, a buffer groove 220 may be respectively arranged on two opposite sides of the mounting portion, instead of the buffer groove 220 arranged around the mounting plate.

Preferably, a thickness of a position of the elastic sealing layer 200 corresponding to the buffer groove 220 is d, and a value range of d is: 0.4 mm≤d≤0.8 mm. It may be understood that the thickness of the elastic sealing layer 200 not only affects the elasticity, but also affects the service life of the elastic sealing layer 200. Limiting the thickness of the position of the elastic sealing layer 200 corresponding to the buffer groove 220 to a range of 0.4 mm≤d≤0.8 mm can increase the service life while ensuring the feel of pressing. When d<0.4 mm, the elastic sealing layer 200 has a short service life. If d>0.8 mm, the hardness of the elastic sealing layer 200 increases, thereby reducing the comfort of pressing.

Further, in an embodiment, the thickness of the position of the elastic sealing layer 200 corresponding to the buffer groove 220 is 0.4 mm. In a second embodiment, the thickness of the position of the elastic sealing layer 200 corresponding to the buffer groove 220 may also be 0.6 mm. In a third embodiment, the thickness of the position of the elastic sealing layer 200 corresponding to the buffer groove 220 may also be 0.7 mm. The thickness of the position of the elastic sealing layer 200 corresponding to the buffer groove 220 is not specifically limited here.

Exemplarily, in this embodiment, an angle between the bottom wall of the buffer groove 220 and the side wall of the buffer groove 220 is a right angle, which can make the elastic sealing layer 200 better rebound.

Further, the button 300 is made of a hard material, including but not limited to hard plastic.

Optionally, the elastic sealing layer 200 is made of at least one selected from a group consisting of silica gel, polycarbonate, polyamide and acrylonitrile-butadiene-styrene copolymer.

Preferably, in this embodiment, the elastic sealing layer 200 is made of silica gel. Since silica gel has strong sealing performance, and has the advantages of waterproofness, environmental protection, durability and low price, configuring the elastic sealing layer 200 made of silica gel can not only ensure the waterproofness of the elastic sealing layer 200, but also reduce the cost of the elastic sealing layer 200. Moreover, silica gel also has good heat resistance and cold resistance, and has a long service life when exposed to the external environment of the earphone; more importantly, silica gel has tear resistance, and the elastic sealing layer 200 is not easy to tear even if it is pressed for a long time and undergoes elastic deformation; therefore, configuring the elastic sealing layer 200 made of silica gel can also make the elastic sealing layer 200 have a long service life.

Optionally, the opening 110 includes a first opening section and a second opening section that are arranged to communicate with each other from outside to inside, a step surface is formed between the first opening section and the second opening section, the step surface is arranged outward, the elastic sealing layer 200 is provided with a sealing section 230 extending into the opening 110, and the sealing section 230 abuts against the step surface. It may be understood that the step surface is arranged in the opening 110, and the sealing section 230 of the elastic sealing layer 200 abuts against the step surface, so that a sealing surface can be formed, thereby increasing the sealing performance of the opening 110. Certainly, the embodiment of the present disclosure is not limited thereto, and in some other embodiments, the opening 110 may also be provided with only one opening section, the elastic sealing layer 200 is provided with a waterproof section extending into the opening 110, and a side wall of the waterproof section abuts against a side wall of the opening section.

Referring to FIG. 30, optionally, a surface of the pressing portion 210 is provided with an anti-slip layer 211; it may be understood that providing an anti-slip portion on the surface of the pressing portion 210 can increase friction, thereby preventing the hand of the user from slipping sideways, and facilitating the user to press the button 300.

Preferably, in this embodiment, the anti-slip layer 211 includes a plurality of convex strips arranged at intervals, such an anti-slip portion is simple to form, and is convenient to increase the forming efficiency of the anti-slip layer 211 while ensuring the anti-slip effect. Certainly, the embodiment of the present disclosure is not limited thereto, and in some other embodiments, the anti-slip portion may also be configured with a plurality of anti-slip convex points.

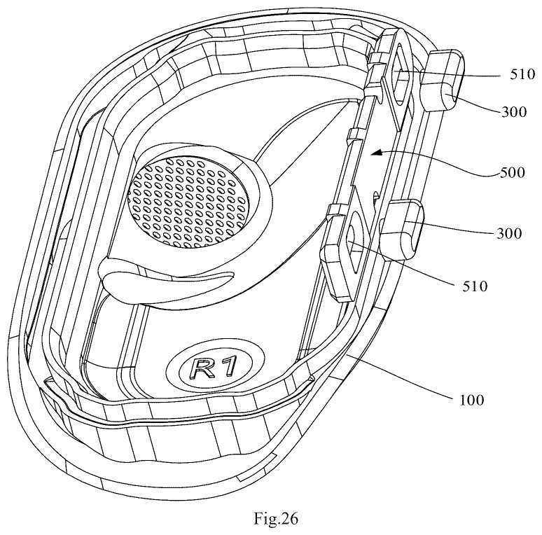

Please refer to FIGS. 25, 26, 28, 29 and 30, optionally, the earphone waterproof button structure further includes a circuit board 400 and a mounting bracket 500, the mounting bracket 500 presses against a side of the circuit board 400 away from the button 300, so as to fix the circuit board 400 at the position of the opening 110, and the circuit board 400 has a switch 410 corresponding to the button 300; specifically, when the button 300 is pressed to trigger the switch 410 on the circuit board 400, the circuit board 400 will indirectly receive the pressing force, and the mounting bracket 500 can provide a certain supporting force for the circuit board 400, thereby preventing the circuit board 400 from deforming or the mounting position from being loose after receiving the pressing force for many times when the circuit board 400 is not supported by the mounting bracket 500; moreover, when the pressing force of the user is too large, the mounting bracket 500 can also support the circuit board 400 to prevent the circuit board 400 from being pressed through. In addition, the mounting bracket 500 is arranged separately from the housing, and the mounting bracket 500 is stressed during the pressing process of the button 300, and the mounting bracket 500 has a certain buffering effect, which prevents the part of the housing at this position from being damaged/loose during the long-term use.

Further, the mounting bracket 500 has an elastic limiting portion 510, and the elastic limiting portion 510 is arranged corresponding to the switch 410; the elastic limiting portion 510 has the function of absorbing the pressing energy of the button 300, and buffers the pressing force of the user acting on the mounting bracket 500, so that a good hand feel can be ensured when the button 300 is pressed; moreover, the elastic limiting portion 510 prevents the overall force on the mounting bracket 500 from being too large when the pressing force applied by the user is too large, and therefore prevents the loosening of the mounting bracket 500; in addition, because the elastic limiting portion 510 has a certain moving space, it is convenient for the assembly of an interference component on a side of the elastic limiting portion 510 away from the switch 410, so that the displacement of the mounting bracket 500 in the thickness direction can be reduced by abutting against the interference component after the assembly is completed, thereby preventing the damage/loosening caused by excessive displacement.

Preferably, in this embodiment, the mounting bracket 500 is provided with a mounting hole 520 corresponding to the switch 410, a first end of the elastic limiting portion 510 is fixed with a hole wall of the mounting hole 520, and a second end of the elastic limiting portion 510 is suspended in a manner capable of being elastically rebounded. The elastic limiting portion 510 has a simple structure and good elastic performance. When receiving the pressing force, the second end of the elastic limiting portion 510 may elastically give way, thereby absorbing the pressing energy of the button 300, and buffering the pressing force of the user acting on the mounting bracket 500, so that a good hand feel can be ensured when the button 300 is pressed. When the force is removed, the elastic limiting portion 510 can automatically rebound under the action of its own elasticity. Certainly, the embodiment of the present disclosure is not limited thereto, and in other embodiments, the elastic limiting portion 510 may also be configured as an elastic silica gel block, the elastic silica gel block is arranged on a side of the mounting bracket 500 facing the circuit board 400 and corresponding to the switch 410, when the button 300 presses the switch 410, the switch 410 will act on the elastic silica gel block, in this case, the elastic silica gel block will be elastically deformed to absorb the pressing energy of the button 300, thereby buffering the pressing force of the user acting on the mounting bracket 500.

Further, a side of the second end of the elastic limiting portion 510 away from the switch 410 is provided with a limiting table 530, and the limiting table 530 abuts against a component in the housing 100 in the thickness direction of the mounting bracket 500. It may be understood that in the assembled state, the limiting table 530 abuts against the component in the housing 100.

When the second end of the elastic limiting portion 510 receives the pressing force of the button 300, it will be elastically deformed in a direction away from the button 300, in this case, the limiting table 530 will also be displaced with the second end of the elastic limiting portion 510, since the limiting table 530 and the corresponding component keep abutting against each other for a long time after the assembly is completed, the moving distance of the mounting bracket 500 along the thickness direction thereof is limited, thereby ensuring the feel of pressing; at the same time, the distance of the elastic limiting portion 510 to elastically give way is also limited, so as to prevent it from being damaged/loose, and also prevent the user from pressing too hard and pressing through the circuit board 400;

It should be noted that in this embodiment, the limiting table 530 abuts against a speaker arranged in the housing 100, certainly, the embodiment of the present disclosure is not limited thereto, and in other embodiments, the limiting table 530 may also abut against other components in the housing.

In some embodiments, silica gel is dispensed in the mounting hole 520 before assembly, and the elastic limiting portion 510 has a high elasticity before the silica gel is completely solidified, so that the elastic limiting portion 510 may move in a direction away from the speaker in the thickness direction during the mounting process, and the elastic limiting portion 510 rebounds to abut against a side surface of the speaker after the speaker is assembled. After the installation is completed, the elastic limiting portion 510 and the circuit board 400 are connected as a whole by the silica gel.

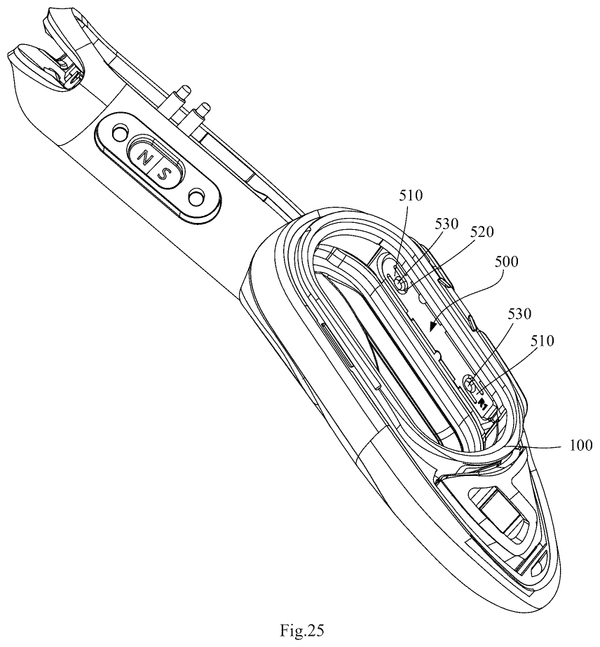

Referring to FIGS. 24, 27 and 28, optionally, in this embodiment, the earphone includes an ear hook portion, the ear hook portion includes a sound producing portion located on a front side of the ear, and the earphone waterproof button structure is arranged on the sound producing portion; the ear hook portion can increase the stability of the earphone worn on the ear.

Specifically, the sound producing portion includes a speaker.

Optionally, in the wearing state, the earphone waterproof button structure is arranged on a side of the sound producing portion facing a triangular fossa of the ear, which can facilitate the user to press the button and avoid interference with the ear when the user presses the button.

The wearing state is defined as follows. The “wearing state” described in the present disclosure is a stable wearing state after the earphone is stably worn on the ear of the human body; certainly, due to individual differences among users, the actual wearing state of the earphone may be somewhat different from the aforementioned wearing state.

Optionally, the earphone further includes a neck hanging piece, two ends of the neck hanging piece are respectively provided with one ear hook portion, and the waterproof button structure is arranged on at least one ear hook portion; the neck hanging piece is convenient for the user to hang the earphone on the neck of the human body when the earphone is not in use, thereby increasing the convenience of use; moreover, the neck hanging piece may also enable the earphone to still hang on the neck of the human body when the earphone falls off from the ear, so that the earphone may be prevented from falling.

### Embodiment 5

In an embodiment of the present disclosure, as shown in FIGS. 31 to 33, the earphone includes a housing 100, a sound producing device 200 is installed in the housing 100, the housing 100 includes a main shell 110 and an inner cover 120 that are sealed with each other, the inner cover 120 and the main shell 110 enclose to form an accommodating cavity 130, the inner cover 120 has a baffle plate 121 that is protruding arranged on a side close to the main shell 110, the baffle plate 121 is spaced apart from an outer wall of the inner cover 120, so as to form a sealing groove 122 between the outer wall of the inner cover 120 and the baffle plate 121, the main shell 110 is provided with an inserting portion 113 inserted into the sealing groove 122, the inserting portion 113 is hermetically connected with the sealing groove 122, a gap 900 is formed between a side of the baffle plate 121 opposite to the sealing groove 122 and the sound producing device 200, and the sound producing device 200 is hermetically connected with the baffle plate 121.

The earphone has the housing 100, and the housing 100 is used to accommodate and install other components inside the earphone, so as to prevent dust or water outside the housing 100 from polluting electronic devices (a speaker, a circuit board, a microphone, etc.) inside the earphone.

The sound producing device 200 (specifically a speaker in the earphone, also known as a loudspeaker) is installed in the housing 100, and it should be noted that the housing 100 includes the main shell 110 and the inner cover 120, and the main shell 110 and the inner cover 120 need to be sealed to meet the waterproof requirement of the earphone. In the process of assembling the sound producing device 200 of the earphone with the housing 100, the sound producing device 200 is first installed in the main shell 110, and then the inner cover 120 is installed and matched with the main shell 110 and the sound producing device 200 respectively, and the sound producing device 200 is installed and fixed in the housing 100 through the above installation steps. The inner cover 120 is a cover body on a side close to the user's ear in the wearing state of the earphone.

The wearing state is defined as follows. The “wearing state” described in the present disclosure is a stable wearing state after the earphone is stably worn on the ear of the human body; certainly, due to individual differences among users, the actual wearing state of the earphone may be somewhat different from the aforementioned wearing state.

Specifically, the inner cover 120 is provided with the baffle plate 121 protruding toward the main shell 110, and there is a certain space between the baffle plate 121 and the outer wall of the inner cover 120, so that the sealing groove 122 is formed between the baffle plate 121 and the outer wall of the inner cover 120, while the main shell 110 is provided with the inserting portion 113 corresponding to the sealing groove 122, and the inserting portion 113 is first inserted into the sealing groove 122 and then is in sealing fit with the sealing groove 122. In this way, a good seal between the inner cover 120 and the main shell 110 can be ensured, and external water is prevented from entering the inside of the housing 100 through the sealing groove 122, thereby improving the waterproof performance of the housing 100. The inserting portion 113 and the sealing groove 122 may be sealed by dispensing waterproof adhesive, and certainly, may also be sealed by arranging a sealing ring between the inserting portion 113 and the sealing groove 122, and the sealing ring may be made of silica gel, rubber or other materials. The above sealing methods may all be used to seal the inserting portion 113 and the sealing groove 122, and the sealing method here is not specifically limited.

It should also be noted that, the main shell 110 and the inner cover 120 may be installed and fixed through the sealing connection between the inserting portion 113 and the sealing groove 122; the main shell 110 and the inner cover 120 may also be installed and fixed by other means, such as clamping, welding or other connection methods; the main shell 110 and the inner cover 120 may also be installed and fixed through the sealing connection and other connection methods, which is not specifically limited here.

In addition, the gap 900 is formed between the side of the baffle plate 121 opposite to the sealing groove 122 and the sound producing device 200, and the gap 900 is used to seal the inner cover 120 and the sound producing device 200, and by sealing the inner cover 120 and the sound producing device 200, the sealing measures at the sound producing device 200 are enhanced, and the waterproof performance at the sound producing device 200 is improved. The sound producing device 200 and the baffle plate 121 may be sealed by dispensing waterproof adhesive, or may be sealed by arranging a sealing ring between the baffle plate 121 and the sound producing device 200, which is not specifically limited here.

According to the technical solution of the present disclosure, after the inserting portion 113 is in sealing fit with the sealing groove 122, the sound producing device 200 is further in sealing fit with the baffle plate 121, thereby improving the sealing effect of the earphone housing 100, and improving the waterproof performance of the earphone, so as to prolong the service life of the earphone.

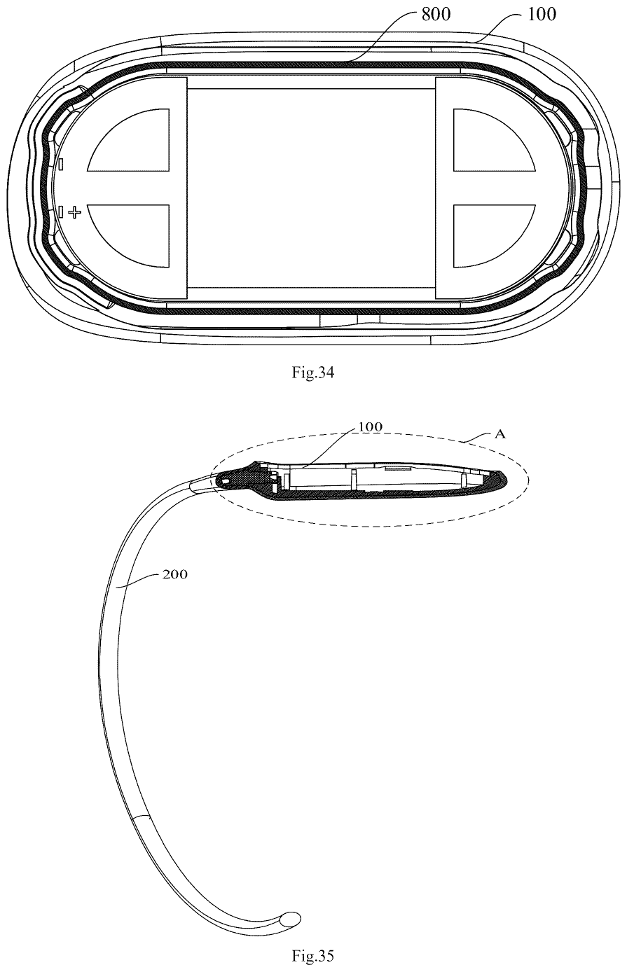

Preferably, please refer to FIG. 33, the sound producing device 200 and the baffle plate 121 are sealed by waterproof adhesive, and a side of an upper end of the baffle plate 121 close to the sound producing device 200 is provided with a guiding surface 121a.

In the present embodiment, the sound producing device 200 and the baffle plate 121 are sealed by dispensing waterproof glue in dots between the sound producing device 200 and the baffle plate 121. In the actual assembly process, the waterproof glue is first dispensed in dots on the upper end of the baffle plate 121, and then the baffle plate 121 and the sound producing device 200 are installed and matched, the waterproof glue dispensed on the upper end of the baffle plate 121 will gradually flow into the gap 900 between the sound producing device 200 and the baffle plate 121, so that the baffle plate 121 is in sealing fit with the sound producing device 200. Certainly, the waterproof glue may also be directly dispensed on the side wall of the baffle plate 121, so that the side wall of the baffle plate 121 is directly bonded to the sound producing device 200.

Considering that in the present embodiment, the gap 900 between the baffle plate 121 and the sound producing device 200 is too narrow to complete dispensing the waterproof glue on the side wall of the baffle plate 121 to be bonded to the sound producing device 200, so the adhesive may only be dispensed on the upper end of the baffle plate 121. It is also considered that the waterproof glue has a large surface tension and viscosity, and affected by the surface tension and viscosity, it is difficult for the waterproof glue to directly diffuse from a larger space to the narrow gap 900, which slows down the gluing speed between the baffle plate 121 and the sound producing device 200, and the gluing effect is not good, indirectly deteriorating the sealing performance between the baffle plate 121 and the sound producing device 200. In view of this, the guiding surface 121a for guiding the waterproof glue is arranged on the side of the upper end of the baffle plate 121 close to the sound producing device 200, and the waterproof glue is gradually guided and diffused into the gap 900 between the baffle plate 121 and the sound producing device 200 through the guiding surface 121a, thereby improving the gluing effect between the sound producing device 200 and the baffle plate 121, and enhancing the sealing performance between the baffle plate 121 and the sound producing device 200.

Further, please refer to FIG. 33, the guiding surface 121 a extends from the baffle plate 121 towards a direction of the sound producing device 200, and the guiding surface 121a is inclined from the upper end of the baffle plate 121 toward a lower end of the baffle plate 121 along an extending direction of the guiding surface 121a.

According to the description of the above embodiment, the guiding surface 121a is arranged on the side of the upper end of the baffle plate 121 close to the sound producing device 200 to guide the waterproof glue, and exemplarily, the guiding surface 121a is formed to extend substantially from the baffle plate 121 to the direction of the sound producing device 200. In order to improve the guiding effect of the guiding surface 121a, the guiding surface 121a is arranged to be inclined, that is, the distance between the guiding surface 121a and the sound producing device 200 is gradually reduced from top to bottom, specifically, the guiding surface 121a is inclined from the upper end of the baffle plate 121 toward the lower end of the baffle plate 121, so that the waterproof glue may gradually diffuse into the gap 900 between the baffle plate 121 and the sound producing device 200 along the guiding surface 121a, thereby improving the gluing effect between the sound producing device 200 and the baffle plate 121, and enhancing the sealing performance between the baffle plate 121 and the sound producing device 200.

In a preferred embodiment, please refer to FIG. 33, a corresponding chamfer 122a is arranged at a folded angle position at the bottom of the sealing groove 122, so that the wall thickness of the position of the inner cover 120 corresponding to the bottom of the sealing groove 122 is uniform.

It should be noted that, considering that in order to reduce the volume of the earphone as much as possible to meet the miniaturized and lightweight design of the earphone, the wall thickness of the housing 100 should not be set too large, and the assembly space inside the housing 100 is relatively small. Therefore, if the space of a corresponding glue dispensing groove arranged between the baffle plate 121 and the sound producing device 200 is not enough, or the wall thickness of the baffle plate 121 is too thin, which will affect its service life. Therefore, the corresponding guiding surface 121a is arranged to realize glue dispensing and sealing.

After the sealing groove 122 is formed in the inner cover 120, the wall thickness of the area corresponding to the sealing groove 122 may be uneven, resulting in stress marks (i.e., thick and thin marks, which often occur in places where the wall thickness changes too much) on the outer wall of the inner cover 120. Due to inconsistent shrinkage, there is shrinkage stress, and the shrinkage stress pulls the plastic in the thinner place inward, and a pit-like mark will be seen on the appearance, which may also be understood as shrinkage marks), resulting in the unsmooth and unattractive outer wall of the earphone. An excessively thin wall thickness of the inner cover 120 corresponding to the sealing groove 122 may even cause the housing 100 to be easily broken after being stressed. Specifically, in other embodiments, the cross section of the sealing groove without the chamfer is square, so that the sealing groove has a corner formed by enclosing the groove side wall and the groove bottom wall, and the distance between the corner close to the outer wall surface of the inner cover and the outer wall surface of the housing is too small, so that stress marks will be formed at the position corresponding to the corner on the outer wall of the inner cover.

In the present embodiment, the corner of the original sealing groove 122 close to the outer wall of the inner cover 120 is thickened to form the chamfer 122a, and the wall thickness of the section of the outer wall of the inner cover 120 corresponding to the chamfer 122a is made uniform, so as to prevent stress marks or fracture and damage of the wall surface of the housing due to too thin thickness or uneven thickness here, thereby improving the structural strength and structural stability of the outer wall of the inner cover 120.

Preferably, please refer to FIG. 33, a distance between the chamfer 122a and the outer wall surface of the inner cover 120 is set to be 0.4 mm to 0.8 mm.

Further, the distance between the wall surface of the chamfer 122a and the outer wall surface of the inner cover 120 is defined to be greater than or equal to 0.4 mm, so that the wall thickness here is not too thin, and the wall thickness of the area of the inner cover 120 close to the outer wall is relatively uniform, thereby ensuring that the structural strength and structural stability of the area of the outer wall of the inner cover 120 corresponding to the chamfer 122a are good. The distance between the wall surface of the chamfer 122a and the outer wall surface of the inner cover 120 should also be less than or equal to 0.8 mm. If the wall thickness here is too thick, the volume of the inner cover 120 will become larger, which is not conducive to the miniaturized design of the earphone itself. In view of this, the distance between the wall surface of the chamfer 122a and the outer wall surface of the inner cover 120 is limited to be between 0.4 mm and 0.8 mm, and any value in this interval may be selected, which may be 0.4 mm, 0.5 mm, or 0.7 mm, and the value is not specifically limited here.

Optionally, please refer to FIG. 34, the cross section of the sealing groove 122 is arranged in a polygonal shape.

It has been explained in the above embodiment that the cross section of the original sealing groove 122 is arranged in a square shape, and the groove side wall close to the outer wall of the inner cover 120 and the groove bottom wall of the sealing groove 122 enclose to form a corner, and the corner is thickened to form the chamfer 122a, the chamfer 122a may be regarded as the fifth wall surface of the sealing groove 122, so the cross section of the sealing groove 122 is in a pentagonal shape. Certainly, the groove side wall away from the outer wall of the inner cover 120 and the groove bottom wall of the sealing groove 122 also enclose to form a corner, and a chamfer may also be arranged here, and the cross section of the sealing groove 122 may also be in a hexagonal shape.

In a preferred embodiment, please refer to FIG. 33, a width of the sealing groove 122 is set to be 0.5 mm to 1 mm, and a depth of the sealing groove 122 is set to be 0.5 mm to 1 mm.

It should be noted that, the width of the sealing groove 122 is defined to be greater than or equal to 0.5 mm, and the depth of the sealing groove 122 is defined to be greater than or equal to 0.5 mm, so as to avoid the width or depth of the sealing groove 122 being too small to form a good connection strength with the inserting portion 113. Moreover, when the groove width or groove depth of the sealing groove 122 is too small, the length or thickness of the inserting portion 113 corresponding to the sealing groove 122 may be too small. When the inserting portion 113 is too thin, the structural strength of the inserting portion 113 is poor, and the inserting portion 113 is easy to break during the assembly process or using process of the earphone, which affects the local structural strength of the housing 100, and is not conducive to the glue dispensing operation and the connection strength after glue dispensing. Secondly, considering that the earphone needs to reduce the volume as much as possible to meet the miniaturization requirement, if the groove width and groove depth of the sealing groove 122 are set too large, the wall thickness of the inner cover will be increased. In view of this, the groove width and groove depth of the sealing groove 122 formed in the inner cover 120 should not be too large, the groove width of the sealing groove 122 is set to be less than or equal to 1 mm, and the groove depth of the sealing groove 122 is set to be less than or equal to 1 mm, that is, the width of the sealing groove 122 may be any value from 0.5 mm to 1 mm, and the depth of the sealing groove 122 may be any value from 0.5 mm to 1 mm. Certainly, the ranges of the groove depth and groove width of the sealing groove 122 in the present embodiment are preferred ranges, the groove width and groove depth of the sealing groove 122 may also be slightly less than 0.5 mm, and the groove width and groove depth of the sealing groove 122 may also be slightly greater than 1 mm, the groove width and groove depth of the sealing groove 122 within this range are also within the optional range of the above embodiment.

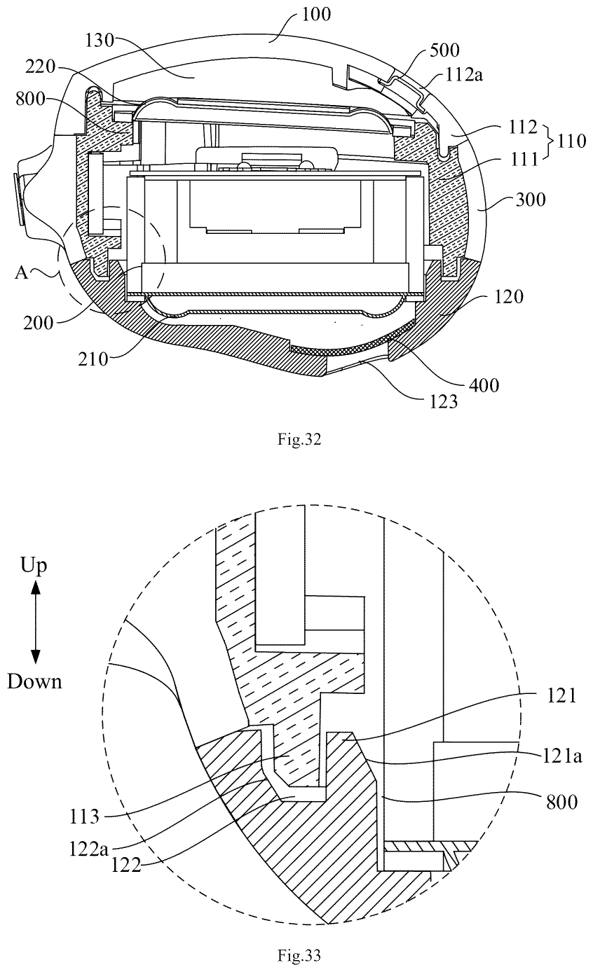

Preferably, please refer to FIG. 32 and FIG. 33, the inserting portion 113 and the sealing groove 122 are sealed by waterproof adhesive.

It should be further noted that, in the present embodiment, considering that the width of the sealing groove 122 is relatively small, it is difficult to have enough space to arrange the sealing ring, so the waterproof glue is dispensed between the inserting portion 113 and the sealing groove 122 for sealing. In the actual assembly process, glue is first dispensed in dots on a plurality of wall surfaces of the inserting portion 113, and then the inserting portion 113 is in sealing fit with the sealing groove 122, so that water outside the housing 100 is not easy to flow into the housing 100 through the connection position between the inner cover 120 and the main shell 110, thereby improving the waterproof performance of the earphone. The inserting portion 113 and the sealing groove 122 are connected by the waterproof glue, and the inserting portion 113 and the sealing groove 122 may not only seal the inserting portion 113 and the sealing groove 122, but also fix the inner cover 120 and the main shell 110 by gluing.

In an embodiment, please refer to FIG. 32, the main shell 110 includes a middle shell 111 and an outer cover 112 that are connected, and the middle shell 111 is located between the inner cover 120 and the outer cover 112.

It should be noted that, the inner cover 120 and the outer cover 112 are connected through the middle shell 111, and the housing 100 is separately provided with the inner cover 120, the middle shell 111 and the outer cover 112, which facilitates the installation of the electronic devices such as the sound producing device 200 in the housing 100, and reduces the process difficulty of the earphone assembly. Certainly, an embodiment in which the middle shell 111 and the outer cover 112 are not separately arranged is also within the scope of optional embodiments.

In an embodiment, please refer to FIG. 32, the middle shell 111 is wrapped with a protective sleeve 300, and an outer wall surface of the protective sleeve 300 is in smooth transition with both an outer wall surface of the inner cover 120 and an outer wall surface of the outer cover 112.

It should be noted that, the protective sleeve 300 arranged outside the middle shell 111 is made of silica gel, while the middle shell 111, the inner cover 120 and the outer cover 112 are generally made of plastic, silica gel has a more comfortable feel and better friction resistance than plastic, and the outer wall of the protective sleeve 300 is in smooth transition with both the outer wall surface of the inner cover 120 and the outer wall surface of the outer cover 112, so that the earphone has a more beautiful appearance, is smooth as a whole, and has a more comfortable feel.

Certainly, the protective sleeve 300 may not be arranged outside the middle shell 111, and an embodiment in which an outer wall surface of the middle shell 111 is in smooth transition with both the outer wall surface of the inner cover 120 and the outer wall surface of the outer cover 112 is also an optional embodiment of the present disclosure.

In an embodiment, please refer to FIG. 31 and FIG. 32, the inner cover 120 is provided with a first sound outlet hole 123 communicated with the accommodating cavity 130, and a side of the sound producing device 200 close to the first sound outlet hole 123 is provided with a first diaphragm 210.

According to the above description, the inner cover 120 is a cover body on a side close to the human ear after the earphone is worn on the human ear, in this way, the inner cover 120 should be provided with at least one first sound outlet hole 123 for the earphone to transmit sound signals, certainly, the number of the first sound outlet hole 123 may also be two or even more, and the number of the first sound outlet hole 123 is not specifically limited here.

The first diaphragm 210 is installed on the side of the sound producing device 200 close to the first sound outlet, and the first diaphragm 210 is used to seal the side of the sound producing device 200 close to the first sound outlet hole 123. The first diaphragm 210 has waterproof performance, which can block water, outside the sound producing device 200, flowing into the housing 100 from the first sound outlet hole 123, can improve the sealing performance of the side of the sound producing device 200 close to the first sound outlet hole 123, and further improve the overall waterproof performance of the earphone.

Further, please refer to FIG. 32, the outer cover 112 is provided with a second sound outlet hole 112a communicated with the accommodating cavity 130, a side of the sound producing device 200 close to the second sound outlet hole 112a is provided with a second diaphragm 220, and the second diaphragm 220 and the first diaphragm 210 are respectively arranged on two opposite sides of the sound producing device 200.

Correspondingly, the outer cover 112 is a cover body on a side away from the human ear after the earphone is worn on the human ear, in this way, the second sound outlet hole 112a formed in the outer cover 112 may be used to form a dipole with the first sound outlet hole 112a, and the second sound outlet hole 112a may also enhance the sound output effect of the earphone in the low frequency band. The number of the second sound outlet hole 112a may be one, and the number of the second sound outlet hole 112a may also be two or even more, and the number of the second sound outlet hole 112a is not specifically limited here.

The second diaphragm 220 is installed on the side of the sound producing device 200 close to the second sound outlet, and the second diaphragm 220 covers the side of the sound producing device 200 close to the second sound outlet hole 112a. The second diaphragm 220 also has waterproof performance, which can block water, outside the sound producing device 200, flowing into the housing 100 from the second sound outlet hole 112a, can improve the sealing performance of the side of the sound producing device 200 close to the second sound outlet hole 112a, and further improve the overall waterproof performance of the earphone.

In an embodiment, please refer to FIG. 32 and FIG. 34, a ring platform 800 is arranged in the housing 100, the ring platform 800 is arranged around the sound producing device 200, and the ring platform 800 is in sealing and adhesive connection with the second diaphragm 220.

It should be noted that, the ring platform 800 is arranged in the housing 100, the ring platform 800 is arranged around the sound producing device 200, and the ring platform 800 is in sealing and adhesive connection with the second diaphragm 220. The second diaphragm 220 is provided with a bracket, and the ring platform 220 is formed with a step surface which is attached to the bracket and achieve sealing and adhesive connection, so as to prevent water from entering the sound producing device 200 through the periphery of the second diaphragm 220. The ring platform 800 may be arranged separately from the housing 100, or the ring platform 800 may be formed on the housing 100.

In an embodiment, please refer to FIG. 32, a first mesh cloth 400 is arranged on a side of the first sound outlet hole 123 close to the accommodating cavity 130, and a second mesh cloth 500 is arranged on a side of the second sound outlet hole 112a close to the accommodating cavity 130.

It should also be noted that, considering that dust easily enters the accommodating cavity 130 through the opening of the first sound outlet hole 123, which in turn affects the sound output effect of the earphone, the first mesh cloth 400 is arranged on the side of the first sound outlet hole 123 close to the accommodating cavity 130. The first mesh cloth 400 has a plurality of micropores, and the first mesh cloth 400 can block granular objects and most of dust from entering the accommodating cavity 130, and secondly, the first mesh cloth 400 also has a good effect on blocking water drops from flowing into the accommodating cavity 130.

Dust also easily enters the housing 100 through the opening of the second sound outlet hole 112a, which in turn leads to an increase in pressure in the earphone and makes the wearer feel uncomfortable, so the second mesh cloth 500 is arranged on the side of the second sound outlet hole 112a close to the accommodating cavity 130. The second mesh cloth 500 has a plurality of micropores, and the second mesh cloth 500 can block granular objects and most of dust from entering the accommodating cavity 130, and secondly, the second mesh cloth 500 also has a good effect on blocking water drops from entering the accommodating cavity 130.

In an embodiment, please refer to FIG. 31, the inner cover 120 is further provided with a tuning hole 124, the tuning hole 124 is arranged at a distance from the first sound outlet hole 123, and the tuning hole 124 is acoustically coupled with the first diaphragm 210.

It should be noted that, the inner cover 120 is further provided with the tuning hole 124, and the tuning hole 124 is similar in function to the second sound outlet hole 112a, the tuning hole 124 may be used to balance the air pressure inside the earphone, and the tuning hole 124 can also enhance the sound output effect of the earphone in the low frequency band. There is a distance between the tuning hole 124 and the first sound outlet hole 123, and the tuning hole 124 is also arranged corresponding to the first diaphragm 210, and secondly, a mesh cloth is also arranged on a side of the tuning hole 124 close to the accommodating cavity 130 to block granular objects and most of dust from entering the accommodating cavity 130.

In an embodiment, please refer to FIG. 31, the earphone further includes an ear hook portion 600, and the ear hook portion 600 is arranged at an end of the housing 100.

The earphone includes the ear hook portion 600, the ear hook portion 600 is arranged at the end of the housing 100, and the ear hook portion 600 is hooked on the ear of the human body in the wearing state, which can increase the stability of the earphone worn on the ear.

In an embodiment, please refer to FIG. 31, the earphone further includes a neck hanging piece 700.

Optionally, the earphone further includes the neck hanging piece 700, and two ends of the neck hanging piece 700 are respectively provided with one ear hook portion 600; the neck hanging piece 700 is convenient for the user to hang the earphone on the neck of the human body when the earphone is not in use, thereby increasing the convenience of use; moreover, the neck hanging piece 700 may also enable the earphone to still hang on the neck of the human body when the earphone falls off from the ear, so that the earphone can be prevented from falling.

### Embodiment 6

In an embodiment of the present disclosure, as shown in FIGS. 35 to 38, the neck-hung earphone includes an earphone main body 100 and a neck hanging piece 200, the earphone main body 100 includes a body 110 and an earphone head 120 that are connected with each other; the neck hanging piece 200 includes a neck hanging main body 210, a plug portion 220 and a clamping table 230 that are connected in sequence; where, the body 110 is provided with a jack 111 corresponding to the plug portion 220, the plug portion 220 extends into the jack 111, the jack 111 has a first hole opening 111a located on a surface of the body 110 and a second hole opening 111b located inside the body 110, a periphery of the first hole opening 111a abuts against the neck hanging main body 210, and the clamping table 230 is in snap-fit with a periphery of the second hole opening 111b.

Exemplarily, the neck hanging piece 200 is connected to the earphone main body 100, specifically, two ends of the neck hanging piece 200 are respectively connected to two earphone main bodies 100, and the neck hanging piece 200 is used to hang the neck-hung earphone around the neck of the human body, so that the user may hang the earphone around the neck during sports. In contrast, a non-neck-hung Bluetooth earphone generally has an earphone box, and it is very inconvenient to put the earphone box in a trouser pocket during sports, so the neck-hung earphone is more suitable for use during sports than a conventional Bluetooth earphone.

Further, the earphone main body 100 includes the body 110 and the earphone head 120 that are connected, and it should be noted that, an accommodating cavity is formed inside the body 110 for accommodating electronic devices inside the earphone.

The neck hanging piece 200 includes the neck hanging main body 210, the plug portion 220 and the clamping table 230 that are connected in sequence, and it should be noted that, the connection manner among the neck hanging main body 210, the plug portion 220 and the clamping table 230 may be gluing, welding, or the neck hanging main body 210, the plug portion 220 and the clamping table 230 may be integrally formed in a mold, which is not specifically limited here.

Considering that the neck hanging piece 200 and the earphone main body 100 should be fixedly matched for use, in this embodiment, a jack 111 is formed in the body 110 corresponding to the plug portion 220 for the plug portion 220 to extend into the jack 111, and the clamping table 230 is located at an end of the plug portion 220 extending into the jack 111, the clamping table 230 just abuts against an outer peripheral edge of the second hole opening 111b, so that the clamping table 230 is snap-fit with the periphery of the second hole opening 111b.

Certainly, the neck hanging piece 200 and the earphone main body 100 may also be snap-fit matched by providing a groove body on the plug portion 220 and a clamping block in the inserting slot, or may also adopt other fixed fit manners of the neck hanging piece 200 and the earphone main body 100. Any one of the above fixing manners may be used for installation and fixing, or a combination of the above manners may be used for installation and fixing, which is not specifically limited here.

It should be noted that, because the periphery of the first hole opening 111a abuts against the neck hanging main body 210, it is difficult for water to flow into the body 110 through the jack 111, therefore, the waterproof sealing performance at the assembly of the neck hanging piece 200 and the earphone main body 100 can be improved by adopting this installation method.

In the technical solution of the present disclosure, by inserting the plug portion 220 into the jack 111, the clamping table 230 is snap-fit with the outer peripheral edge of the second hole opening 111b, the periphery of the first hole opening 111a abuts against the neck hanging main body 210, and then the neck hanging piece 200 and the earphone main body 100 are assembled and fixed, moreover, this installation method can improve the sealing performance at the assembly of the neck hanging piece 200 and the earphone main body 100, so that water is not easy to flow into the body 110 through the jack 111, thereby greatly prolonging the service life of the neck-hung earphone.

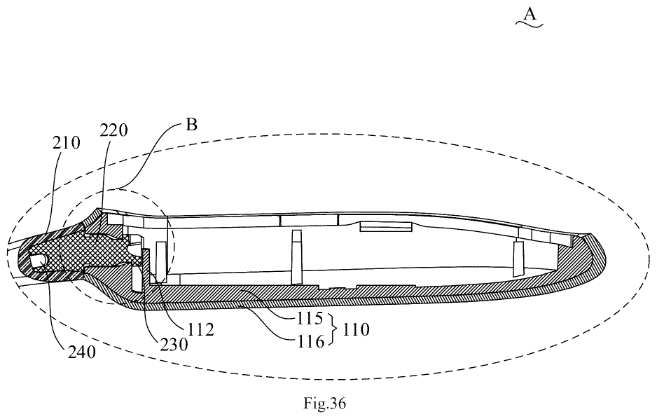

In an embodiment, please refer to FIGS. 36, 37 and 39, a baffle plate 112 is arranged in the body 110 to abut against an end portion of the clamping table 230.

Specifically, the baffle plate 112 is arranged to define a relative position of the clamping table 230, so as to prevent the plug portion 220 from excessively extending into the clamping groove 221, and the baffle plate 112 is also used to block water drops flowing in through a gap between the jack 111 and the plug portion 220, so as to prevent the water drops from further entering the body 110 and contaminating or damaging components such as a circuit board, a speaker and a microphone inside the body 110, thereby enhancing the waterproof performance of the earphone. The number of the baffle plate 112 may be one or multiple consecutive baffle plates may be provided. In this embodiment, one baffle plate 112 can better prevent water drops from entering the body 110. The shape of a side of the baffle plate 112 that abuts against the clamping table 230 may be square, semicircular or other shapes, which is not specifically limited here.

Further, please refer to FIGS. 36, 37 and 39, the baffle plate 112 protrudes and extends from a side of an inner wall of the body 110 toward an opposite side of the inner wall of the body 110, and a space is formed between the baffle plate 112 and the opposite side of the inner wall of the body 110.

It should be noted that the baffle plate 112 and the inner wall of the body 110 may be integrally formed in a mold or formed by connection, and the specific connection relationship may be ultrasonic welding or gluing, which is not specifically limited here, a space is formed between the baffle plate 112 and the opposite side of the inner wall of the body 110, instead of being connected to the opposite side of the inner wall of the body 110, which is used to balance the air pressure inside the body 110, and prevent the air pressure inside the body 110 from decreasing when the plug portion 220 is inserted into the jack 111, the decreasing air pressure may cause difficulty in inserting the plug portion 220, moreover, the structural design of the baffle plate 112 facilitates the dispensing and sealing after the assembly is completed.

Preferably, please refer to FIGS. 36, 37 and 39, the baffle plate 112 and the clamping table 230 are bonded and sealed.

It should be noted that, before the plug portion 220 and the clamping table 230 are inserted into the jack 111, glue is dispensed on the surface of the clamping table 230, and then the clamping table 230 and the baffle plate 112 are sealed by gluing, so that the relative position between the clamping table 230 and the plug portion 220 can be further fixed, and the waterproof effect of the baffle plate 112 can also be better.

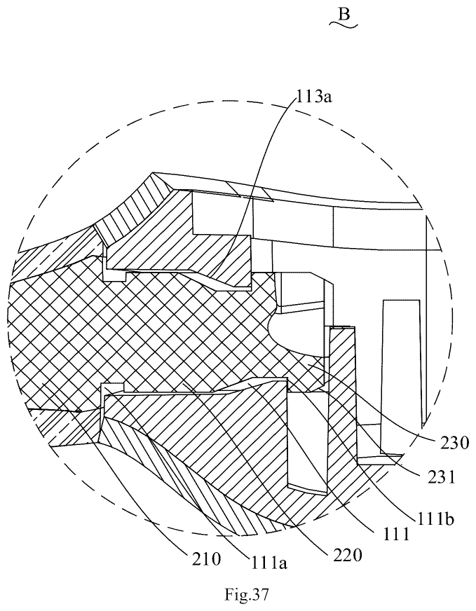

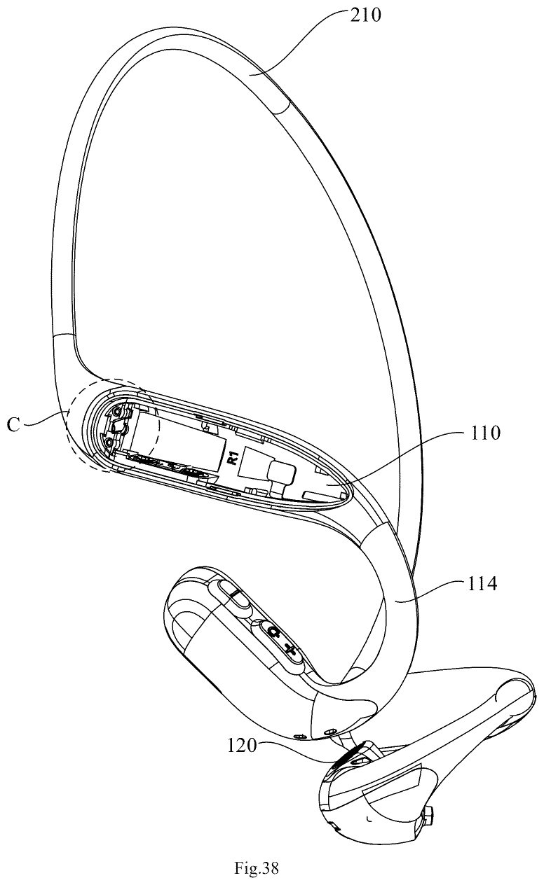

Further, please refer to FIG. 36 and FIG. 37, the clamping table 230 and the periphery of the second hole opening 111b are bonded and sealed.

According to the description of the previous embodiment, after glue is dispensed on the surface of the clamping table 230, the clamping table is bonded and sealed with the periphery of the second hole opening 111b after passing through the jack 111, so that water drops may be further prevented from entering the body 110 through the second hole opening 111b from the gap between the plug portion 220 and the jack 111, the waterproof effect at the connection position between the body 110 and the neck hanging piece 200 can be improved, and the service life of the neck-hung earphone of the present disclosure can be prolonged.

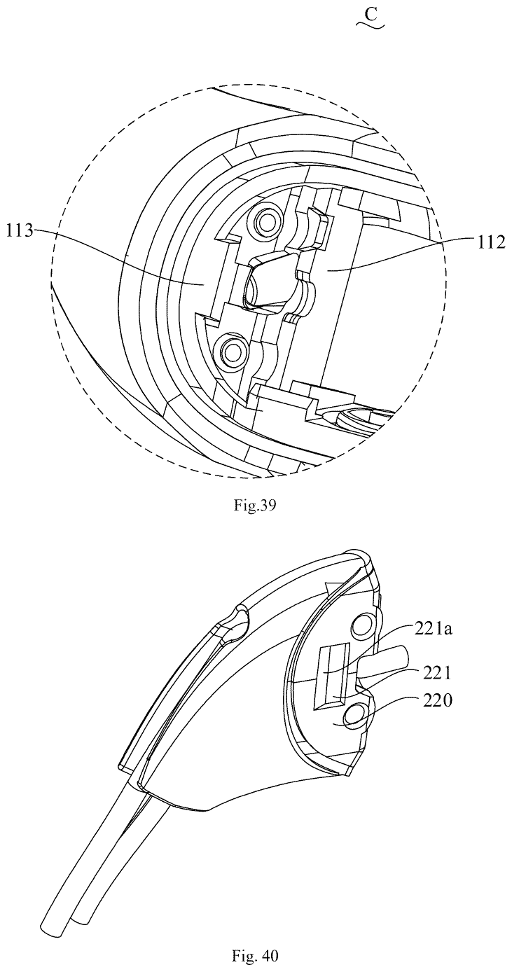

In an embodiment, please refer to FIG. 39 and FIG. 40, a clamping portion 113 is arranged on a hole wall of the jack 111, and the plug portion 220 is provided with a clamping groove 221 matched with the clamping portion 113.

Specifically, in the above embodiment, the earphone main body 100 and the neck hanging piece 200 are fixed only by the limit fit between the clamping table 230 and the periphery of the second hole opening 111b, the fit effect is general, and the connection between the earphone main body 100 and the neck hanging piece 200 may not be firm enough. Therefore, the clamping portion 113 is further arranged on the hole wall of the jack 111, the clamping portion 113 is arranged to protrude from the hole wall of the jack 111, the plug portion 220 is provided with the clamping groove 221 matched with the clamping portion 113, and the clamping portion 113 is buckled into the clamping groove 221 to define the relative position between the earphone main body 100 and the neck hanging piece 200, so that the connection between the earphone main body 100 and the neck hanging piece 200 is firmer.

The shape of the clamping portion 113 may be prismatic, cylindrical or in other irregular shapes, which is not specifically limited here, and the shape of the clamping groove 221 is arranged corresponding to the shape of the clamping portion 113, which may be a groove body with a square notch, a groove body with a circular notch or a groove body with a special-shaped notch, which is not specifically limited here.

Further, please refer to FIG. 39 and FIG. 40, the clamping portion 113 has a first guiding surface 113a extending in an inserting direction of the plug portion 220, and the first guiding surface 113a is inclined from the hole wall of the jack 111 toward the clamping groove 221 in the inserting direction of the plug portion 220; a second guiding surface 221a is arranged in the clamping groove 221 to match with the first guiding surface 113a.

It should be further noted that, in order to make the clamping portion 113 more easily buckle into the clamping groove 221 in the process of inserting the plug portion 220 into the jack 111, the clamping portion 113 further has the first guiding surface 113a extending in the inserting direction of the plug portion 220, the first guiding surface 113a is arranged obliquely, and the first guiding surface 113a is inclined from the hole wall of the jack 111 toward the clamping groove 221 in the inserting direction of the plug portion 220, so that the resistance of the clamping table 230 passing through the clamping portion 113 when the clamping table 230 being inserted into the jack 111 can be reduced.

Furthermore, the clamping groove 221 has the second guiding surface 221a, the second guiding surface 221a is in guiding fit with the first guiding surface 113a, and the second guiding surface 221a also extends in the inserting direction of the plug portion 220, and the second guiding surface 221a is inclined from an outer wall of the plug portion 220 in a direction away from the hole wall of the jack 111 in the inserting direction of the plug portion 220, that is, the inclination direction of the second guiding surface 221a is basically consistent with the inclination direction of the first guiding surface 113a, so that the clamping portion 113 is easy to slide into the clamping groove 221, and the earphone main body 100 and the neck hanging piece 200 are easy to install and fit.

In an embodiment, please refer to FIG. 37, a chamfer 231 matched with the first guiding surface 113a is arranged on an outer periphery of the clamping table 230.

Considering that the size of the opening of the jack 111 is only slightly larger than the size of the plug portion 220, it is difficult for the clamping table 230 to be inserted into the jack 111 and then to protrude from the second hole opening 111b. Then, the chamfer 231 is arranged on the outer periphery of the clamping table 230, so that the clamping table 230 may be more easily inserted into the jack 111 and protrude from the second hole opening 111b. Moreover, the chamfer 231 matches with the inclination angle of the first guiding surface 113a, so that the clamping table 230 may more easily pass through the part with the first guiding surface 113a.

Optionally, please refer to FIG. 36, the neck hanging piece 200 is further provided with a wire threading hole 240, and the wire threading hole 240 is communicated with the interior of the body 110.

Specifically, the neck hanging piece 200 is provided with the wire threading hole 240, and the wire threading hole 240 is communicated with the interior of the body 110, it should be noted that, a signal transmission wire connecting the earphones at both ends needs to be arranged inside the neck hanging piece 200, and the wire threading hole 240 is formed on the neck hanging piece 200, the wire threading hole 240 is generally formed inside the neck hanging piece 200, and the wire threading hole 240 is communicated with the interior of the body 110, so that the signal transmission wire may be connected to electronic devices such as a circuit board or/and a speaker inside the body 110.

In an embodiment, please refer to FIG. 36 and FIG. 37, the plug portion 220 and the clamping table 230 are made of plastic, the neck hanging main body 210 wraps part of the plug portion 220, and the neck hanging main body 210 is made of silica gel.

It should be noted that, the neck hanging main body 210 and the plug portion 220 may be bonded or formed by secondary injection molding, the neck hanging main body 210 is made of silica gel in this embodiment, certainly, the neck hanging main body 210 may also be made of plastic, the neck hanging main body 210 made of silica gel has a more comfortable feel than plastic, and silica gel is more resistant to friction than plastic, so that the neck hanging main body 210 is not easy to wear, the neck hanging main body 210 made of silica gel may be stretched, folded and put into a pocket, which is more convenient to carry than the neck hanging main body 210 made of plastic. In addition, the plug portion 220 and the clamping table 230 are made of plastic, so that the connection stability between the plug portion 220 and the clamping table 230 and the body 110 is better, and the plastic is not easy to deform, which can ensure a good sealing performance at the connection position between the neck hanging piece 200 and the body 110, and water is not easy to flow into the body 110 from the connection position between the neck hanging piece 200 and the body 110.

It should be noted that, a wire, a metal line and the like are further arranged inside the neck hanging piece 200, where, the wire and/or the metal line may be arranged in the wire threading hole 240 or embedded inside the neck hanging piece 200, which is not specifically limited here.

In an embodiment, please refer to FIG. 36 and FIG. 37, the body 110 includes an inner shell 115 and a protective layer 116 wrapping the inner shell 115, the inner shell 115 is made of plastic, and the protective layer 116 is made of silica gel.

Exemplarily, the body 110 has the inner shell 115 and the protective layer 116 wrapped around the inner shell 115, the inner shell 115 is made of plastic, considering that silica gel has better cushioning and anti-wear functions than plastic, in view of this, the protective layer 116 is made of silica gel.

In a preferred embodiment, please refer to FIG. 36 and FIG. 37, the neck hanging main body 210, the plug portion 220 and the clamping table 230 are integrally formed in a mold.

It should be noted that, the neck hanging piece 200 is integrally formed in a mold, and the neck hanging main body 210, the plug portion 220 and the clamping table 230 are formed on the neck hanging piece 200 by machining, this machining method is simple to process, and it is easy to perform refined machining and design on the plug portion 220 and the clamping table 230.

In an embodiment, please refer to FIG. 38, the body 110 is provided with an ear hook portion 114 for hooking the ear.

Specifically, the neck-hung earphone may not only be hung around the neck, but also the earphone main body 100 thereof further includes the ear hook portion 114, and the ear hook portion 114 is formed on the body 110, the ear hook portion 114 is worn on the ear of the user, so that the fit between the earphone main body 100 and the ear may be tighter, and the earphone main body will not easily shake during sports, thereby improving the user experience.

1. An earphone, comprising:
an earphone main body, wherein the earphone main body is provided with at least one sound pickup hole, and a sound pickup cavity is formed in the earphone main body and is communicated with the sound pickup hole;
a microphone group, arranged in the earphone main body and comprising at least one microphone; and
a waterproof and breathable assembly, arranged on one side of the microphone to prevent water in the sound pickup cavity from flowing to the microphone, wherein the microphone and the sound pickup cavity are acoustically coupled through the waterproof and breathable assembly.

2. The earphone of claim 1, wherein the sound pickup hole and the microphone are arranged in a staggered manner in an axial direction of the sound pickup hole.

3. The earphone of claim 1, wherein the waterproof and breathable assembly comprises a waterproof and breathable membrane and a sealing connector, a waterproof and breathable cavity is formed between the waterproof and breathable membrane and the microphone, and the waterproof and breathable membrane is acoustically coupled with the microphone through the waterproof and breathable cavity.

4. (canceled)

5. The earphone of claim 3, wherein the at least one sound pickup hole comprises a first sound pickup hole and a second sound pickup hole, the earphone main body comprises a main body portion and a sound producing portion, the first sound pickup hole is formed in the main body portion, the second sound pickup hole is formed in the sound producing portion, the microphone group comprises a first microphone and a second microphone, the first microphone is acoustically coupled with the first sound pickup hole, and the second microphone is acoustically coupled with the second sound pickup hole.

6. The earphone of claim 5, wherein the at least one sound pickup hole further comprises a third sound pickup hole formed in the sound producing portion, the third sound pickup hole is spaced apart from the second sound pickup hole, and a projection of the second microphone on the sound producing portion in an axial direction of the second microphone is located between the second sound pickup hole and the third sound pickup hole.

7. The earphone of claim 5, wherein the main body portion comprises a first housing and a main board cover, the first housing and the main board cover enclose to form a main body accommodating cavity, and the first sound pickup hole is formed in the main board cover.

8. The earphone of claim 7, wherein the sound pickup cavity comprises a first sound pickup cavity and a second sound pickup cavity which are communicated with each other, the first sound pickup cavity is communicated with the first sound pickup hole, the second sound pickup cavity is acoustically coupled with the first microphone through the waterproof and breathable assembly, and in an axial direction of the first sound pickup hole, the first sound pickup cavity is at least partially located at an outer side of the second sound pickup cavity.

9. The earphone of claim 8, wherein the earphone comprises a first sound pickup frame, the first sound pickup cavity and the second sound pickup cavity are formed in the first sound pickup frame, a first step surface is formed between a cavity wall of the first sound pickup cavity and a cavity wall of the second sound pickup cavity, and a projection of the first step surface on the main board cover in the axial direction of the first sound pickup hole covers the first sound pickup hole.

10. The earphone of claim 9, wherein a second step surface is further formed between the cavity wall of the first sound pickup cavity and the cavity wall of the second sound pickup cavity, a first inflection point is provided at a connection position between the cavity wall of the first sound pickup cavity and the second step surface, a second inflection point is provided at a connection position between the cavity wall of the second sound pickup cavity and the second step surface, the first microphone comprises a first microphone channel, and a shortest distance from the first inflection point to an axis of the first microphone channel is smaller than a shortest distance from the second inflection point to the first microphone channel.

11. The earphone of claim 10, wherein a first installation groove is formed at a side of the first sound pickup frame away from the first sound pickup hole, and a groove bottom of the first installation groove is communicated with the second sound pickup cavity; the waterproof and breathable assembly is arranged in the first installation groove, the earphone further comprises a first installation component, and the first installation component hermetically presses the waterproof and breathable assembly into the first installation groove.

12. The earphone of claim 11, wherein the first microphone is arranged on a side of the first installation component away from the first sound pickup hole and connected with the first installation component, the waterproof and breathable assembly is arranged on another side of the first installation component, the first installation component comprises a first sound passing channel, and the first sound passing channel is arranged corresponding to the first microphone channel; the first microphone is acoustically coupled with the waterproof and breathable assembly through the first sound passing channel.

13. The earphone of claim 11, wherein in the axial direction of the first sound pickup hole, a thickness of the elastic sealing component is larger than a distance between the groove bottom of the first installation groove and the first installation component.

14. The earphone of claim 6, wherein the sound producing portion comprises a second housing and an outer cover, the outer cover and the second housing enclose to form a sound producing accommodating cavity, the second microphone is arranged in the sound producing accommodating cavity, and the second sound pickup hole and the third sound pickup hole are formed in the outer cover.

15. The earphone of claim 14, wherein the sound pickup cavity comprises a main sound cavity and a secondary sound cavity which are communicated with each other, the main sound cavity is communicated with the second sound pickup hole and the third sound pickup hole, and the secondary sound cavity is acoustically coupled with the second microphone through the waterproof and breathable membrane.

16. The earphone of claim 15, wherein the earphone comprises a second sound pickup frame, the main sound cavity and the secondary sound cavity are formed in the second sound pickup frame, the secondary sound cavity is acoustically coupled with the waterproof and breathable cavity through the waterproof and breathable membrane, the earphone has a projection plane perpendicular to an axis of the second sound pickup hole, and an orthographic projection of the secondary sound cavity toward the projection plane is located between an orthographic projection of the second sound pickup hole toward the projection plane and an orthographic projection of the third sound pickup hole toward the projection plane.

17. The earphone of claim 16, wherein the second sound pickup frame comprises a sound frame bottom portion and a sound frame side portion, the sound frame bottom portion is connected with the sound frame side portion, and the sound frame bottom portion is provided with a waterproof groove opposite to the second sound pickup hole and the third sound pickup hole.

18. The earphone of claim 17, wherein the sound frame bottom portion and the sound frame side portion enclose to form the main sound cavity; the sound frame bottom portion protrudes towards the outer cover to form a boss, and the waterproof groove is formed between the boss and an inner wall of the sound frame side portion.

19. The earphone of claim 18, wherein a connection position between the boss and the waterproof groove is inclined and smoothly transits to form a flow guide surface.

20. The earphone of claim 19, wherein the secondary sound cavity is formed in the sound frame bottom portion, the secondary sound cavity comprises a secondary sound cavity inlet and a secondary sound cavity outlet, the secondary sound cavity inlet is formed on a surface of the boss, and the secondary sound cavity outlet is formed in an outer wall surface of the sound frame bottom portion and is arranged corresponding to the waterproof and breathable membrane.

21. The earphone of claim 20, wherein a second installation groove is formed at a side of the second sound pickup frame away from the outer cover, and a groove bottom of the second installation groove is communicated with the secondary sound cavity; the waterproof and breathable assembly is arranged in the second installation groove, the earphone further comprises a second installation component, and the second installation component hermetically presses the waterproof and breathable assembly into the second installation groove.

22-119. (canceled)
